(19) United States
(12) Patent Application Publication
(10) Pub. No.: US 2016/0012182 A1
(43) Pub. Date: Jan. 14, 2016

(54) 3D cone beam dental imaging system

(71) Applicant: Douglas A. Golay, Coon Rapids, IA (US)

(72) Inventor: Douglas A. Golay, Coon Rapids, IA (US)

(21) Appl. No.: 14/137,615

(22) Filed: Dec. 20, 2013

(51) Int. Cl. G06F 19/00; G06T 7/00

(52) U.S. Cl. CPC G06F 19/321; G06T 7/0022; G06T 7/0065; G06F 19/327; G06T 2207/10116; G06T 2207/30036

(57) ABSTRACT

A 3D dental imaging system which is used for producing and transferring 3D volumes of a patient from a remote cloud storage device and which includes a 3D volume imaging software for displaying cone beam images. The software retrieves volumes from storage located in the dental office. The 3D volumes are acquired via a cone beam scanner. There is storage located in the dentist office for storage of 3D volumes that were acquired via a cone beam scanner. There is also storage located remotely of the dentist office for storage of 3D volumes that were acquired via a cone beam scanner located in the dentist office. The 3D volumes are transferred between the local storage and the remote storage. The patient appointment information is retrieved for patient's future appointments from a patient scheduling software. The 3D volumes automatically are downloaded from remote storage to local storage based upon patient's future appointment information.

### BACKGROUND OF THE INVENTION

1. Field of the Invention

The invention relates to the field of dentistry and more specifically to a 3D dental cone beam imaging system containing a cone beam scanner, 3D dental imaging software, local 3D volume storage and remote 3D volume storage.

2. Description of the Prior Art

In the field of dentistry, dentists are employing more 3D cone beam imaging equipment for general, implant and orthodontic dentistry procedures. The 3D volumes produced by these types of imaging equipment are of a relatively large size as compared to traditional 2D images and can be anywhere from 10 to 500 times or more larger in size.

The field of software development and deployment is also significantly and rapidly changing from traditional client server systems where the software, clients, and servers are all locally installed and maintained to remote storage and software applications where only the clients are local and the storage and/or servers are remotely located. These types of environments are commonly referred to as virtualized environments, remote access environments or Cloud environments.

Remote storage and applications for dentists have many benefits including easy ability to share images, easy ability for multi-site access, and easier ability to be interoperable with other health care systems and software. Less software is installed locally in the dentist office and less local IT support is required. In addition, because data is located off-site disaster recovery is possible as well as controlled backups at the cloud storage. Also by having the 3D volumes available in the remote storage/cloud environment allows easier interaction with EMR and DICOM types of systems when located at multiple locations.

In a 3D equipped dental office/environment where remote storage is desired to be used for storing and sharing 3D volumes, it is not currently feasible because the remote storage and/or application are operated via a bandwidth limited connections such as a cable or DSL internet connection which are inherently too slow to upload and download the 3D volumes for processing nearly real time which is required in the dental workflow. Likewise the bandwidth available is also normally too slow to send the high quality rendered preview results from the application server in semi-real-time to display on the client.

The above remote application, remote storage and bandwidth issue lead to 3D dental imaging systems not being able to be implemented to work well with remote storage.

U.S. Pat. No. 8,553,965 teaches a local device which receives 3D medical image data captured by a medical imaging device. The 3D medical image is anonymized by removing certain metadata associated with the 3D medical image data based on an anonymization template. The local device automatically uploads the anonymized 3D medical image data to a cloud server over a network based on a set of one or more rules, using a network connection established via an internet port of the local device. The cloud server is configured to provide medical image processing services to a plurality of users using a plurality of image processing tools provided by the cloud server. A computerized axial tomography scan (commonly known as a CAT scan or a CT scan) is an x-ray procedure, which combines many x-ray images with the aid of a computer to generate cross-sectional views of the internal organs and structures of the body. In each of these views, the body image is seen as an x-ray “slice” of the body. Typically, parallel slices are taken at different levels of the body, i.e., at different axial (z-axis) positions. This recorded image is called a tomogram, and “computerized axial tomography” refers to the recorded tomogram “sections” at different axial levels of the body. In multislice CT, a two-dimensional (2D) array of detector elements replaces the linear array of detectors used in conventional CT scanners. The 2D detector array permits the CT scanner to simultaneously obtain tomographic data at different slice locations and greatly increases the speed of CT image acquisition. Multi-slice CT facilitates a wide range of clinical applications, including three-dimensional (3D) imaging, with a capability for scanning large longitudinal volumes with high z-axis resolution.

Magnetic resonance imaging (MRI) is another method of obtaining images of the interior of objects, especially the human body. More specifically, MRI is a non-invasive, non-x-ray diagnostic technique employing radio-frequency waves and intense magnetic fields to excite molecules in the object under evaluation. Like a CAT scan, MRI provides computer-generated image “slices” of the body's internal tissues and organs. As with CAT scans, MRI facilitates a wide range of clinical applications, including 3D imaging, and provides large amounts of data by scanning large volumes with high resolution.

Medical image data, which are collected with medical imaging devices, such as X-ray devices, MRI devices, Ultrasound devices, Positron Emission Tomography (PET) devices or CT devices in the diagnostic imaging departments of medical institutions, are used for an image interpretation process called “reading” or “diagnostic reading.” After an image interpretation report is generated from the medical image data, the image interpretation report, possibly accompanied by representative images or representations of the examination, are sent to the requesting physicians. Today, these image interpretation reports are usually digitized, stored, managed and distributed in plain text in a Radiology Information System (RIS) with accompanying representative images and the original examination stored in a Picture Archiving Communication System (PACS) which is often integrated with the RIS.

Typically, prior to the interpretation or reading, medical images may be processed or rendered using a variety of imaging processing or rendering techniques. Recent developments in multi-detector computed tomography (MDCT) scanners and other scanning modalities provide higher spatial and temporal resolutions than the previous-generation scanners.

Advanced image processing was first performed using computer workstations. However, there are several limitations to a workstation-based advanced image processing system. The hardware and software involved with these systems are expensive, and require complicated and time consuming installations. Because the workstation can only reside in one location, users must physically go to the workstation to use the advanced image processing software and tools. Also, only one person can use the workstation at a time.

Some have improved on this system by converting the workstation-based advanced image processing system to a client-server-based system. These systems offer some improvements over the workstation-based systems in that a user can use the client remotely, meaning the user does not have to be physically located near the server, but can use his/her laptop or computer elsewhere to use the software and tools for advanced image processing. Also, more than one client can be used with a given server at one time. This means that more than one user can simultaneously and remotely use the software that is installed on one server. The computational power of the software in a client-server-based system is distributed between the server and the client. In a “thin client” system, the majority of the computational capabilities exist at the server. In a “thick client” system, more of the computational capabilities, and possibly data, exist on the client. The hardware software installation and maintenance costs and complexity of a client-server based system are still drawbacks. Also, there can be limitations on the number of simultaneous users that can be accommodated. Hardware and software must still be installed and maintained. Generally the information technology (IT) department of the center which purchased the system must be heavily involved, which can strain resources and complicate the installation and maintenance process.

U.S. Pat. No. 8,386,288 teaches a workflow management system which manages workflow within one or more entities and which may include a first drop-box application program executed on a first computing system including a first input object directory configured to receive an input object electronically outputted from an application program. The first drop-box application program may further include a first workflow engine configured to generate and send a workflow package to a second drop-box application program executed on a second computing system, the workflow package including the input object, a plurality of workflow tasks, and a set of predetermined workflow rules defined by a user via the first drop-box application program. In some examples at least one workflow task may be implemented via the second drop-box application program based on the set workflow rules.

U.S Patent Publication No. 2009/0103789 teaches an apparatus which delivers and receives DICOM images. A plurality of files, including DICOM image files and non-DICOM image files, stored on a computer is accessed. The DICOM image files are identified from among the plurality of files by scanning header data of the plurality of files when accessing the plurality of files. At least one of the identified DICOM image files is selected to be uploaded in response to user input. The selected DICOM image file is uploaded to an application on a server.

Medical imaging has made a significant contribution to improvements in diagnosing and treating many injuries and illnesses. There are many different types of medical imaging available including X-ray imaging, magnetic resonance imaging, computerized tomography, ultrasonic scanning, endoscopic imaging and nuclear imaging. As medical imaging techniques are continuously improving and evolving, physicians are able to provide patients with more informed diagnoses and more effective treatments and recovery plans. Patients who require specialist advice are, in many cases, able to present a copy of their medical images at an appointment with the specializing physician. There are also occasions where treating physicians, even specialists, have a need to share medical images with colleagues for an opinion or diagnosis. These colleagues may be located in other medical facilities, which may also be located in other locations of the country or even overseas.

As communications technology has developed, it has now become possible to pass vast quantities of information including images and accompanying data from one location to another over communications networks such as telephone networks and dedicated high speed communications networks. This technology facilitates sharing of medical information and images between physicians, where compatible communication platforms and protocols are used, as well as where common network connections are available.

Devices used to create and store different types of medical images usually differ from one another and devices that create digital records of the images often use different file formats and different protocols to compress and de-compress the image data. To overcome these differences, the Digital Imaging and Communications in Medicine (DICOM) standard was developed to meet the needs of users and manufacturers of medical imaging equipment for interconnection of devices on standard networks including the Internet. DICOM has become the most common standard for receiving digital medical images such as scans from a hospital. A primary advantage of the DICOM standard is that a piece of medical equipment or software produced by one manufacturer can communicate with software or equipment produced by another. Therefore, DICOM image data can be utilized by any party with access to a DICOM compatible viewer.

In addition to medical images, the DICOM image format provides for the entry of brief patient histories, usually by the technologist, and may also provide a patient work-list by the technologist that includes patient history and/or physician information.

The transmission of DICOM image files that are transmitted in a DICOM communication session may often include various errors, including data errors and data format errors, which complicate one's ability to receive and process a DICOM image file. Moreover, certain older CT and MRI devices may incorrectly populate DICOM data fields. Too often, discovery of such errors occurs during processing of a DICOM image file, which contributes increased frustration and associated costs. Often, similar or the same errors are repeated by the same sending DICOM service class user. Similarly, the data structure for the filing of patient studies may vary from site to site, making data transport challenging and often having to involve non-medical related parties such as system administrators to complete the transfer.

Under current HIPAA standards and with regard to other aspects of patient confidentiality, secure transmissions of the patient data are required. In many cases secure private networks, such as VPNs are utilized between the facilities sharing the medical images in order to preserve patient confidentiality and meet HIPAA requirements, thus limiting the ability to share image files.

What is needed therefore is a method to deliver and receive DICOM image files, without the need for a secure private network connection or intervention by non-medical parties.

U.S. Patent Publication No. 2009/0204435 teaches a system which automatically assigns diagnostic imaging centers, uploads diagnostic data, selects and routes data to electronically connected reviewing physicians, on-line report generation and automatic billing.

U.S. Pat. No. 8,577,493 teaches a virtual model of an intraoral cavity wherein a process is initialized by a dental clinic, and the design and manufacture of a suitable dental prosthesis for the intraoral cavity is shared between a dental lab and a service center. The method for manufacturing a dental prosthesis includes the steps of receiving a three dimensional data indicative of a patient's oral cavity; generating based on the three dimensional data a dentition model so as to identify a prosthesis preparation and external surface shape geometry of a prosthesis coupling portion of the preparation; generating, based on the dentition model, prosthesis data including three dimensional shape data of a preparation coupling portion of the prosthesis, wherein the preparation coupling portion is configured for coupling the prosthesis and the preparation, the prosthesis data further including three dimensional shape data of an external surface of the prosthesis configured to match adjacent teeth in the patient's oral cavity; and transmitting prosthesis data for manufacture of the prosthesis such that the coupling portion of the prosthesis and coupling portion of the preparation have a predetermined criteria including a fitting tolerance in a predetermined range of dimensional accuracy, wherein manufacturing the prosthesis according to the predetermined criteria is shared among a service center and a dental lab, wherein the prosthesis data includes a surface feature located on the coupling portion of the prosthesis and having a geometry configured to maintain proper spatial alignment between the coupling portion of the prosthesis and the external surface of the prosthesis.

A dental treatment often begins with obtaining a three-dimensional (3D) model of a patient's teeth. The model may be a physical model of the dentition or a virtual 3D computer model. The model is used to assist in designing a dental treatment for the patient. After the treatment has been designed, the model is used to design the dental prosthesis or appliance to be applied to the teeth in order to execute the treatment. Such prostheses and appliances include, for example, bridges, crowns, and orthodontic braces.

In some instances, a negative cast of the dentition is obtained at the dental clinic in which the patient is seen, and may include both arches, one arch, or part of an arch. The cast is sent to a dental laboratory, and a positive physical model of the dentition is made from the negative cast, typically by pouring plaster into the cast allowing the plaster to set. A dental treatment is then determined at the clinic using the model, and prostheses or appliances for mounting onto the patient's teeth are designed or selected in order to execute the treatment. The appliances are made at a laboratory and then dispatched to the clinic for mounting onto the patient's teeth.

It is also known to obtain a 3D virtual representation of the teeth that is used to assist in devising a dental treatment and/or to design dental appliances. The 3D computer model may be obtained at the dental clinic using an optical scanner to scan the teeth directly or to scan a model of the teeth. The computer model is then used at the clinic for designing or selecting appropriate dental prosthesis and/or appliances to carry out the treatment. Instructions are then sent to a dental appliance laboratory for making the prosthesis or appliances, which are made at the laboratory and then dispatched to the clinic.

Alternatively, a negative cast of the dentition of each jaw is obtained at a dental clinic that is dispatched to a dental appliance laboratory where a 3D positive model of the patient's teeth is made from the negative cast. The 3D model is then scanned at the laboratory so as to generate a virtual 3D model of the patient's teeth that is used to design appropriate dental prosthesis or appliances. The prosthesis or appliances are produced at the laboratory and then dispatched to the clinic.

U.S. Pat. No. 6,632,089 teaches a computer-based dental treatment planning method. A virtual 3D model of the dentition of a patient is obtained that is used to plan a dental treatment. Obtaining the 3D model as well as treatment planning can be performed at a dental clinic or at a remote location such as a dental appliance laboratory having access to the virtual model of the dentition. In the latter situation, the proposed treatment plan is sent to the clinic for review, and modification or approval by the dentist, before the requisite appliances are made at the laboratory.

U.S. Pat. No. 6,632,089 also teaches an interactive, software-based treatment planning method to correct a malocclusion. The method can be performed on an orthodontic workstation in a clinic or at a remote location such as a lab or precision appliance manufacturing center. The workstation stores a virtual three-dimensional model of the dentition of a patient and patient records. The virtual model is manipulated by the user to define a target situation for the patient, including a target arch-form and individual tooth positions in the arch-form. Parameters for an orthodontic appliance, such as the location of orthodontic brackets and resulting shape of an orthodontic arch-wire, are obtained from the simulation of tooth movement to the target situation and the placement position of virtual brackets. The treatment planning can also be executed remotely by a precision appliance service center having access to the virtual model of the dentition. In the latter situation, the proposed treatment plan is sent to the clinic for review, and modification or approval by the orthodontist. The method is suitable for other orthodontic appliance systems, including removable appliances such as transparent aligning trays.

U.S. Pat. No. 7,958,100 teaches a method of managing medical information which includes receiving, at a first computer, requests for medical information from a second computer. The first computer responds by sending a set of instructions to the second computer. The instructions are sufficient to allow the second computer to automatically retrieve the requested medical information from a third computer.

Medical imaging is important and widespread in the diagnosis of disease. In certain situations, however, the particular manner in which the images are made available to physicians and their patients introduces obstacles to timely and accurate diagnoses of disease. These obstacles generally relate to the fact that each manufacturer of a medical imaging system uses different and proprietary formats to store the images in digital form. This means, for example, that images from a scanner manufactured by General Electric Corp. are stored in a different digital format compared to images from a scanner manufactured by Siemens Medical Systems. Further, images from different imaging modalities, such as, for example, ultrasound and magnetic resonance imaging (MRI), are stored in formats different from each other. Although it is typically possible to “export” the images from a proprietary workstation to an industry-standard format such as “Digital Imaging Communications in Medicine” (DICOM), Version 3.0, several limitations remain as discussed subsequently. In practice, viewing of medical images typically requires a different proprietary “workstation” for each manufacturer and for each modality. Currently, when a patient describes symptoms, the patient's primary physician often orders an imaging-based test to diagnose or assess disease. Typically, days after the imaging procedure, the patient's primary physician receives a written report generated by a specialist physician who has interpreted the images. The specialist physician, however, typically has not performed a clinical history and physical examination of the patient and often is not aware of the patient's other test results. Conversely, the patient's primary physician typically does not view the images directly but rather makes a treatment decision based entirely on written reports generated by one or more specialist physicians. Although this approach does allow for expert interpretation of the images by the specialist physician, several limitations are introduced for the primary physician and for the patient, such as, for example: (1) The primary physician does not see the images unless he travels to another department and makes a request; (2) It is often difficult to find the images for viewing because there typically is no formal procedure to accommodate requests to show the images to the primary physician; (3) Until the written report is forwarded to the primary physician's office, it is often difficult to determine if the images have been interpreted and the report generated; (4) Each proprietary workstation requires training in how to use the software to view the images; (5) It is often difficult for the primary physician to find a technician who has been trained to view the images on the proprietary workstation; (6) The workstation software is often “upgraded” requiring additional training; (7) The primary physician has to walk to different departments to view images from the same patient but different modalities; (8) Images from the same patient but different modalities cannot be viewed side-by-side, even using proprietary workstations; (9) The primary physician cannot show the patient his images in the physician's office while explaining the diagnosis; and (10) The patient cannot transport his images to another physician's office for a second opinion.

It would be desirable to allow digital medical images to be viewed by multiple individuals at multiple geographic locations without loss of diagnostic information.

“Teleradiology” allows images from multiple scanners located at distant sites to be transferred to a central location for interpretation and generation of a written report. This model allows expert interpreters at a single location to examine images from multiple distant geographic locations. Teleradiology does not, however, allow for the examination of the images from any site other than the central location, precluding examination of the images by the primary physician and the patient. Rather, the primary physician and the patient see only the written report generated by the interpreters who examined the images at the central location. In addition, this approach is based on specialized “workstations” (which require substantial training to operate) to send the images to the central location and to view the images at the central location. It would be advantageous to allow the primary physician and the patient to view the images at other locations, such as the primary physician's office, at the same time he/she and the patient see the written report and without specialized hardware or software.

In principle, medical images could be converted to Internet Web Pages for widespread viewing. Several technical limitations of current Internet standards, however, create a situation where straightforward processing of the image data results in images which transfer across the Internet too slowly, lose diagnostic information or both. One such limitation is the bandwidth of current Internet connections which, because of the large size of medical images, result in transfer times which are unacceptably long. The problem of bandwidth can be addressed by compressing the image data before transfer, but compression typically involves loss of diagnostic information. In addition, due to the size of the images the time required to process image data from an original format to a format which can be viewed by Internet browsers is considerable, meaning that systems designed to create Web Pages “on the fly” introduce a delay of seconds to minutes while the person requesting to view the images waits for the data to be processed. Workstations allow images to be reordered or placed “side-by-side” for viewing, but again, an Internet system would have to create new Web Pages “on the fly” which would introduce further delays. Finally, diagnostic interpretation of medical images requires the images are presented with appropriate brightness and contrast. On proprietary workstations these parameters can be adjusted by the person viewing the images but control of image brightness and contrast are not features of current Internet standards (such as, for example, http or html).

It is possible to allow browsers to adjust image brightness and contrast, as well as other parameters, using “Java” programming. “Java” is a computer language developed by Sun Microsystems specifically to allow programs to be downloaded from a server to a client's browser to perform certain tasks. Using the “Java” model, the client is no longer simply using the browser to view “static” files downloaded from the server, but rather in addition the client's computer is running a program that was sent from the server. There are several disadvantages to using “Java” to manipulate the image data. First, the user must wait additional time while the “Java” code is downloaded. For medical images, the “Java” code is extensive and download times are long. Second, the user must train to become familiar with the controls defined by the “Java” programmer. Third, the user must wait while the “Java” code processes the image data, which is slow because the image files are large. Fourth, “Java” code is relatively new and often causes browsers to “crash.” Finally, due to the “crashing” problem “Java” programmers typically only test their code on certain browsers and computers, such as Microsoft Explorer on a PC, precluding widespread use by owners of other browsers and other computer platforms.

U.S. Pat. No. 5,891,035 teaches an ultrasound system which incorporates an http server for viewing ultrasound images over the Internet. The approach of Wood, however, creates Web Pages “on the fly,” meaning that the user must wait for the image processing to complete. In addition, even after processing of the image data into a Web Page the approach of Wood does not provide for processing the images in such a way that excessive image transfer times due to limited bandwidth are addressed or provide for “brightness/contrast” to be addressed without loss of diagnostic information. In addition, the approach of Wood is limited to ultrasound images generated by scanners manufactured by a single company, and does not enable viewing of images from modalities other than ultrasound.

U.S. Patent Publication No. 2008/0253693 teaches a method and system for pre-fetching relevant imaging information from multiple healthcare organizations Aspects of one method may include querying data associated with one or more patients from a shared document registry. The method includes receiving manifests of imaging data associated with one or more patients from a shared document repository based on the queried data. The method also includes pre-fetching imaging data associated with one or more patients from a shared imaging data repository based on the received manifests of the imaging data. The method further includes storing the pre-fetched imaging data in an image storage repository within a picture archiving and communication system (PACS). The stored imaging data may be accessed by a user via one or more PACS work stations.

U.S. Pat. No. 8,065,166 teaches a method which manages, transfers, modifies, converts and/or tracks medical files and/or medical system messages. The method is generally be based on requesting medical files at a first medical facility, identifying the requested medical files at a second medical facility, initiating a secure network connection between the first and second medical facility, modifying a header portion of the medical files based on patient identification information created by the first medical facility, and other processing steps.

Referring to FIG. 1 U.S. Pat. No. 5,891,035 teaches an ultrasound system which incorporates an http server for viewing ultrasound images over the Internet. The approach of Wood, however, creates Web Pages “on the fly,” meaning that the user must wait for the image processing to complete. In addition, even after processing of the image data into a Web Page the approach of Wood does not provide for processing the images in such as way that excessive image transfer times due to limited bandwidth are addressed or provide for “brightness/contrast” to be addressed without loss of diagnostic information. In addition, the approach of Wood is limited to ultrasound images generated by scanners manufactured by a single company, and does not enable viewing of images from modalities other than ultrasound. This is a common prior art approach currently used by companies to serve medical images to Internet browsers (e.g., General Electric's “Web-Link” component of their workstation-based “Picture Archiving and Communication System” (PACS)). Serial processing of image data “on the fly” combined with extensive user interaction results in a slow, expensive, and unstable system. After a scanner acquires images (Step 100) a user may request single image as a webpage (Step 200) whereby the image data is downloaded (Step 300) to allow the user to view a single image with the single image (Step 400). Steps 1000-1400 result in extensive user interaction which results in the system being slow, expensive and unstable. A schematic diagram summarizes a common prior art approach currently used by companies to serve medical images to Internet browsers (e.g., General Electric's “Web-Link” component of their workstation-based “Picture Archiving and Communication System” (PACS)). Serial processing of image data “on the fly” combined with extensive user interaction results in a slow, expensive, and unstable system. After a scanner acquires images (Step 100) a user may request single image as a webpage (Step 200) whereby the image data is downloaded (Step 300) to allow the user to view a single image with the single image (Step 400). Steps 1000-1400 result in extensive user interaction which results in the system being slow, expensive and unstable.

Referring to FIG. 2 in conjunction with FIG. 3 a medical image management system 10 is connected via a Hospital Intranet or the Internet 12 to a number of browsers 14 (such as, for example, Microsoft Explorer™ or Netscape Navigator™). The connection 12 to the browsers is used to:) Accept commands to pull images from the scanners 16; 2) To navigate through images which have already been posted as web pages; and 3) To arrange and organize images for viewing. The medical image management system 10 is also connected to a number of medical imaging systems (scanners) 16 via a Hospital Intranet or the Internet 12′. The connection 12′ to the scanners 16 is used to pull the images by Internet-standard file transfer protocols (FTP). Alternatively, images can be transferred to the system 10 via a disk drive or disk 18. Preferably the scanner, and hence modality, is associated with magnetic resonance imaging, echocardiographic imaging, nuclear scintigraphic imaging (e.g., SPECT, or single photon emission computed tomography), positron emission tomography, x-ray imaging and combinations thereof. Responsibility for the entire process is divided amongst a series of software engines. The processes of the transfer engine 20, decoding engine 22, physiologic knowledge engine 24, encoding engine 26 and post engine 28 are preferably run automatically by computer and do not require the person using the browser, the user, to wait for completion of the associated tasks. The decoding engine 22, physiologic knowledge engine 24 and encoding engine 26 are, preferably, combined to form a converter engine. The post engine 28 sends an e-mail notification, via an e-mail server 30 (FIG. 2) to the person submitting the request when the computations are complete, thereby allowing the requester to do other tasks. Similarly, text messages could be sent to a physician's pager. The time necessary for these computations depends on the size of the images and the speed of the network, but was measured for the MRI images of FIG. 16 to be approximately 3 minutes over a standard Ethernet 10BASET line (10 Mbps) using a 400 MHz computer. The transfer engine 20 is responsible for pulling the images from the scanner 16 for example, in response to a user request (Step 2010). Using previously recorded information such as, for example, a username and password (Step 2020), the transfer engine 20 logs into the scanner 16 over the Internet 12 (Step 2030) and pulls the appropriate images from the scanner 16, using standard Internet FTP or DICOM commands (Step 2040). Alternatively, images can be acquired by the transfer engine 20 by use of a disk drive 18 such as, for example, a CD-ROM drive (Steps 2011-2022). When the transfer process is complete, all images from the scan will exist within the transfer engine 20 but are still in their original digital format. This format may be specific to the scanner 16 manufacturer, or may be one of a variety of formats which are standard but cannot be displayed by browsers, such as, for example, DICOM. The images are then passed to the decoding engine (Step 3000).

Referring to FIG. 4 an orthodontic care system 10 incorporating a scanner system 12 includes a hand-held scanner 14 that is used by the orthodontist to acquire three-dimensional information of the dentition and associated anatomical structures of a patient. The images are processed in a scanning node or workstation 16 having a central processing unit, such as a general-purpose computer. The scanning node 16, either alone or in combination with a back-office server 28, generates a three-dimensional virtual computer model 18 of the dentition. The computer model provides the orthodontist and the treatment planning software with a base of information to plan treatment for the patient. The model 18 is displayed to the user on a monitor 20 connected to the scanning node 16. The orthodontic care system consists of a plurality of orthodontic clinics 22 which are linked via the Internet or other suitable communications medium 24 (such as the public switched telephone network, cable network, etc.) to a precision appliance service center 26. Each clinic 22 has a back office server work station 28 having its own user interface, including a monitor 30. The back office server 28 executes an orthodontic treatment planning software program, described at length below. The software obtains the three-dimensional digital data of the patient's teeth from the scanning node and displays the model 18 for the orthodontist. The treatment planning software includes features to enable the orthodontist to manipulate the model 18 to plan treatment for the patient. For example, the orthodontist can select an archform for the teeth and manipulate individual tooth positions relative to the archform to arrive at a desired or target situation for the patient. The software moves the virtual teeth in accordance with the selections of the orthodontist. The software also allows the orthodontist to selectively place virtual brackets on the tooth models and design a customized archwire for the patient given the selected bracket position. When the orthodontist has finished designing the orthodontic appliance for the patient, digital information regarding the patient, the malocclusion, and a desired treatment plan for the patient are sent over the communications medium to the appliance service center 26. A customized orthodontic archwire and a device for placement of the brackets on the teeth at the selected location is manufactured at the service center and shipped to the clinic 22. The system is applicable to other types of orthodontic appliances. For example, a target situation for the dentition could be transferred to the precision appliance service center 26. The center 26 could make a stereolithographic (SLA) model of the dentition. From that model (or from models of the malocclusion), the center could fabricate removable orthodontic appliances such as transparent aligning devices, retainers, Herbst expansion devices, etc. using known techniques. The precision appliance service center 26 includes a central server 32, an archwire manufacturing system 34 and a bracket placement manufacturing system 36. These details are not particularly important to the treatment panning methods and apparatus and are therefore omitted from the present discussion for sake of brevity. For more details on these aspects of the illustrated orthodontic care system, the interested reader is directed to the patent application of Rudger Rubbert et al., filed Apr. 13, 2001, entitled INTERACTIVE AND ARCHWIRE-BASED ORTHODONTIC CARE SYSTEM BASED ON INTRA-ORAL SCANNING OF TEETH, Ser. No. 09/835,039, the contents of which are incorporated by reference herein.

Referring to FIG. 5 in conjunction with FIG. 4 a scanning system 12, suitable for use in the orthodontic care system. The scanning system 12 is a mechanism for capturing three-dimensional information of an object 40, which in the present example is the dentition and surrounding anatomical structures of a human patient, e.g., gums, bone and/or soft tissue. The scanning system 12 includes a scanner 14 which is used for image capture, and a processing system, which in the illustrated example consists of the main memory 42 and central processing unit 44 of the scanning node or workstation 16. The scanner 14 includes a projection system 46 that projects a pattern onto the object 40 along a first projection axis 48. The projected pattern is formed on a slide 50 which is placed in front of a light source 53. The light source 53 includes the terminus of a fiber-optic cable 51. The cable 51 carries a high intensity flash generated by a flash lamp 52 located in a base unit 54 for the scanner. A suitable flash lamp is the model FX-1160 flash unit available from Perkin Elmer. The illuminations of the flash lamp 52 cause the pattern contained in the slide 50 to be projected onto the three-dimensional surface of the object. The scanner 14 further includes an electronic imaging device 56 including an array of photo-sensitive pixels, such as an off-the-shelf, color-sensitive, charged-coupled device (CCD) of a size of 1028.times1028 pixels arranged in an array of rows and columns. The Sony ICX205AK CCD chip is a suitable electronic imaging device. The electronic imaging device 56 is oriented perpendicular to a second imaging axis 58, which is off-set from the projection axis 48. The angle between the projection and imaging axes need not be known. If the 3D calculations are made in accordance with the parameters of FIG. 9, then the angle and the separation distance between the center of the imaging device 56 and the center of the light source 53 need to be known. The angle .PSI. will be optimized during design and manufacture of the scanner depending on the desired resolution required by the scanner. This, in turn, is dependent on the degree to which the surface under scrutiny has undercuts and shadowing features which would result in the failure of the imaging device to detect the projection pattern. The greater the angle is, the greater the accuracy of the scanner. However as the angle increases, the presence of undercuts and shadowing features will block the reflected pattern and prevent capture of the pattern and subsequent three-dimensional analysis of those portions of the surface. The angle is shown somewhat exaggerated in FIG. 2, and will generally range between 10 and 30 degrees for most applications. The electronic imaging device 56 forms an image of the projection pattern after reflection of the pattern off of the surface of the object 40. The reflected patterns imaged by the imaging device contain three-dimensional information as to the surface of the object, and this information needs to be extracted from the images. The scanning system therefore includes a processing subsystem which is used to extract this information and construct a three-dimensional virtual model of the object 40. This processing subsystem consists of memory 42 storing calibration information for the scanner, and at least one processing unit, such as the central processing unit 44 of the scanning workstation 16. The location of the memory and the processing unit is not important. They can be incorporated into the scanner 14 per se. Alternatively, all processing of the images can take place in the back office server 28 or in another computer. Alternatively, two or more processing units could share the processing in order to reduce the amount of time required to generate the three-dimensional information. The memory 42 stores a calibration relationship such as a table for the scanner 14. The calibration table includes information used to compute three-dimensional coordinates of points on the object that reflected the projection pattern onto the imaging device. The information for the table is obtained during a calibration step, performed at the time of manufacture of the scanner 14. The calibration table includes an array of data storage locations that contain two pieces of information. Firstly, the calibration table stores pixel coordinates in X and Y directions for numerous portions of the projection pattern that are imaged by the electronic imaging device 56, when the pattern is projected onto a calibration surface at two different distances during a calibration procedure. Secondly, the table stores distance information, (e.g., in units of tenths of millimeters), in X and Y directions, for the portions of the projection pattern imaged at the two different distances. The scanning system requires at least one processing unit to perform image processing, three-dimensional calculations for each image, and registration of frames to each other. The processing unit 44 is the central processing unit (CPU) of the scanning work station 16. The CPU 44 processes the image of the pattern after reflection of the pattern off the surface of the object 40 and compares data from the image to the entries in the calibration table. From that comparison (or, more precisely, interpolation relative to the entries in the table, as explained below), the processing unit 44 derives spatial information, in three dimensions, of points on the object that reflect the projected pattern onto the electronic imaging device. Basically, during operation of the scanner to scan an object of unknown surface configuration, hundreds or thousands of images are generated of the projection pattern as reflected off of the object in rapid succession. For each image, pixel locations for specific portions, i.e., points, of the reflected pattern are compared to entries in the calibration table. X, Y and Z coordinates (i.e., three dimensional coordinates) are obtained for each of these specific portions of the reflected pattern. For each picture, the sum total of all of these X, Y and Z coordinates for specific points in the reflected pattern include a three-dimensional “frame” or virtual model of the object. When hundreds or thousands of images of the object are obtained from different perspectives, as the scanner is moved relative to the object, the system generates hundreds or thousands of these frames. These frames are then registered to each other to thereby generate a complete and highly accurate three-dimensional model of the object 40. Stray data points are preferably canceled out in generating the calibration table or using the calibration table to calculate three-dimensional coordinates. For example, a smoothing function such as a spline can be calculated when generating the entries for the calibration table, and the spline used to cancel or ignore data points that deviate significantly from the spline.

Referring still to FIG. 5 after the CCD imaging device 56 captures a single image, the analog voltage signals from the device 56 are amplified in an amplifier 57 and fed along a conductor 59 to an analog to digital converter 60. The digital signal is converted into a bitmap stream of digital image data. The data is formatted by a module 61 into an IEEE 1394 “firewire” format for transmission over a second conductor 62 to the main memory 42 of the scanner work station 16. The scanning system includes an optical scanner holder 64 for the user to place the scanner after the scanning of the dentition is complete. These details are not particularly important and can vary considerably. The scanning system is constructed to provide a minimum of equipment and clutter at the chair side. Hence, the scanning station is preferably located some distance away from the chair where the patient sits. The cable leading from the scanner 14 to the base station and/or workstation 16 could be suspended from the ceiling to further eliminate chair-side clutter. The scanning work station 16 also includes the monitor 20 for displaying the scanning results as a three-dimensional model of the dentition in real time as the scanning is occurring. The user interface also includes a keyboard and mouse for manipulating the virtual model of the object, and for entering or changing parameters for the scanning, identifying sections or segments of scans that have been obtained, and other features. The scanning station may also include a foot switch, not shown, for sending a signal to the CPU 44 indicating that scanning is commencing and scanning has been completed. The base station may alternatively include a voice recognition module that is trained to recognize a small set of voice commands such as START, STOP, AGAIN, REPEAT, SEGMENT, ONE, TWO, THREE, FOUR, etc., thereby eliminating the need for the foot switch. Scanner start and stop commands from the CPU 44, in the form of control signals, are sent to the light source 52, thereby controlling the illumination of the lamp 52 during scanning. The light source 52 operates at a suitable frequency, such as 6 flashes per second, and the frame rate of the CCD imaging device 56 is synchronized with the frame rate. With a frame rate of 6 flashes per second, and a scanning motion of say 1-2 centimeters per second, a large of overlap between images is obtained. The size of the mirror at the tip 68 of the scanner influences the speed at which scanning is possible. The mirror at the tip 68 is 18 mm square. A larger mirror reflects more surface of the object and enables faster scanning. A smaller mirror requires slower scanning. The larger the mirror, the more difficult in-vivo scanning becomes, so some trade-off between size and utility for in-vivo scanning exists. The mirror 18 is heated to prevent fogging during in vivo scanning by a resistance heater coil. This overlap between images generated by the scanner 14, and resulting three dimensional frames, allows a smooth and accurate registration of frames relative to each other. The frame rate and permissible rate of scanner motion will depend on many factors and can of course vary within the scope of the invention. A preferred frame rate will be at least one flash per second. Flashing a high intensity flash lamp for a brief period of time is preferred since it is desirable to reduce the exposure time of the CCD imaging device 56 to reduce blurring. A high intensity lamp is desirable to achieve sufficient signal strength from the imaging device. A 5 microsecond flash times with similar exposure periods. As an alternative one would use a constant illumination source of high intensity, and control exposure of the imaging device using a shutter, either a physical shutter or using electronic shutter techniques, such as draining charge accumulating in the pixels prior to generating an image. Scanning using longer exposures would be possible without image blur, using electronic image motion compensation techniques described in U.S. Pat. No. 5,155,597.

Referring to FIG. 6 a system 10 for designing and producing dental appliances includes a dental service center 23, one or more dental clinics 22, and one or more dental labs 26. The dental clinics 22 and the dental labs 26 are linked to each other and each to the dental service center 23 via a communication means or network such as for example the Internet or other suitable communications medium such as an intranet, local access network, public switched telephone network, cable network, satellite communication system, and the like, indicated by the cloud at 24. Optionally, it is also possible for some dental clinics 22 to be linked to each other, and/or for some dental labs 26 to be linked to each other, via the same one or a different one of said communication medium, for example when such dental clinics or labs form part of a common commercial entity. Further optionally, such interlinked dental clinics 22 and/or dental labs 26 may be further linked with other entities, for example a head clinic or head lab, including a centralized data base (not shown). Digitized three-dimensional (3D) information W (FIG. 2) of the patient's intra-oral cavity, or part thereof, is created by the system, and this information is then used by the dental labs 26 and/or the service center 23 for designing and/or manufacturing a custom dental prosthesis in an optimal and cost efficient manner. Accordingly, acquiring an accurate 3D representation of the intraoral cavity is the first step that is carried out by the system. Typically, the 3D information is obtained at the clinic 22, but this information may be obtained, alternatively, by one of the dental labs 26 or the service centre 23, as described herein. Each dental clinic 22 may provide the 3D digitized data of the intraoral cavity, including the dentition and associated anatomical structures of a patient, and includes suitable equipment for scanning a patient's teeth. Such equipment may include, for example, a hand-held scanner 31 that is used by the practitioner to acquire the 3D data. Advantageously, a probe for determining three dimensional structure by confocal focusing of an array of light beams may be used, for example as manufactured under the name of PROSTHOCAD or as disclosed in WO 00/08415, the contents of which are incorporated herein by reference in their entirety. The 3D data obtained by the probe may then be stored in a suitable storage medium, for example a memory in a computer workstation 32, before being sent over the communication network 24 to the dental service center 23 and/or to the dental lab 26, for further processing, as described below. Alternatively, each clinic 22 may include equipment for obtaining a negative casting of a patient's teeth. In this case, the negative cast or impression is taken of the patient's teeth, in a manner known in the art, and this negative model 33 is dispatched to one of the dental labs 26 that is equipped to prepare from the negative model a positive cast 34 suitable for scanning. The positive cast 34 may be scanned at the dental lab 26 by any method known in the art, including using the aforesaid probe manufactured under the name of PROSTHOCAD or as disclosed in WO 00/08415. The 3D data is then transmitted over the network 24 to the service center 23. Alternatively, the positive cast 34 may be dispatched to the service center 23 by the dental clinic 22 and scanned at the service center to obtain the 3D data. Alternatively, the service center 23 produces a positive model 34 from the negative model 33 and is scanned thereat, or sent to the dental clinic 22 to be scanned thereat. Alternatively, the negative model 33 is scanned, either at the dental lab 26 or at the service center 23. Alternatively, the negative model 33 provided by the clinic 22 is sent to the service center 23, either directly by the clinic 22, or indirectly via the dental lab 26, and a composite positive-negative model may be manufactured from the original negative model. Thereafter, the positive-negative model may be processed to obtain 3D digitized data, for example as disclosed in U.S. Pat. No. 6,099,314, assigned to the present assignee, and the contents of which are incorporated herein in their entirety. Alternatively, the 3D digitized data may be obtained in any other suitable manner, including other suitable intra oral scanning techniques, based on optical methods, direct contact or any other means, applied directly to the patient's dentition. Alternatively, X-ray based, CT based, MRI based, or any other type of scanning of the patient or of a positive and/or negative model of the intra-oral cavity may be used. The dimensional data may be associated with a complete dentition, or of a partial dentition, for example such as a preparation only of the intra oral cavity. Once the 3D digitized data is obtained, the next step is to design the dental prosthesis in question, followed by the manufacture thereof, and finally the installation of the appliance in the oral cavity of the patient. The design and the manufacture of the appliance may each be carried out at the dental lab 26 or at the service centre 23, or alternatively one or both of these activities may be shared between the two; in each case the design and manufacture are based on the original 3D data of the oral cavity previously obtained. The dental lab 26 includes a laboratory, or a design or manufacturing entity that provides direct technical services to the dental clinic 22. Such services include, for example, scanning, manufacturing, analyzing the preparation in the intra oral cavity to mark the location of the finish line, for example, as disclosed in U.S. Ser. No. 10/623,707 and WO 04/008981, also assigned to the present assignee, and the contents of which are incorporated herein in their entirety, and so on. The dental lab is characterized as being equipped or otherwise able to design part or whole appliances, and/or to partially manufacture or assemble the same, particularly where close tolerances are relatively less critical. On the other hand, while the service center 23 is also equipped to design part or whole appliances, and/or to fully or partially manufacture and/or assemble the same, it is particularly suited to do any of these activities where close or tight tolerances are in fact critical and/or difficult to achieve. The service center 23 is a different design and manufacturing entity to the dental lab 26 and is thus separate thereto. However, while the service centre 23 may be located in a different geographical zone to the dental clinic 26, for example, different countries, different cities in the same country, different neighborhoods in the same city, or even different buildings in the same neighborhood, they may also be housed in the same building, and in any case maintain their separate functions and capabilities. Typically, for any given prosthesis, the service center 23 shares at least the manufacturing of the prosthesis with one dental lab 26 according to predetermined criteria, as will be further elaborated herein. Nevertheless, the manufacturing for a particular prosthesis may also be shared between the service center 23 and a number of dental labs 26, each of which contributes a part of the manufacture. The same applies also to the design of the prosthesis, which may be executed at the same or a different dental lab 26, and optionally also shared with the service center 23. The dental lab 26 is typically located in the same locality as the clinic 22 that it services, though the two may alternatively be geographically remote. Thus, the dental lab 26 and the clinic 22 that it services may both be located in the same building or complex, or in different parts of the same city, or in different cities or countries. However, the dental lab 26 of the invention typically has an established working relationship with the clinic 22, and thus tends to be, generally, within the same city.

Referring to FIG. 7 in conjunction with FIG. 8 block diagrams illustrate a cloud-based image processing system. The system 100 includes one or more entities or institutes 101-102 communicatively coupled to cloud 103 over a network. Entities 101-102 may represent a variety of organizations such as medical institutes having a variety of facilities residing all over the world. For example, entity 101 may include or be associated with image capturing device or devices 104, image storage system (e.g., PACS) 105, router 106, and/or data gateway manager 107. Image storage system 105 may be maintained by a third party entity that provides archiving services to entity 101, which may be accessed by workstation 108 such as an administrator or user associated with entity 101. Note that throughout this application, a medical institute is utilized as an example of an organization entity. However, it is not so limited; other organizations or entities may also be applied. Cloud 103 may represent a set of servers or clusters of servers associated with a service provider and geographically distributed over a network. For example, cloud 103 may be associated with a medical image processing service provider such as TeraRecon of Foster City, Calif. A network may be a local area network (LAN), a metropolitan area network (MAN), a wide area network (WAN) such as the Internet or an intranet, or a combination thereof. Cloud 103 can be made of a variety of servers and devices capable of providing application services to a variety of clients such as clients 113-116 over a network. In one The cloud 103 includes one or more cloud servers 109 to provide image processing services, one or more databases 110 to store images and other medical data, and one or more routers 112 to transfer data to/from other entities such as entities 101-102. If the cloud server consists of a server cluster, or more than one server, rules may exist which control the transfer of data between the servers in the cluster. For example, there may be reasons why data on a server in one country should not be placed on a server in another country. The server 109 may be an image processing server to provide medical image processing services to clients 113-116 over a network. For example, server 109 may be implemented as part of a TeraRecon AquariusNET™ server and/or a TeraRecon AquariusAPS server. Data gateway manager 107 and/or router 106 may be implemented as part of a TeraRecon AquariusGATE device. Medical imaging device 104 may be an image diagnosis device, such as X-ray CT device, MRI scanning device, nuclear medicine device, ultrasound device, or any other medical imaging device. Medical imaging device 104 collects information from multiple cross-section views of a specimen, reconstructs them, and produces medical image data for the multiple cross-section views. Medical imaging device 104 is also referred to as a modality. Database 110 may be a data store to store medical data such as digital imaging and communications in medicine (DICOM) compatible data or other image data. Database 110 may also incorporate encryption capabilities. Database 110 may include multiple databases and/or may be maintained by a third party vendor such as storage providers. Data store 110 may be implemented with relational database management systems (RDBMS), e.g., Oracle™ database or Microsoft® SQL Server, etc. Clients 113-116 may represent a variety of client devices such as a desktop, laptop, tablet, mobile phone, personal digital assistant (PDA), etc. Some of clients 113-116 may include a client application (e.g., thin client application) to access resources such as medical image processing tools or applications hosted by server 109 over a network. Examples of thin clients include a web browser, a phone application and others. The server 109 is configured to provide advanced image processing services to clients 113-116, which may represent physicians from medical institutes, agents from insurance companies, patients, medical researchers, etc. Cloud server 109, also referred to as an image processing server, has the capability of hosting one or more medical images and data associated with the medical images to allow multiple participants such as clients 113-116, to participate in a discussion/processing forum of the images in a collaborated manner or conferencing environment. Different participants may participate in different stages and/or levels of a discussion session or a workflow process of the images. Dependent upon the privileges associated with their roles (e.g., doctors, insurance agents, patients, or third party data analysts or researchers), different participants may be limited to access only a portion of the information relating to the images or a subset of the tools and functions without compromising the privacy of the patients associated with the images. The data gateway manager 107 is configured to automatically or manually transfer medical data to/from data providers (e.g., PACS systems) such as medical institutes. Such data gateway management may be performed based on a set of rules or policies, which may be configured by an administrator or authorized personnel. In response to updates of medical images data during an image discussion session or image processing operations performed in the cloud, the data gateway manager is configured to transmit over a network (e.g., Internet) the updated image data or the difference between the updated image data and the original image data to a data provider such as PACS 105 that provided the original medical image data. Similarly, data gateway manager 107 can be configured to transmit any new images and/or image data from the data provider, where the new images may have been captured by an image capturing device such as image capturing device 104 associated with entity 101. In addition, data gateway manager 107 may further transfer data amongst multiple data providers that is associated with the same entity (e.g., multiple facilities of a medical institute). Furthermore, cloud 103 may include an advanced preprocessing system (not shown) to automatically perform certain pre-processing operations of the received images using certain advanced image processing resources provided by the cloud systems. A gateway manager 107 is configured to communicate with cloud 103 via certain Internet ports such as port 80 or 443, etc. The data being transferred may be encrypted and/or compressed using a variety of encryption and compression methods. The term “Internet port” in this context could also be an intranet port, or a private port such as port 80 or 443 etc. on an intranet. Thus, using a cloud-based system for advanced image processing has several advantages. A cloud system refers to a system which is server-based, and in which the software clients are very thin—possibly just a web browser, a web browser with a plug-in, or a mobile or phone application, etc. The server or server cluster in the cloud system is very powerful computationally and can support several users simultaneously. The server may reside anywhere and can be managed by a third party so that the users of the software in the cloud system do not need to concern themselves with software and hardware installation and maintenance. A cloud system also allows for dynamic provisioning. For example, if facility X needs to allow for a peak of 50 users, they currently need a 50 user workstation or client-server system. If there are 10 such facilities, then a total of 500 users must be provided for with workstations, or client-server equipment, IT staff, etc. Alternatively, if these same facilities use a cloud service, and for example, the average number of simultaneous users at each place is 5 users, then the cloud service only needs to provide enough resource to handle the average (5 simultaneous users) plus accommodations for some peaks above that. For the facilities, this would mean 50 simultaneous users to cover the average and conservatively 100 simultaneous users to cover the peaks in usage. This equates to a 150-user system on the cloud system vs. a 500-user system using workstations or a client-server model, resulting in a 70% saving in cost of equipment and resources etc. This allows lower costs and removes the need for the individual sites to have to manage the asset. Cloud computing provides computation, software, data access, and storage services that do not require end-user knowledge of the physical location and configuration of the system that delivers the services. Cloud computing providers deliver applications via the Internet, which are accessed from Web browsers, desktop and mobile apps, while the business software and data are stored on servers at a remote location. Cloud application services deliver software as a service over the Internet, eliminating the need to install and run the application on the customer's own computers and simplifying maintenance and support. A cloud system can be implemented in a variety of configurations. For example, a cloud system can be a public cloud system as shown in FIG. 7, a community cloud system, a hybrid cloud system, a private cloud system as shown in FIG. 8, or a combination thereof. Public cloud describes cloud computing in the traditional mainstream sense, whereby resources are dynamically provisioned to the general public on a self-service basis over the Internet, via Web applications/Web services, or other internet services, from an off-site third-party provider who bills on a utility computing basis. Community cloud shares infrastructure between several organizations from a specific community with common concerns (security, compliance, jurisdiction, etc.), whether managed internally or by a third-party and hosted internally or externally. The costs are spread over fewer users than a public cloud (but more than a private cloud), so only some of the benefits of cloud computing are realized. Hybrid cloud is a composition of two or more clouds (private, community, or public) that remain unique entities but are bound together, offering the benefits of multiple deployment models. Briefly it can also be defined as a multiple cloud systems which are connected in a way that allows programs and data to be moved easily from one deployment system to another. Private cloud is infrastructure operated solely for a single organization, whether managed internally or by a third-party and hosted internally or externally. Generally, access to a private cloud is limited to that single organization or its affiliates. With cloud computing, users of clients such as clients 113-116 do not have to maintain the software and hardware associated with the image processing. The users only need to pay for usage of the resources provided from the cloud as and when they need them, or in a defined arrangement, such as a monthly or annual contract. There is minimal or no setup and users can sign up and use the software immediately. In some situations, there may be a small software installation, like a Citrix or java or plug-in. Such a configuration lowers up-front and maintenance costs for the users and there is no or lower hardware, software, or maintenance costs. The cloud servers can handle backups and redundancies and security so the users do not have to worry about these issues. The users can have access to all and the newest clinical software without having to install the same. Tools and software are upgraded (automatically or otherwise) at the servers to the latest versions. Access to tools is driven by access level, rather than by software limitations. Cloud servers can have greater computational power to preprocess and process images and they can be larger and more powerful with better backup, redundancy, security options. For example, a cloud server can employ volume rendering techniques available from TeraRecon to render large volume of medical images. Further detailed information concerning the volume rendering techniques can be found in U.S. Pat. No. 6,008,813 and U.S. Pat. No. 6,313,841. Image processing services provided by cloud 103 can be provided based on a variety of licensing models, such as, for example, based on the number of users, case uploads (e.g., number of cases, number of images or volume of image data), case downloads (e.g., number of cases, number of images or volume of image data), number of cases processed and/or viewed, image processing requirements, type of user (e.g., expert, specialty or general user), by clinical trial or by research study, type of case, bandwidth requirements, processing power/speed requirements, priority to processing power/speed (e.g., system in ER may pay for higher priority), reimbursement or billing code (e.g., user may only pay to perform certain procedures that are reimbursed by insurance), time using software (e.g., years, months, weeks, days, hours, even minutes), time of day using software, number of concurrent users, number of sessions, or any combination thereof.

Referring to FIG. 9 a block diagram illustrates a cloud-based image processing system. For example, a system 200 may be implemented as part of the systems as shown in FIG. 7 and FIG. 8. The system 200 includes server 109 communicatively coupled to one or more clients 202-203 over network 201, which may be a LAN, MAN, WAN, or a combination thereof. Server 109 is configured to provide cloud-based image processing services to clients 202-203 based on a variety of usage licensing models. Each of clients 202-203 includes a client application such as client applications 211-212 to communicate with a server counterpart 209, respectively, to access resources provided by server 109. Server application 209 may be implemented as a virtual server or instance of the server application 209, one for each client. The server 109 includes, but is not limited to, workflow management system 205, medical data store 206, image processing system 207, medical image collaboration system 208, and access control system 210. Medical data store 206 may be implemented as part of database 110 of FIGS. 1A and 1B. Medical data store 206 is utilized to store medical images and image data received from medical data center (e.g., PACS systems) 105 or other image storage systems 215 (e.g., CD-ROMs, or hard drives) and processed by image processing system 207 and/or image preprocessing systems 204. Image processing system 207 includes a variety of medical imaging processing tools or applications that can be invoked and utilized by clients 202-203 via their respective client applications 211-212, respectively, according to a variety of licensing terms or agreements. It is possible that in some medical institutes that the image storage system 215 and the image capturing device 104 may be combined. In response to image data received from medical data center 105 or from image capturing devices (not shown) or from another image source, such as a CD or computer desktop image preprocessing system 204 may be configured to automatically perform certain preprocesses of the image data and store the preprocessed image data in medical data store 206. For example, upon receipt of image data from PACS 105 or directly from medical image capturing devices, image preprocessing system 204 may automatically perform certain operations, such as bone removal, centerline extraction, sphere finding, registration, parametric map calculation, reformatting, time-density analysis, segmentation of structures, and auto-3D operations, and other operations. Image preprocessing system 204 may be implemented as a separate server or alternatively, it may be integrated with server 109. Furthermore, image preprocessing system 204 may perform image data preprocesses for multiple cloud servers such as server 109. A client/server image data processing architecture is installed on system 200. The architecture includes client partition (e.g., client applications 211-212) and server partition (e.g., server applications 209). The server partition of system 200 runs on the server 109, and communicates with its client partition installed on clients 202-203, respectively. The server 109 is distributed and running on multiple servers. The system is a Web-enabled application operating on one or more servers. Any computer or device with Web-browsing application installed may access and utilize the resources of the system without any, or with minimal, additional hardware and/or software requirements. The server 109 may operate as a data server for medical image data received from medical image capturing devices. The received medical image data is then stored into medical data store 206. When the client 202 requests for unprocessed medical image data, server application 209 retrieves the data from the medical data store 206 and renders the retrieved data on behalf of client 202. Image preprocessing system 204 may further generate workflow information to be used by workflow management system 205. Workflow management system 205 may be a separate server or integrated with server 109. Workflow management system 205 performs multiple functions. For example, workflow management system 205 performs a data server function in acquiring and storing medical image data received from the medical image capturing devices. It may also act as a graphic engine or invoke image processing system 207 in processing the medical image data to generate 2D or 3D medical image views. Workflow management system 205 invokes image processing system 207 having a graphics engine to perform 2D and 3D image generating. When a client (e.g., clients 202-203) requests for certain medical image views, workflow management system 205 retrieves medical image data stored in medical data store 206, and renders 2D or 3D medical image views from the medical image data. The end results for medical image views are sent to the client. When a user making adjustments to the medical image views received from server 109, these user adjustment requests are sent back to the workflow management system 205. Workflow management system 205 then performs additional graphic processing based on the user requests, and the newly generated, updated medical image views are returned to the client. This approach is advantageous because it eliminates the need to transport large quantity of unprocessed medical image data across network, whfe providing 2D or 3D image viewing to client computers with minimal or no 2D or 3D image processing capacity. As described above, when implemented as a cloud based application, system 200 includes a client-side partition and a server-side partition. Functionalities of system 200 are distributed to the client-side or server-side partitions. When a substantial amount of functionalities are distributed to the client-side partition, system 200 may be referred to as a “thick client” application. Alternatively, when a limited amount of functionalities are distributed to the client-side partition, while the majority of functionalities are performed by the server-side partition, system 200 may be referred to as a “thin client” application. Functionalities of system 200 may be redundantly distributed both in client-side and server-side partitions. Functionalities may include processing and data. Server 109 may be implemented as a web server. The web server may be a third-party web server (e.g., Apache™ HTTP Server, Microsoft® Internet Information Server and/or Services, etc). The workflow management system 205 manages the creation, update and deletion of workflow templates. It also performs workflow scene creation when receiving user requests to apply a workflow template to medical image data. A workflow is defined to capture the repetitive pattern of activities in the process of generating medical image views for diagnosis. A workflow arranges these activities into a process flow according to the order of performing each activity. Each of the activities in the workflow has a clear definition of its functions, the resource required in performing the activity, and the inputs received and outputs generated by the activity. Each activity in a workflow is referred to as a workflow stage, or a workflow element. With requirements and responsibilities clearly defined, a workflow stage of a workflow is designed to perform one specific task in the process of accomplishing the goal defined in the workflow. For many medical image studies, the patterns of activities to produce medical image views for diagnosis are usually repetitive and clearly defined. Therefore, it is advantageous to utilize workflows to model and document real life medical image processing practices, ensuring the image processing being properly performed under the defined procedural rules of the workflow. The results of the workflow stages can be saved for later review or use. A workflow for a specific medical image study is modeled by a workflow template. A workflow template is a template with a predefined set of workflow stages forming a logical workflow. The order of processing an activity is modeled by the order established among the predefined set of workflow stages. Workflow stages in a workflow template are ordered sequentially, with lower order stages being performed before the higher order stages. Dependency relationships are maintained among the workflow stages. Under such arrangement, a workflow stage cannot be performed before the workflow stages it is depending on being performed first. Advanced workflow management allows one workflow stage depending on multiple workflow stages, or multiple workflow stages depending on one workflow stage, etc. The image processing operations receive medical image data collected by the medical imaging devices as inputs, process the medical image data, and generate metadata as outputs. Metadata, also known as metadata elements, broadly refers to parameters and/or instructions for describing, processing, and/or managing the medical image data. For instance, metadata generated by the image processing operations of a workflow stage includes image processing parameters that can be applied to medical image data to generate medical image views for diagnostic purpose. Further, various automatic and manual manipulations of the medical image views can also be captured as metadata. Thus, metadata allows the returning of the system to the state it was in when the metadata was saved. After a user validates the results generated from processing a workflow stage predefined in the workflow template, workflow management system 205 creates a new scene and stores the new scene to the workflow scene. Workflow management system 205 also allows the updating and saving of scenes during user adjustments of the medical image views generated from the scenes. Further detailed information concerning workflow management system 205 can be found in co-pending U.S. patent application Ser. No. 12/196,099, entitled “Workflow Template Management for Medical Image Data Processing,” filed Aug. 21, 2008, which is incorporated by reference herein in its entirety. Referring still to FIG. 9 the server 109 further includes access control system 210 to control access of resources (e.g., image processing tools) and/or medical data stored in medical data store 206 from clients 202-203. Clients 202-203 may or may not access certain portions of resources and/or medicate data stored in medical data store 206 dependent upon their respective access privileges. The access privileges may be determined or configured based on a set of role-based rules or policies. For example, some users with certain roles can only access some of the tools provided by the system. Examples of some of the tools available are listed at the end of this document, and include vessel centerline extraction, calcium scoring and others. Some users with certain roles are limited to some patient information as shown in FIG. 3B. Some users with certain roles can only perform certain steps or stages of the medical image processes as shown in FIG. 3C. Steps or stages are incorporated into the tools (listed at the end of this document) and might include identifying and/or measuring instructions, validation of previously performed steps or stages and others. Some users with certain roles are limited to certain types of processes as shown in FIG. 3D.

Referring to FIG. 10 a workflow package may have a pre-defined pathway (e.g. series of recipients, organizations and/or groups of recipients) based on specified workflow tasks, which may be pre-determined, through which the workflow package travels. Each recipient may modify the workflow package based on the workflow tasks included in the workflow package. In this way a series of workflow tasks may be automated, thereby decreasing the amount of labor expended to perform the workflow tasks. As a result the efficiency within the business entity may be increased.

U.S. Pat. No. 8,532,807 pre-operative planning and manufacturing method for orthopedic surgery includes obtaining pre-operative medical image data representing a joint portion of a patient. The method also includes constructing a three-dimensional digital model of the joint portion and manufacturing a patient-specific alignment guide for the joint portion from the three-dimensional digital model of the joint portion when the image data is sufficient to construct the three-dimensional digital model of the joint portion. The patient-specific alignment guide has a three-dimensional patient-specific surface pre-operatively configured to nest and closely conform to a corresponding surface of the joint portion of the patient in only one position relative to the joint portion. The method further includes determining, from the image data, a size of a non-custom implant to be implanted in the patient and manufacturing the non-custom implant when there is insufficient image data to construct the patient-specific alignment guide therefrom. The various pre-operative planning methods for orthopedic procedures can be employed for planning partial or total knee joint replacement surgery. Specifically, image data from medical scans of the patient can be provided, and if there is sufficient two-dimensional image data, an accurate three-dimensional digital model of the knee joint can be generated as well as a three-dimensional digital model of a patient-specific alignment guide. If there is insufficient two-dimensional image data to generate the three-dimensional digital model and a patient-specific alignment guide therefrom, the image data can still be used to determine a size of a non-custom prosthesis to be implanted. The image data can also be used to determine sizes and dimensions for instruments (e.g., resection guides, etc.) that will be used during surgery. Moreover, a kit can be pre-operatively assembled containing the selected alignment guide(s), prosthetic device(s), trial prosthetic device(s), instruments, etc. that will be used during surgery for a particular patient. These methods can, therefore, make pre-operative planning more efficient. Also, the surgical procedure can be more efficient since the prosthetic device and the related surgical implements can be tailored for the particular patient.

Referring initially to FIG. 11 a pre-operative planning tool 10 is illustrated. The tool 10 can be computer-based and can generally include a receiving device 12, a processor 14, a memory device 16, and a display 18. The receiving device 12 can receive medical image data 20 of a joint portion 24 (e.g., a knee joint) of a patient. Representative image data 20 of a knee joint portion 24 (including a femur F and a tibia T). It will be appreciated that the image data 20 can include any number of images of the joint portion 24, taken from any viewing perspective. Specifically, the receiving device 12 can receive medical scans prepared by a Magnetic Resonance Imaging (MRI) device, a Computed Tomography (CT) scanner, a radiography or X-ray machine, an ultrasound machine, a camera or any other imaging device 22. The imaging device 22 can be used to generate electronic (e.g., digital) image data 20. The image data 20 can be stored on a physical medium, such as a CD, DVD, flash memory device (e.g. memory stick, compact flash, secure digital card), or other storage device, and this data 20 can be uploaded to the tool 10 via a corresponding drive or other port of the receiving device 12. The image data 20 may alternatively, or in addition, be transmitted electronically to the receiving device 12 via the Internet or worldwide web using appropriate transfer protocols. Also, electronic transmissions can include e-mail or other digital transmission to any appropriate type of computer device, smart phone, PDA or other devices in which electronic information can be transmitted. The memory device 16 can be of any suitable type (RAM and/or ROM), and the medical image data 20 can be inputted and stored in the memory device 16. The memory device 16 can also store any suitable software and programmed logic thereon for completing the pre-operative planning discussed herein. For instance, the memory device 16 can include commercially-available software, such as software from Materialize USA of Plymouth, Mich. The processor 14 can be of a known type for performing various calculations, analyzing the data, and other processes discussed here-in-below. Also, the display 18 can be a display of a computer terminal or portable device, such as an electronic tablet, or any other type of display. As will be discussed, the display 18 can be used for displaying the medical image data 20 and/or displaying digital anatomical models generated from the image data 20 and/or displaying other images, text, graphics, or objects. It will also be appreciated that the pre-operative planning tool 10 can include other components that are not illustrated. For instance, the planning tool 10 can include an input device, such as a physical or electronic keyboard, a joystick, a touch-sensitive pad, or any other device for inputting user controls. The image data 20 can be analyzed and reviewed (manually or automatically) using the tool 10 to determine whether the image data 20 is sufficient enough to generate and construct a three-dimensional (3-d) digital model 26a, 26b of the joint 24. For instance, if the image data 20 was collected by MRI or other higher-resolution imaging device, there are likely to be a relatively large number of two-dimensional images of the joint 24 taken at different anatomical depths, and these images can be virtually assembled (“stacked”) by the processor 14 to generate the three-dimensional electronic digital model 26a, 26b of the patient's anatomy. Using these digital models 26a, 26b, a first surgical plan 30 (FIG. 1) can be generated, and a corresponding kit 33 can be manufactured and assembled. As will be discussed, the kit 33 can include the physical components necessary for surgery, including patient-specific alignment guide(s), selected prosthetic devices, trial prosthetic devices, surgical instruments, and more. The kit 33 can be sterilized and shipped to be available for surgery for that particular patient. However, if the image data 20 was collected by X-ray or other lower-resolution imaging device, there is unlikely to be sufficient data about the joint 24 to generate accurate three-dimensional digital models 26a, 26b. Regardless, the two-dimensional image data 20 can still be used to generate a second surgical plan 3 and a corresponding kit 34 can be assembled. The kit 34 can include a selected non-patient-specific (non-custom) implant, trial implant, surgical instruments, and more. However, the items within the kit 34 can be size-specific (i.e., the size of the items in the kit 34 can be pre-operatively selected for the particular patient). It will be appreciated that the same tool 10 can be used for planning purposes, regardless of whether the image data 20 is sufficient to generate three-dimensional digital models of the joint 24 or not. Thus, for instance, if the patient is able and willing to undergo MRI to obtain highly detailed images as recommended by the surgeon, the tool 10 can be used to generate a surgical plan 30 and to manufacture implements that are highly customized for that patient. Otherwise, if the patient is unable or unwilling to undergo MRI (e.g., because the patient has a pacemaker, because the patient has claustrophobia, because MRI is not recommended by the surgeon, etc.), the tool 10 can still be used to generate the surgical plan 32, albeit with implements that are selected from inventory or manufactured on a non-custom basis. In either case, the surgery can be planned and carried out efficiently.

Referring to FIG. 12 a method 40 of using the tool 10 can begin in block 42, in which the image data 20 is obtained. As mentioned above, the image data 20 can be obtained from an MRI device, an X-ray device, or the like. In the case of data 20 obtained by X-ray, one or more radio-opaque (e.g., magnetic) markers or scaling devices 43 can be used as shown in FIG. 3. These devices 43 can be of a known size and shape. For instance, the devices 43 can be discs that measure ten centimeters in diameter, or the devices 43 can be elongate strips or other shapes with known dimensions. The devices 43 can be placed over the patient's knee joint 24 before the X-ray is taken. The devices 43 will be very visible in the X-ray image. Since the actual size of the devices 43 are known, the size of the device 43 can be compared against the anatomical measurements taken from the image, and the scale of anatomy in the image can be thereby detected. The method 40 can continue in block 44, in which the image data 20 can be evaluated, and in block 46, it can be determined whether there is enough data to generate accurate 3-d digital model(s) 26a, 26b of the joint 24. “Accurate” in this context means that the image data 20 is sufficient and detailed enough to generate precise representations of the anatomical joint 24. More specifically, “accurate 3-d models” are those that are detailed and precise enough to construct a patient-specific alignment guide therefrom. (Patient-specific alignment guides will be discussed in greater detail below.) It is noted that three 3-d models can still be generated from a lesser or insufficient number of medical scans, although such 3-d models will not be accurate enough to generate patient-specific alignment guides that mirror the corresponding joint surfaces of the specific patients.

U.S. Pat. No. 8,149,111 teaches a central facility which communicates with a portable container via a mobile device. A computer at the central facility receives (a) usage data, in association with identification tag information for the portable container, from the mobile device associated with the portable container, the usage data generated by a usage sensor in the portable container, (b) environmental data from the mobile device associated with the portable container, the environmental data generated by an environmental sensor, and (c) patient data from the mobile device associated with the portable container, the patient data generated by a patient sensor. The central facility computer stores the usage data, the environmental data and the patient data in a record associated with the identification tag information. The central facility computer analyzes the usage data, the environmental data and the patient data relative to a situational rule, to determine an action. The central facility computer sends (i) action data to the mobile device associated with the portable container, and (ii) notice data to a third party in accordance with a notification rule. The central facility computer stores the action data and the notice data in the record associated with the identification tag information.

Referring to FIG. 13 there are illustrated communication network 5, product management system 10, customer 20, customer practice management system 25, shipping module 60, field device 70 and regulator 95. Communication network 5 may be any wireline or wireless network, such as the Internet, a private virtual network, a private dedicated network and so on. Further, communication network 5 may be embodied as a plurality of networks, for example, a wireline data network and a wireless voice network. Product management system 10 includes communications interface 15, product information tag (PIT) preparation module 30, PIT preparation rules 35, PIT database 50, database viewer 55, report preparation module 80, report preparation rules 85, and analyst 90. Product management system 10 is embodied as a general-purpose computer programmed in accordance with the present description. The general-purpose computer can be one computer or many computers networked together. System 10 can operate on dedicated or shared hardware, and may be at a user's premises or available as a so-called “web service” through communication network 5 or other communication facility. When system 10 is available as a web service, analyst 90 communicates therewith via communication network 5, in similar manner as regulator 95. Customer 20 is able to communicate with product management system 10 via communication network 5. Customer 20 has a general purpose computing device, such as a personal computer. The customer 20 has practice management system 25 which may be any conventional system for storing medical or dental patient records, modified to also store PIT and other information described below, for example, the DENTRIX system available from Henry Schein, Inc. A typical practice management system has a front-office portion for handling appointment scheduling and payments, a mid-office portion for handling patient records and a back-office portion for handling diagnostic and treatment information, as well as a patient portal enabling a patient to access their appointments and medical information via a communication network such as the Internet. In the examples described below, it is contemplated that information associated with products by a products distributor is captured by practice management system 25 and associated with the appropriate patient record. Practice management system 25 uses communication network 5 to provide information to product management system 10, such as product usage and location information, and/or to receive information from product management system 10, such as recommended operating instructions and product supply chain information. PIT preparation module 30 is adapted to generate PITs for products in accordance with customer order 20 and PIT preparation rules 35. Products typically are medical or pharmaceutical supplies, such as drugs or devices. “PIT” means a record relating to a product that logically accompanies the product, and that may or may not physically accompany the product in whole or in part. In contrast, a “label”, as the term is customarily used in the medical products industry, must physically accompany the product and include required standardized information. A PIT may be embodied in any of the following ways: (a) as a printed paper affixed to a product or a product's container, (b) as a printed paper accompanying a product, (c) as an electromagnetic device affixed to or accompanying a product that stores information, (d) as an electromagnetic device affixed to or accompanying a product that enables access to information stored about the product, the information being stored in other than the electronic device that serves as the PIT, (e) combinations of the above, or (f) other configurations apparent to one of ordinary skill. Thus, a PIT may be information associated with a paper, such as a bar code, and/or information associated with an electronic or magnetic device. Electronic devices suitable for a PIT include a radio frequency identification (RFID) tag, a “smart card” typically including a credit-card sized device with a processor and memory, a pattern that is magnetically readable as a bar code, and other devices that will be apparent to those of ordinary skill in the art. Generally, the PIT serves to uniquely identify the product relative to other products in PIT database 50. Customer 20 provides an order that typically includes identification of the desired product, quantity, a ship-to address, an order date and sometimes a delivery date and/or other special instructions. The instructions may be provided directly or indirectly. An example of indirect instructions is when a customer is in a country whose regulations stipulate certain requirements; the customer is deemed to have indirectly provided the certain requirements. The customer order may specify features of the product, for example, the type of container, and optional features such as stickers for patient charts, the stickers bearing product-related information, and characteristics of the patient that affect the packaging, such as disabilities (need for Braille stickers), childproof containers and so on. PIT preparation rules 35 include product handling information based on the type of product, e.g., refrigerated, customer predefined preferences, shipping company requirements, regulatory requirements in the country of origin, regulatory requirements in the destination country, destination country characteristics such as official language(s), customs requirements, climate characteristics of the shipping path and destination (e.g., cold or hot packs needed), and special instructions in or related to the customer order. The information in PIT preparation rules 35 relates to: package layout and appearance; what type of PIT or PITs should be used, i.e., sticker on product, sticker on patient's chart, product insert, electronic tag, bar code, device to be attached to patient, reorder stickers or devices; what historical information about the product content must be on its PIT: lot code, manufacturer date, serial number, UPC code and so on; patient-specific requests and/or requirements, such as Braille labels, audible label devices, childproof containers, easy-open containers, and so on; PIT information for the product container: whether refrigerated shipping is needed, individual container, package container, carton container, shipping pallet and so on; when the product is a refill, how to reset or relabel the refilled container; associated products, e.g., syringes for fluids; product trademark requirements; proper representation of trademarks and associated designs in translations (e.g., font, accompanying designs, different trademarks in different countries); promotional materials; advice to include restrictions to be applied (ex: how to use, how to distribute, how to store); whether a sensor is to be applied, and what type sensor may be appropriate; training materials; training schedules; maintenance and repair instructions; maintenance and repair schedules; programming rules for the PIT, such as which phone number or Internet protocol (IP) address to contact when triggered (see discussion below of injector 600 and case 700), or when training is required for an associated healthcare professional, patient or caregiver (that is, individuals for some items should be periodically or as-needed trained or retrained on use of the item); information related to communicating post-shipment information, such as if a product complaint has to be forwarded within a predetermined number of days after the complaint is received, if the complaint should generate a warning message or a reminder to appropriate parties such as the manufacturer; repair reminders after a certain number of uses and/or elapsed time since last repair; and sending compliance and/or training reminders to patients, medical providers and so on, as directed by manufacturers, regulations, doctors or as requested by patients. For example, let it be assumed that the customer order specifies that 100 units of high speed dental operatory hand-pieces are to be sent to a location in Moldova and are to have RFID tags with serial numbers. PIT preparation rules 35 specify that Moldova requires medical device instructions to be in Russian and in French, that the manufacturer of such hand-piece as identified under Moldovian regulations be determinable, although not necessarily from the product PIT; that the customer wants its instruction sheets to have its name on the sheets and other monitoring information, and the instructions in German and English, and its name affixed to the product itself; and that the regulatory requirements for Korea, the country of manufacture, specify that the date of manufacture must be on the PIT for the device. In this example, PIT preparation module 30 creates PITs having stickers to be affixed to the handpieces having the customer name and the date of manufacture, creates inserts on paper having instructions for use in Russian, French, German and English, and creates RFID tags and sterilization indicators to be affixed to the handpieces containing the serial number of the respective handpieces. When PIT preparation module 30 generates PIT 40, it also generates a PIT record and places the PIT record in PIT database 50. The PIT record includes at least the information provided in the PIT, and typically includes additional information. The PIT record serves as an audit trail for the past, present and future information about the product. Generally, the past information refers to the manufacturing history of the product, including manufacturer, product type, product serial number and UPC code, product version number, manufacture date, expiration date (if any), previous owners of the product, whether the product has been subject to recalls and field corrective actions, the number of previous sterilization procedures, vibration, shock, radiation, temperature and/or humidity extremes in storage conditions, and so on. The present information refers to instructions for use, which can be in one or more languages, or contain one or more pointers to instructional language, the present location of the product, and so on. The future information refers to the customer, the product's actual use, the shipper, the shipment route (if appropriate) and so on. The customer may be a health care professional, such as a product prescriber or dispenser and/or a patient (product user) and/or a patient's caregiver. Supply chain information refers to information relating to how a product arrived at its current location, particularly, who had possession of the product, when, and the conditions experienced by the product while in a party's possession, such as ambient temperature and humidity ranges. A location sensing system, such as the global positioning system (GPS), can be a source of supply chain information. Information relating to where and when a product was can be correlated with third-party information such as transit route information and/or weather service data, to determine cumulative time that a product was outside a temperature range, ambient conditions at the time of use, and so on. The PIT record includes information provided to the customer, as well as information provided from the customer, or the product itself while in the customer's possession. During the lifetime of the product, the definition of present and future adapts. That is, after the product is received by the customer, the shipper becomes part of the past information. Usage and exception reports are then provided by the customer and/or the product, as discussed below. Database viewer 55 enables a person, such as analyst 90, to view the contents of PIT database 50. Database viewer 55 is embodied as software for interacting with PIT database 50. Analyst 90 represents and suitable hardware for enabling a person to view information, such as a terminal or personal computer and/or printer. Database viewer 55 typically enables analyst 90 to formulate queries and apply them to PIT database 50. Many commercial database packages are known and suitable, such as Microsoft Access, MySQL, Oracle and so on. PIT database 50 may be used for the following purposes: to provide information to manufacturers for sales programs and recalls, to provide information for product liability lawsuits quantifying the amount of product from a particular products distributor involved in malfunctions and the like, for data mining, to project product failure rates and the need to replace the product and/or maintain an inventory of spare replacement parts, to indicate which customers to focus on based on the customer's activity with regard to various procedures, to recommend complementary or substitute products, to provide different levels of customer support depending on the value of the customer, to update training, maintenance or repair instructions or schedules, to help decide where to locate sales and/or service centers, typically near the most frequent users of products. Shipping module 60 enables the shipping service to update the PIT record, to indicate the present location of the product. Package tracking services are well known, and employed by, for example, UPS, Federal Express and the United States Post Office. A shipping module 60 is part of system 10, and queries the shipper's package tracking service for the status of products in transit. Shipping module enables a person or system associated with a shipping service to update the PIT record. Additionally, if a shipper has field device 70, PIT 40 may update the PIT record. Field device 70 enables a customer or other authorized party to access a PIT record, and to update a PIT record with usage and exception information. Each PIT record may contain not only actual product usage information, but also supply chain information for the product. A field device 70 also transmits PIT and possibly other information directly to practice management system 25, so that the PIT and other information can be associated with patient records, enabling a patient record to directly provide product supply chain information.

U.S. Patent Publication No. 2013/0144647 teaches dental enterprise resource planning systems and methods which include a user interface, a data integration engine and interface, a third party application pool, and an application module pool. Data and functionality of the various applications are integrated and delivered through a single platform. Dentistry is becoming an increasingly technological profession. There are also more laws governing the protection of patient information (e.g., HIPAA). These laws require more sophisticated equipment and more secure physical storage areas. Dental offices are pressured to shrink costs and increase profitability in the midst of increasing IT costs caused by advances in technology. One of largest challenges facing today's dental professionals, and dental offices in general, is maintaining the software and hardware needed to operate a dental office. Common practice is to contain all servers, systems, data, and telecommunications within the office environment on locally owned or leased computer hardware. Various dental specific software packages and application are sold to track, maintain, and operate various functions of a dental practice. Often, offices hire specialized staff to maintain and upgrade its equipment periodically and when upgraded software requires such upgrades. Such non-dental specialized hiring increases the overall cost of running a dental practice. Typically, as a dental practice grows, so do the number of office locations that require more hardware and equipment. Quickly, it becomes difficult to scale the respective infrastructure in a cost effective method. Another challenge to operating an effective dental practice is integrating the amount of information generated by the different number of software applications used. Dental practices must schedule and track clients, file insurance claims, maintain medical records, including client images (e.g., x-rays), order supplies, process client payments, keep financial records, backup and store data. Usually two or more application systems are used to accomplish all these necessary functions and such application are becoming more complex. Such complexity requires more training and/or additional staff to simply operate the applications. Even more challenging is retrieving data from each system and integrating this data so that comprehensive picture the practice may be obtained. What is needed is a system and method that unifies the disparate systems and tools used by a dental office into a single solution. Furthermore, what is needed is a solution that integrates the data provided by such systems into a comprehensive view of the practice. Dental software is unified into single platform. The platform infrastructure is cloud-based to provide for a dental enterprise resource planning solution. In particular, the invention provides a system and method for a user interface system, a data integration engine and interface, a third party application pool, a platform module pool, and a network. The system is configurable by the user such that a user enters the system through the user interface, e.g., a web browser, selects a third party practice management solution, and selects desired application modules that provide varying functionality. The platform is configured to integrate the data and functionality the third party management selection and the application module selections into a unified platform so that the user interacts with the total functionality through a single interface. Thus, as will become apparent from the following descriptions, the system and methods of the invention facilitate delivering functionality and data relevant to a dental practice through a single platform. Conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

Referring to FIG. 14 in block format, an exemplary dental enterprise resource planning (“Dental ERP”) system 100 includes a user interface system 110, a data integration engine and interface 120, a third party application pool 130, a platform module pool 140, an optional reporting engine 150, and a network 160 connecting the various components. Depending on the physical configuration, these systems may use a variety of methods to communicate with each other. For example, the systems may communicate over one or more networks 160 using protocols suited to the particular system and communication. As used herein, the term “network” shall include any electronic communications means which incorporates both hardware and software components. Communication among the systems may be accomplished through any suitable communication channels, such as, for example, a telephone network, an extranet, an intranet, Internet, portable computer device, personal digital assistant, online communications, satellite communications, off-line communications, wireless communications, transponder communications, local area network, wide area network, networked or linked devices, keyboard, mouse and/or any suitable communication or data input modality. These systems are contained within a single physical unit and appropriately coupled through various integrated circuit components. One or more of the systems are implemented within a cloud framework. Various cloud platform systems that enable the ability to develop, store, and execute application functionality are well known and will not be described here. User interface 110 includes any hardware and/or software suitably configured to enable users access to the Dental ERP system 100. A user may be a dental professional or dental office/administrative staff, clients (i.e., customers), personnel from third-party software providers that provide functionality to the system, Dental ERP personnel, and/or another computer system or application. The user interface is the only interface dental practice personnel need to access the full functionally of the Dental ERP 100 system. The user interface 100 includes a single sign-on system configured to provide access to any application or system within the Dental ERP system 100. One or more of the components of the Dental ERP may require a security authorization separate from the Dental ERP system to access certain functionality. The single sign-on system provides such authorization without querying the user for additional authorization information. The user accesses the Dental ERP through a username and password. Single sign-on systems are well known in the art and will not be described in further detail. User interface 110 also includes any hardware and/or software suitable configured to present the functionality of the Dental ERP system 100 and retrieve data input from users. In general, the user interface receives data from, and provides data to, the data integration engine and interface 120, and renders such data as is appropriate for the particular system employed by the user. The user interface 110 may render the data received exactly as received (i.e., “pass-thru”) from the data and integration engine and interface. This method may be used when a third party application's graphical user interface must be presented to a user rather than the Dental ERP's graphical user interface. The user interface 110 receives only data and the user interface 110 renders a graphical user interface for the user of the system. The user interface 110 renders the user interface using both methods. A user may use various applications or systems to access the user Dental ERP system 100. Access to the system is achieved through a web browser. Access is achieved wholly or partially through a plug-in or similar application software resident on a user's system. Users may gain access using well-known remote access desktop application software. A data integration engine and interface 120 includes any hardware and/or software suitably configured to capture/receive, store, and enable retrieval of relevant data from the third party application pool 130 and platform module pool 140 and to provide/receive such data to/from the user interface 110. The data and integration engine and interface 120 may utilize one or more databases or file structures suitable to record and manipulate data within the time frames required by the invention. Database may be any type of database, such as relational, hierarchical, object-oriented, or similar data management structures. Database systems are well known and will not be described in detail. However, the data storage may be organized in any suitable manner, including flat files, data tables, lookup tables, or the like. Association of certain data may be accomplished through any data associated technique known and practiced in the art. One skilled in the art will also appreciate that any databases, systems, devices or other components of the system may consist of any combination at a single location or at multiple locations. The data integration engine and interface 120 securely stores and manipulates its data according to required regulatory requirements (e.g., HIPAA). The data integration engine and interface 120 may store some or all of the data required for the Dental ERP system's needs. The data integration engine and interface 120 acts as a pass-thru to third party applications within the third party application pool 130. The data integration engine and interface 120 stores all data passing through the interface. This interface may employ a data synchronization scheme to keep third party data and the Dental ERP system data current. The interface may utilize various methods to connect with third party application within the application pool 130. The data integration engine and interface 120 may interface with third party applications resident on a user's desktop or in a location remote to the Dental ERP system. The data integration engine and interface 120 connects with the third party application and obtains data from the application. This data is then stored within the Dental ERP system and may be used and/or analyzed as if the third party application was within the third party application pool 130. The data integration engine and interface may send data to the third party application for use by the application. An optional feature of the data integration engine and interface 120 is the ability to migrate data from a user's system of record to another Such migration capability supports the ability to easily upgrade or change third party applications within the third party application pool. A user may desire to switch their third party dental practice management solution. A user may select their desired practice management solution through the Dental ERP system without the first download data to a compatible file and later import such data into the new application. The migration of data is automatic between the applications such that the migration of data appears to be seamless to the user. A third party application pool 130 includes any hardware and/or software suitably configured to integrate third party software or systems 135 within the Dental ERP system as may be needed for a particular user. In general, the third party application pool contains third party applications commonly used for dental practice management or other functions. The third party application pool 130 may include application add-ons, modules, or updates to the various third party applications. A user select the desired third party application presented by the Dental ERP through the user interface. Such selection informs the system that the particular user desires to have the functionality and data of the third party application integrated into their overall Dental ERP implementation. The selection of third party software is plug and play such that the user simply selects the particular software and may begin using the software within their particular Dental ERP implementation as soon as possible. The third party application pool 130 delivers and installs the third party application onto the systems of the user.t The third party application pool 130 is suitably configured to activate and implement the licensing/usage models for the various third party applications. Such activation may include activation, information collecting and passing, charge models, payment collection, and revenue distribution based on the installation of the third party application. The third party application pool 130 may contain only the add-ons, modules, or updates for particular third party applications to install on a user's system in the same manner. A platform module pool 140 includes any hardware and/or software suitably configured to integrate functionality within a particular user's Dental ERP implementation. In general, the Dental ERP system 100 provides application functionality to effectively operate and manage a dental practice(s). The platform module pool 140 contains modules 145 of functionality that may be selected and enabled by a user to be included within their particular implementation. The modules 145 are available to be selected on a plug and play basis. For example, upon sign up, a user may select two modules to be included in their implementation. At a later time, the user may decide to deselect one of the modules and select two more based on the needs of the dental practice at that time. The platform module pool 140 installs or makes available/unavailable the particular functionality upon the user's selections. The other components of the Dental ERP system 100, for example, the data integration engine and interface 120, are notified by the platform module pool 140 of a particular user's selection and manage the user's data accordingly. Some modules are mandatory for each Dental ERP system implementation. Modules 145 of functionality are varied and suitably configured such that if a particular module is included within a particular Dental ERP implementation, its operation is seamless with other modules and components of the system. A module 145 may include any type of functionality suitable to dental practice enterprise resource planning and management. Module functionality may overlap or supersede application functionality provided by third party application providers available within the third party application pool 130. The following module descriptions are examples of the type of functionality that may be integrated into a Dental ERP implementation and are not intended to limit the types of functionality that may be implemented with the Dental ERP system 100. An Insurance Module includes any hardware and/or software suitably configured to provide functionality to secure information provided by e-filing systems of the third-party practice management systems (e.g., Dentrix™, Eaglesoft™, QSi™, Carestream, Curve). Insurance related information is passed from the third-party practice management system to the Insurance Module. The information is utilized to gain pre-authorizations, explanations of benefits, claim denial disputes, or other actions or information typical to the dental insurance industry. Once the insurance action requested has been satisfied the information is provided to the third-party system. The module then prompts the user, by patient name, that the issue has been resolved. The information is stored in a patient's information record. Current standard office practice to process claims includes complex interactions with third-party (sometimes offshore) groups and insurance carriers. The need to have these third parties interact with the internal staff of the dental office is a security risk, is known to be inefficient and requires local dental professional/management assistance during the process. The system will allow a secure but separate area, for example, a private cloud environment, for offsite third parties to access needed claims information. Claims may be processed and updated directly to the private cloud environment. The Patient Services Module includes any hardware/software suitably configured to provide functionality for a virtual patient concierge portal. The module enables a client or patient to view/manage either future or past appointments. The module may also send or otherwise initiate communication regarding reminders to the patient. The reminders that can be utilized are appointment, payment, doctor's directions (i.e. please take pre-medication), and other general patient information. Other services that may be provided are surveys and after hours scheduling or appointment requests. The patient can also request prescription refills and any adjuncts to upcoming appointments. The Centralized Patient Database Module includes any hardware and/or software suitably configured to obtain data from patient charting systems and normalizes this data in a centralized database for each patient. The database will track of what types of treatment the patient has had (both medical and dental), the types of materials used during procedures, and the clinical outcome of all patient visits. This data enables access to the patient's history of treatments and materials to more accurately help the patient. It will also increase the safety to the patient and efficiency of the office. The database tracks of patient information and makes such information accessible to other modules, such as the Patient Services Module. This module is connected to a Dentist Portal, an Office Portal, and a Patient Portal. The Patient Portal enables real-time treatment planning such that patients can be educated on their condition and the reasoning behind the treatment. Once treatment is completed data will be presented in a graphical nature that will help the patient to understand the nature of the treatment and the outcome post treatment. The module may also obtain data from a patient portal or similar system that stores patient health-related data. Dental patient data is obtained and may be de-identified and stored in a dental health information exchange. The dental health information exchange contains any data pertinent to any dental service rendered to a patient. Analysis or retrieval may be performed on the data contain within the dental health information exchange. A dental health information exchange and a generic health information exchange may communication with each other to obtain a full health profile of patients. The Inventory Module includes any hardware and/or software suitably configured to manage dental practice inventory through predictive modeling and is calibrated using scanning techniques, such as bar code scanning inventory items or connecting with RFID tags. Predictive modeling is a well-known technique in the art and will not be further described here. The module accepts scans of dental instrument blocks (i.e., bur blocks) that have been designed to better track the small pieces of inventory expended in a dental office. Cartridge dispensers may be scanned that track inventory automatically. This module communicates with purchasing systems that a particular office uses and helps automate a purchase event as supply levels reach practice pre-defined thresholds. The Merchant Services Module includes any hardware and/or software suitably configured to incorporate a merchant services gateway into the Dental ERP system. The module provides typical merchant services processes and reporting. The module provides secure automated payment processing for office transactions occurring through the Dental ERP system. The module includes ultra-secure charge models, HIPAA compliant interaction with client information, and secure virtual terminal, gateway and bank payment flows. The module is office configurable and permits the elimination of common swipe machines. Merchant services data integrates with the Business Intelligence Module to enable to date reporting. The Business Intelligence Module includes any hardware and/or software suitably configured to provide functionality to receive data from other components of the system 100, aggregate, normalize and parse such data, and present the data to users through the user interface. The module collects data over time so that predictive measures may be based on trends in the data. The module's data may be displayed in various time period, such as years, month, days, hours, etc. The module's data may also be displayed via geography (e.g., local, regional, national). However, any suitable field or filter may be applied to gain an analysis useful to users of the system. The module is used to provide information in the following areas of dental practice. Additional modules complement the functionality of the Dental ERP system 100. Each additional module may be implemented separately from the others. One available module includes an Integration Evaluation service that track the usage of other modules to ensure a particular user or office is using the modules effectively. Another available module includes an Issue Tracking Service. This module tracks break/fix status and proactively identifies problematic functions within other modules or applications. Another available module includes an Adjunct Application Delivery Service. This module enables the delivery of various applications relevant to dentistry, such as financial planning or continuing education. Other modules may utilize dental procedure codes to activate other functionality within the system. For example, third party practice management software developers may use procedure codes to integrate additional modules within the Dental ERP system or additional functionality within their own software. Another available module includes a Target Advertising Service. This module examines practice procedures utilization trends to display relevant and beneficial advertising mediums. The module, coupled with third party practice management systems, obtains treatment codes and other data related to an office's daily procedures and treatments. Based on this data, the module may push advertising pertinent to the procedures and/or treatments and overall business trends. Another available module is a Continuing Education Service. The module will provide customizable clinical tutorial sessions. The module obtains procedure codes from a third party practice management system and provides clinical sessions based on the codes. Identified treatments trends also may be analyzed to suggest the appropriate clinical training session. Another available module is an Imaging Service. The module permits the viewing, moving, storage and archival of images commonly utilized within a dental facility. Another available module is a Data Protection Service. This module will natively provide restore-ready data from advanced data backup and protection strategies (i.e. geo-diverse redundant storage systems, database & server snapshots, long-term archival systems) and secured from any view other than qualified personal from the dental facility. The data protection and recovery strategies would be designed to exceed local, state, or other (HIPAA) regulatory guidelines and requirements.

U.S. Patent Publication No. 2005/0148830 teaches a computerized medical and dental diagnosis and treatment planning and management system which includes a menu based computer program with fields for entering information including answers to questions and measured data related to a plurality of different types of examinations, wherein the entered information in specific fields on specific forms for one type of examination will automatically populate selected data fields in a series of other forms for other types of examinations. The forms are electronically disseminated from a central system by one treating practitioner to other practitioners who render service to a patient. Presently, not all practitioners in specialty or even generalized medical and dental practices may be knowledgeable or ideally suited to carry out examinations or treatments in different fields. As an example, an orthodontist operating out of an orthodontic office may not be equipped to render one or more specific examinations, such as a periodontal examination, a dental examination, a bite examination, a temporo-mandibular joint or “TMJ” examination, a facial examination, and a cephalo-metric examination. Moreover, even if such orthodontists can confidently and competently carry out such varied examinations, they may not be well-equipped to carry out all the recommended treatments. Moreover, a working practitioner in a field such as orthodontics, who may have a busy patient load, may not always be apprised of the newest treatment options in other fields, such as maxillofacial and orthognathic surgery or TMJ conditions. It is also a possibility that a practitioner may not be well-connected or personally acquainted with other practitioners in other specialty areas, and therefore may not be able to confidently make referrals. Additionally, if a referral is made, considerable effort can be expended in ensuring that the other practitioner(s) have the necessary medical records, treatment recommendations, and that the treatments by the different professionals will be coordinated, so that the referring practitioner (e.g. an orthodontist) can be assured that the various treatments are carried out so that desired results are reached. Indeed, this can involve faxing records, making numerous telephone calls, writing letters, and the like, all of which require valuable time and effort on the part of the referring practitioner and his or her staff. Medical and dental technology, and a patient's condition and desires are not static, and there is always the possibility that a specialist may decide to change the treatment sometime after an initial recommendation. Since changes in treatments may impact what other specialists plan on or are doing, it is desirable for there to be a central repository for patient records and data to help ensure that the most current recommendations and/or modified treatments from the referring practitioner or another specialist are accurately reflected in the referral practitioner's and other practitioner's records and/or accessible therein. Many medical and dental professionals continue to largely practice in an environment based on paper records and files. One advantage of such paper files and records is their portability. A medical practitioner can carry files from room to room in an office, easily review information, make notes and then easily switch to another file and patient. The newly entered information on paper records may or may not be used to update electronic files. A downside to these paper files is that they must be stored when not in use (which is the vast majority of the time), located and provided to the practitioner in advance of a patient appointment, and then returned afterwards. Moreover, as noted above, if a practitioner decides to refer out a patient to other specialists, someone must forward a copy of at least part of the records, along the requested task. This is cumbersome and is typically handled by letter, fax and/or email, and requires additional effort and expense on the practitioner and his or her staff, for which the referring physician is often not compensated. Medical and dental offices have increasingly taken advantage of computer hardware and software to ensure that their practices run more efficiently. Practice management and scheduling software, and patient records and treatment planning software enjoy widespread acceptance. However, the inventor is unaware of any systems or software applications that facilitate effective collaboration between different offices and specialists, so that the efforts of different professionals can work effectively to achieve a common goal of patient treatment with the least amount of inconvenience and error.

Referring to FIG. 15 a flowchart shows a structure of a computerized medical and dental diagnosis and treatment planning and management system 10 which includes a so-called “Chart Central” 12, which is a software system for storing data such as patient data, information concerning various possible treatment and data concerning those treatments, and information concerning other providers of goods and services. A patient (Patent A) 14 will be seen by a health care provider and will be diagnosed by a “Diagnosis Central” 16 of the system. The diagnosis central 16 will have an examination forms module 18 that can display information in summary form. A treatment central summary 20, a referral central 22 and a procedure central 24 can be provided.

U.S. Patent Publication No. 2013/0308839 teaches that at least a portion of medical information of a patient is displayed within MRCS executed within a local device, the medical information including medical treatment history of the patient. At least a portion of the displayed medical information of the patient is transmitted to a medical imaging processing server over a network, where the transmitted medical information includes a patient identifier (ID) of the patient. Both the at least a portion of patient medical information and one or more medical images are displayed within the MRCS, where the medical images are associated with the patient and rendered by the medical image processing server. A set of icons representing a set of image processing tools is displayed within the MRCS, which when activated by a user, allow an image to be manipulated by the imaging processing server. As medical software becomes more sophisticated and universal, integration among software packages becomes more important and more challenging. For example, electronic medical records (EMR) or electronic health records (EHR) are becoming increasingly common. Clinical trials software, dictation software, research software, radiology information system (RIS) software, Hospital Information System (HIS) software, picture archiving and communication system (PACS) software are other examples of increasingly common medical software. One of the challenges of the increased use of these different software packages is that they are generally created and supported by different vendors, and do not interoperate or “talk” to each other well. But, when a physician, technician or administrator is dealing with a patient, he/she needs to access all of the information that is pertinent to that patient easily and without having to actively open several different software packages, search for the patient, and then search for the patient's information that is pertinent. It is particularly important to be able to view, and where necessary, manipulate, images that are associated with a particular patient and/or condition. This is important whether the patient is being treated for a condition, having a regular checkup, or participating in a clinical trial/study. For example, if a patient is being treated for cancer, his EMR needs to show what medications he is on, what procedures he has had and is scheduled to have, and it also needs to show his progress. The location and size of his cancer, as well as his progress are most likely best depicted in images, whether they are scan images (CT, MRI, Ultrasound etc.) or simple X-ray images or other images, such as lab images or photographs (for example, of skin cancer), etc. It is also likely that the physician for this patient will want to do more than simply view the images. He/she may want to change the settings for the images (for example, the window and/or level settings), zoom, pan, measure, view the images from different angles, view the images in a 3D model, rotate the 3D model, segment the images, perform measurements or anatomy identification on the model/images, etc., to better assess the patient's condition. Currently this is not practical within any of the EMR or EHR software packages. Some EMR software allows the user to view a static image, such as an X-ray, but the user is not able to manipulate the image, or view a more advanced image such as a 3D image with appropriate interactive tools. Software packages exist for doing this more advanced image processing, but currently they are not integrated with EMR or other medical software platforms. This is not a trivial task since advanced image processing software must handle vast amounts of data and deliver processing power that is well beyond the capacity of most other types of software packages. The same lack of integration exists for clinical trials, and other medical software packages also. From here on, EMR, EHR, and other medical record software will be referred to collectively as medical record software (MRS). Clinical trial or other trial software will be referred to collectively as clinical trial software (CTS). The term medical record and/or clinical trial software (MRCS) will be used to refer to CTS and/or MRS or other medical software where integration with medical images is desired. There is a need for seamless integration of MRCS packages with medical images and/or advanced image processing. A user does not want to launch a separate imaging application while using an MRCS software package. The user wants to simply be able to view and manipulate, if necessary, the images associated with that particular patient, while using the MRCS. For example, a cardiologist looking at patient X's EMR wants to see only patient X's cardiovascular images and only the cardiology tools that correspond to them. The cardiologist does not want to have to search through multiple patients, choose patient X, then search through Patient X's images to find the ones that pertain to cardiology, and then weed through multiple irrelevant tools to find the cardiology tools.

Referring to FIG. 16 an integrated MRCS and advanced imaging processing system 100 includes a client 105 communicatively coupled to a medical imaging processing server 110 and medical data server 115 over a network 101, wired and/or wirelessly. Network 101 may be a local area network (LAN), a metropolitan area network (MAN), a wide area network (WAN) such as the Internet or an intranet, a private cloud network, a public cloud network, or a combination thereof. Although FIG. 1 illustrates a single client 105 communicatively coupled to the medical imaging processing server 110 and medical data server 115, it will be appreciated that multiple such clients may be communicatively coupled to the medical imaging processing server 110 and/or MRCS server 115. MRCS server 115 may be a data server that resides physically in a different location from the medical imaging processing server 110 and the client 105. The MRCS server 115 may be in the same location as the medical imaging processing server 110 and/or client 105. MRCS server 115 may be operated by the same or different organization from client 105 and/or imaging processing server 110. The MRCS server 115 includes data storage to store medical records of patients such as EMRs or EHRs 102. MRCS server 115 may also store clinical trial records 103 of anonymous patients. MRCS server 115 further includes access control system 116 for providing access to EMR Data 102 and trial records 103. Different users having different roles may be allowed to access different data. For example, a doctor may be allowed to access EMR data 102, while a medical student or professor may be allowed to access only the trial records 103. For the purpose of illustration, MRCS server 115 may represent a MRS server, a CTS server, or a combination of both and MRCS sever 115 may be implemented in a single server or a cluster of servers. Also note that MRCS server 115 may represent two separate serves: 1) a MRS server having EMR data 102 stored therein; and 2) a CTS server having trial records 103 stored therein. Medical imaging processing server 110 includes an image processing engine which is configured to provide medical image processing services to client 105 over a network. The medical imaging processing server 110 also includes an image store 108 to store medical data such as digital imaging and communications in medicine (DICOM) compatible data or other image data, including jpeg, TIFF, video, EKG, laboratory images, pdf, sound, and other files. The image store 108 may also incorporate encryption capabilities, where the medical data can be stored and transmitted in an encrypted form. The image store 108 may include multiple databases, and may be implemented with relational database management systems (RDBMS), e.g., Oracle™ database or Microsoft® SQL Server, etc. The medical imaging processing server 110 includes an access control system 106 to control access, by the client 105, of resources (e.g., image processing tools) and/or medical data stored in image store. Client 105 may or may not access certain portions of resources and/or medical data stored in image store depending upon its access privilege. The access privileges may be determined or configured based on a set of role-based rules or policies. For example, client 105 may be configured with certain roles that only permit access to some of the tools provided by the medical imaging processing server 110. In other instances, client 105 may be configured with certain roles that limit its access to some patient information. For example, certain users (e.g., doctors, medical students) of client 105 may have different access privileges to access different medical information stored in image store 108 or different imaging rendering resources provided by imaging processing server 110. Client 105 is a client which includes integrated medical software 107 as described herein. The integrated software 107 integrates image(s) and/or image processing functionality 121 with medical record software (MRS) and/or clinical trial software (CTS) 107, which herein are collectively referred to as medical record and/or clinical software (MRCS). For example, imaging processing function may be implemented as a medical imaging processing client 121 communicatively coupled to image processing server 110 over network 101. Imaging processing client 121 may be linked to medical software 107 or embedded within medical software 107. MRS is patient-centric software that focuses on medical records of the individual patients. Patient-centric means here that the software's primary purpose is to record and view data relating to the individual patient. This type of software may be referred to as electronic medical record (EMR) software, electronic health record (EHR) software, personal health record (PHR) software and other names. Information maintained by the MRS typically includes: patient ID, demographic, info—age, weight, height, Blood Pressure (BP), etc., lab orders and results, test orders and results, medical history, appointment history, appointments scheduled, exam history, prescriptions/medications, symptoms/diagnoses, and insurance/reimbursement info. CTS includes software for both retrospective and prospective clinical studies. This type of software may be referred to as a Clinical Trial Management System. CTS may also include software for research. CTS is trial-centric which means the primary purpose of the software is to collect and view aggregate data for multiple patients or participants. Although data is collected at the individual patient/participant level, this data is usually viewed “blindly”. This means that the viewer and/or analyzer of the data generally do not know the identity of the individual patients/participants. However, data can be viewed at the individual patient/participant level where necessary. This is particularly important where images are involved. CTS typically includes: patient ID, concomitant medications, adverse events, randomization info, data collection, informed consent, aggregated data, and status of study. The MRCS 107 of the integrated medical software executed within the client 105 displays medical information 122 of a patient, including, e.g., the medical treatment history of a patient, which may be part of a medical record and/or trial record 120 of the patient. Such records 120 may be downloaded from medical data server 115 in response to a user request. In the case where the integrated medical software integrates MRS, the patient's full identity it typically displayed as part of the medical information. On the other hand, in the case of an integrated CTS, the patient is typically anonymous as discussed above, and the identity of the patient is typically not revealed as part of the displayed medical information. Image(s) and/or image processing function 121 is integrated with the MRCS. Integration can take the form of the image(s) and/or image processing tools showing up in the same window as the MRCS. Integration can also take the form of a window containing the image(s) and/or image processing tools opening up in a separate window from the MRCS window. It should be noted, however, that in either form of integration, the medical information of the patient and image(s) are displayed within the integrated medical software, without requiring the user of the integrated software to separately obtain the images via another software program. Image processing tools 123 that are provided by the remote imaging processing server 110 are displayed to the user of the integrated medical software executed on the client 105. The available image processing tools 123 are displayed in the integrated medical software as a set of icons or some other graphical representations, which when activated by a user, allow an image to be manipulated by the remote imaging processing server. The image processing software is integrated with the MRCS program and also opens up “in context”. “In context” means that the image processing software opens up to show the appropriate image(s) and/or tools for the current user and/or patient and/or affliction. The availability of imaging tools 123 to a particular user depends on the access privileges of that particular user (e.g., doctors vs. medical students). Alternatively, the availability of imaging tools 123 may be determined based on a particular body part of a patient, which may be identified by certain tags such as DICOM tags. For example, one doctor may prefer that the cardiovascular images for his patients open up in a 3D view, with vessel centerline tools available, yet the abdominal images for his patients open up in a coronal view with the flythrough, or virtual colonoscopy, tools available. He may prefer to have the other views and tools hidden from view. In another example, another doctor may prefer that the images for her patients open up showing the most recent views and tools that she used for that patient. In another example, the default view for cardiovascular cases may be set to show a particular view and tools, but the user may be able to change the default so that his/her preferences override the default views and tools. In all of the above examples, ideally only the images that relate to the patient being evaluated at that time are able to be viewed. In addition, the user/physician does not need to search to find the images relating to the patient, the images 124 are automatically associated with the correct patient, for example, based on the corresponding patient ID. To do this, the identity of the patient needs to be associated with the patient's images. This can be done by using tags, such as a common identifier, such as an ID number, metadata associated with one or more of the images, mining patient data, body part analysis, or other ways. Also, the appropriate tools need to be shown and inappropriate tools hidden. The tags are discussed in more details below. For example, an image or image series can be analyzed to determine whether it is a head, abdomen, or other body part, based on the anatomy. A skull has a characteristic shape, as do other parts of the anatomy. A catalog of reference images may be used to help identify specific body parts. Based on this analysis, the appropriate views and/or tools can be made visible to the user, and inappropriate views and/or tools can be hidden. For example, if the image series is of a head/skull, the image series may be shown in a certain view, such as an axial view, and tools associated with the brain visible. In addition, if certain key words, such as “tumor” or “stroke”, are found in the MRCS record, specific tools may be shown, such as tools that detect a tumor or evaluate brain perfusion. It is also possible that a patient ID can be determined from the anatomy in an image based on shape, disease, tags etc. for example, an image of a dental area can be matched with dental records to identify a patient from medical images. Or, an identifying tag can be included in the medical image—such as a tag with the patient ID number placed on or near the table of a CT scanner, or on the patient himself. The user of the software is able to customize how the image processing software is presented in context. For example, Doctor Y, a cardiologist, may prefer to have the images open up in a 3D model view, and have cardiology tool A and cardiology tool B visible to him. In this example, other views may be hidden (for example, the axial, sagittal, and coronal views) and other tools are hidden (for example, tools relating to the colon or the brain).

The inventor hereby incorporates all of the above referenced patents into this specification.

### SUMMARY OF THE INVENTION

The present invention is a 3D dental imaging system used for producing and transferring 3D volumes from a remote cloud storage device.

In a first aspect of the present invention the 3D dental imaging system includes a 3D volume imaging software for displaying cone beam images. The software retrieves volumes from storage located in the dental office. The 3D volumes are acquired via a cone beam scanner. There is storage located in the dentist office for storage of 3D volumes that were acquired via a cone beam scanner. There is also storage located remotely of the dentist office for storage of 3D volumes that were acquired via a cone beam scanner located in the dentist office. The patient appointment information is retrieved for the patient's future appointments from a patient scheduling software. The 3D volumes automatically are downloaded from remote storage to local storage based upon the patient's future appointment information.

Other aspects and many of the attendant advantages will be more readily appreciated as the same becomes better understood by reference to the following detailed description and considered in connection with the accompanying drawing in which like reference symbols designate like parts throughout the figures.

### DESCRIPTION OF THE DRAWINGS

FIG. 1 is a schematic view of a prior art method for user to view images from a scanner;

FIG. 2 is a block diagram of an imaging managing system according to U.S. Pat. No. 7,958,100.

FIG. 3 is a schematic diagram of a system for providing a user with images from a scanner according to U.S. Pat. No. 7,958,100.

FIG. 4 is an illustration of an orthodontic care system incorporating a hand-held scanner system and treatment planning software in accordance with U.S. Pat. No. 6,632,089. The orthodontist uses the hand-held scanner system to acquire three-dimensional information of the dentition and associated anatomical structures of a patient and provide a base of information for interactive, computer software-based diagnosis, appliance design, and treatment planning for the patient. The scanner is suitable for in-vivo FIG. 16 is a figure taken from U.S. Patent Publication No, 2013/0308839.scanning, scanning a plaster model, scanning an impression, or some any combination thereof.

FIG. 5 is a block-diagram of a scanning system suitable for use in the orthodontic care system of FIG. 4.

FIG. 6 shows a dental service system for designing and producing dental appliances in accordance with U.S. Pat. No. 8,577,493.

FIG. 7 and FIG. 8 are block diagrams illustrating a cloud-based image processing system according to U.S. Pat. No. 8,553,965.

FIG. 9 is a block diagram illustrating a cloud-based image processing system according to U.S. Pat. No. 8,553,493.

FIG. 10 is work-flow package according to U.S. Pat. No. 8,386,288.

FIG. 11 is a figure taken from U.S. Pat. No. 8,532,807.

FIG. 12 is a figure taken from U.S. Pat. No. 8,532,807.

FIG. 13 is a figure taken from U.S. Pat. No. 8,149,111.

FIG. 14 is a figure taken from U.S Patent Publication No. 2013/0144647.

FIG. 15 is a figure taken from U.S. Patent Publication No, 2005/0148830. FIG. 16 is a figure taken from U.S. Patent Publication No, 2013/0308839.

FIG. 17 is a schematic drawing of a 3D cone beam dental imaging system which has been optimized for use in dental practices employing remote storage of 3D volumes in accordance with present invention.

FIG. 18 is a flowchart of a first embodiment of the invention.

FIG. 19 is a flowchart of a second embodiment of the invention.

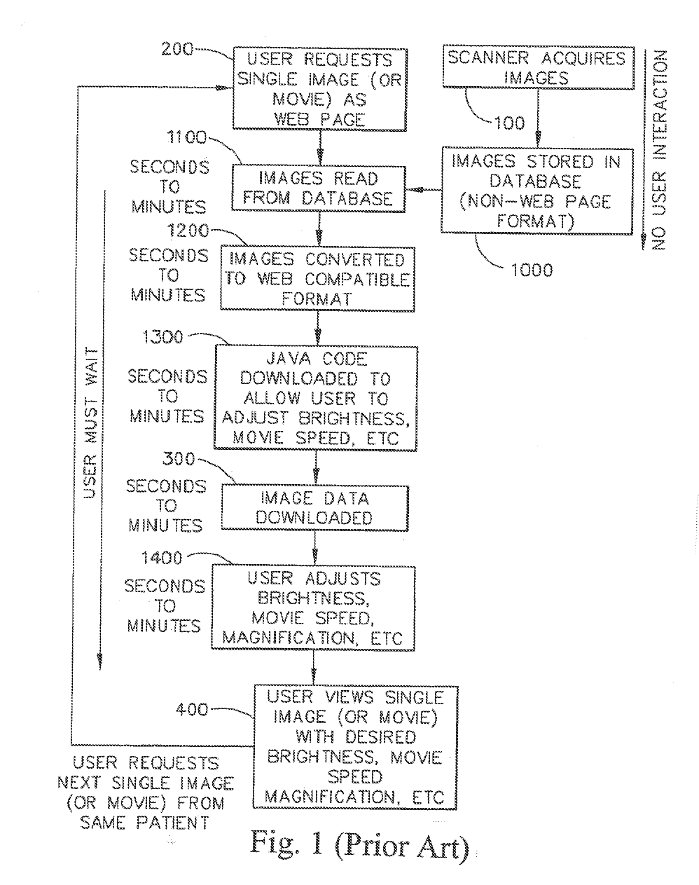

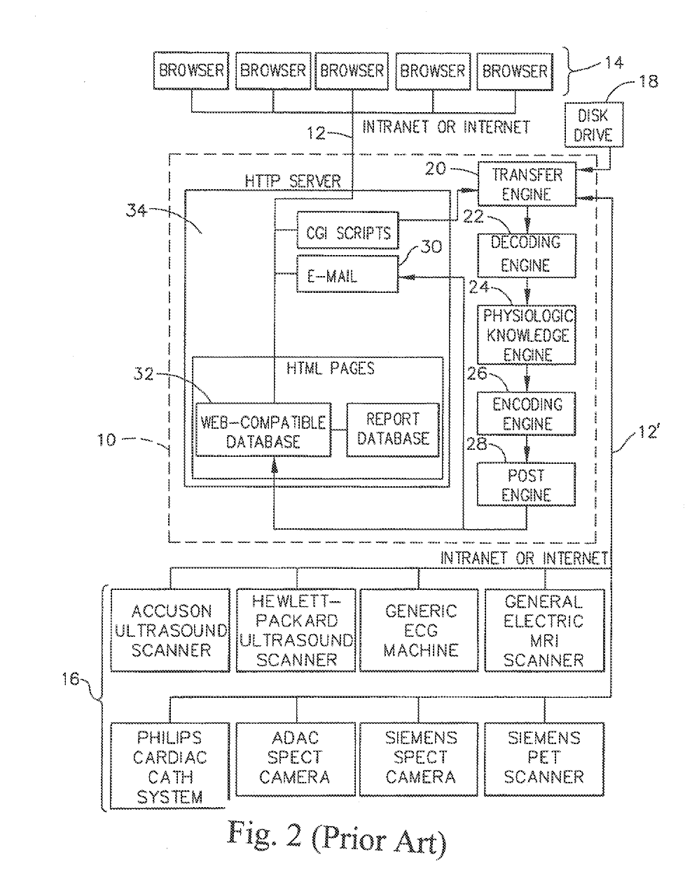

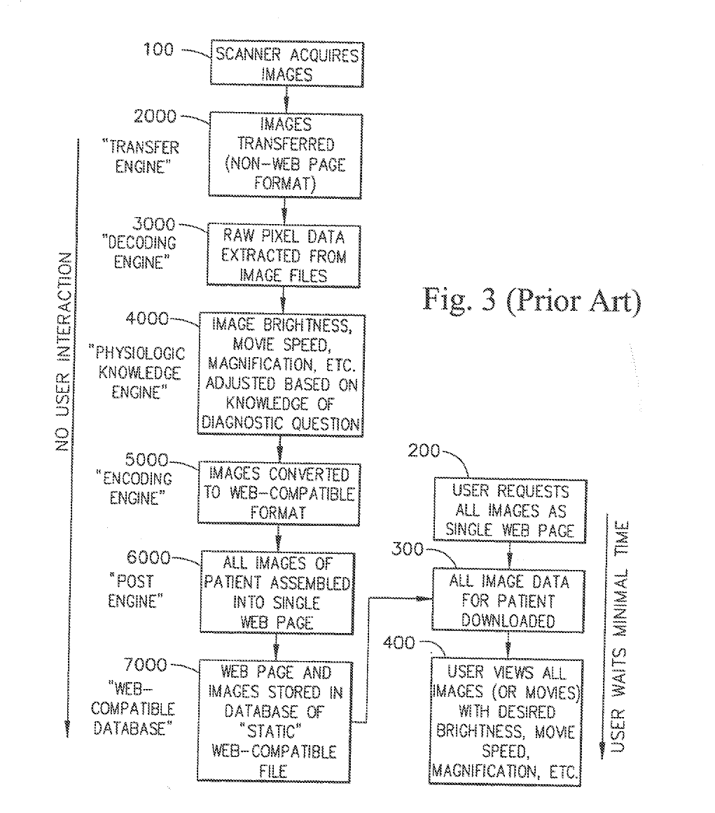

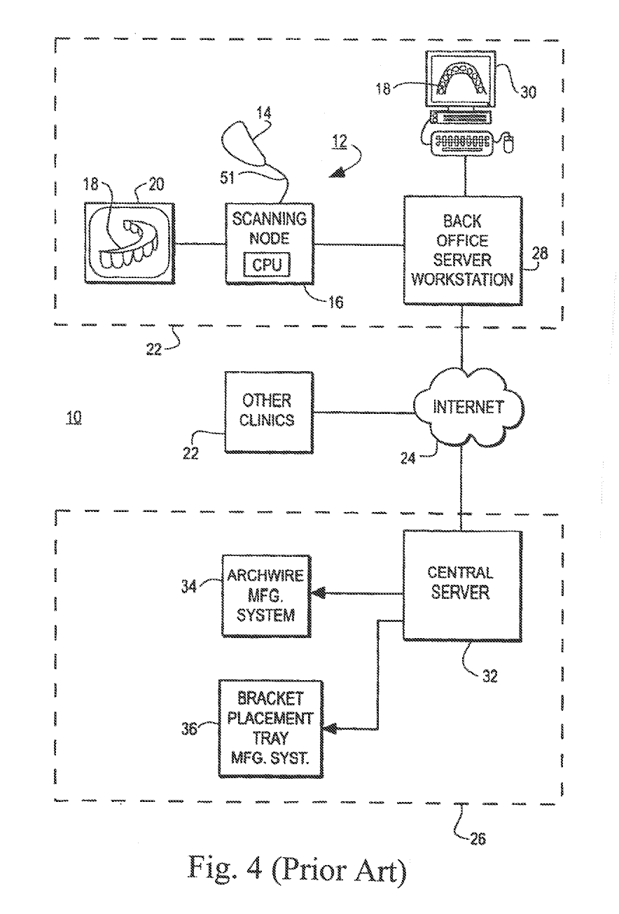

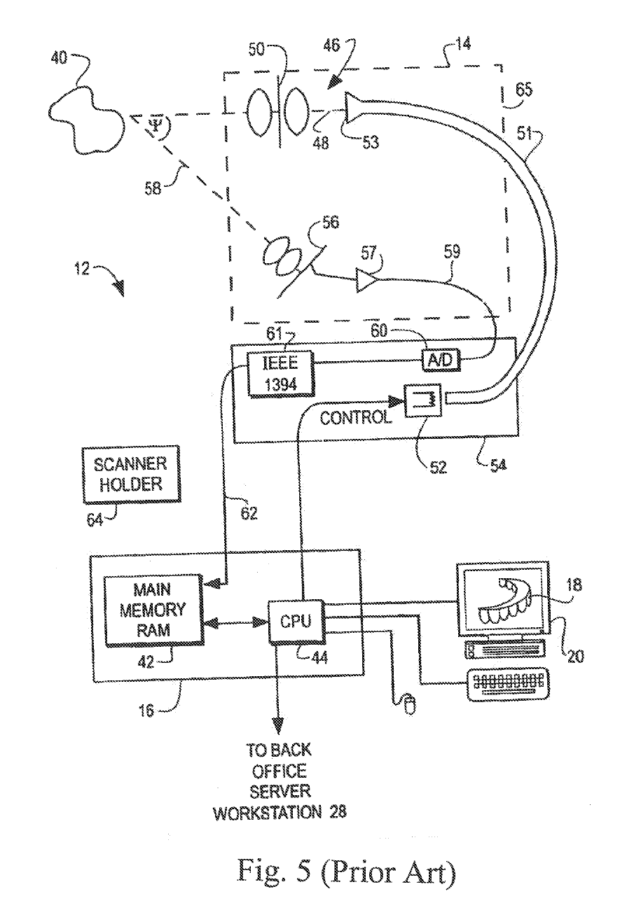

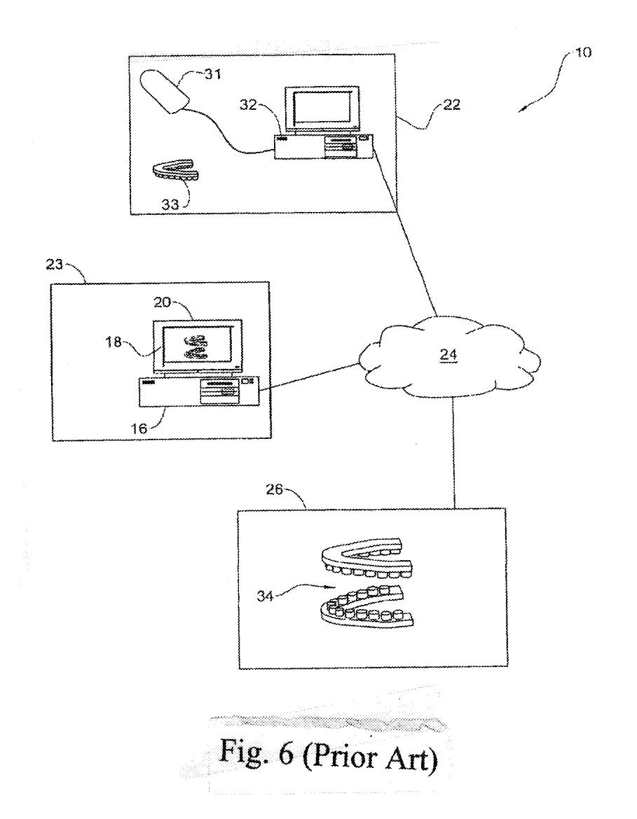

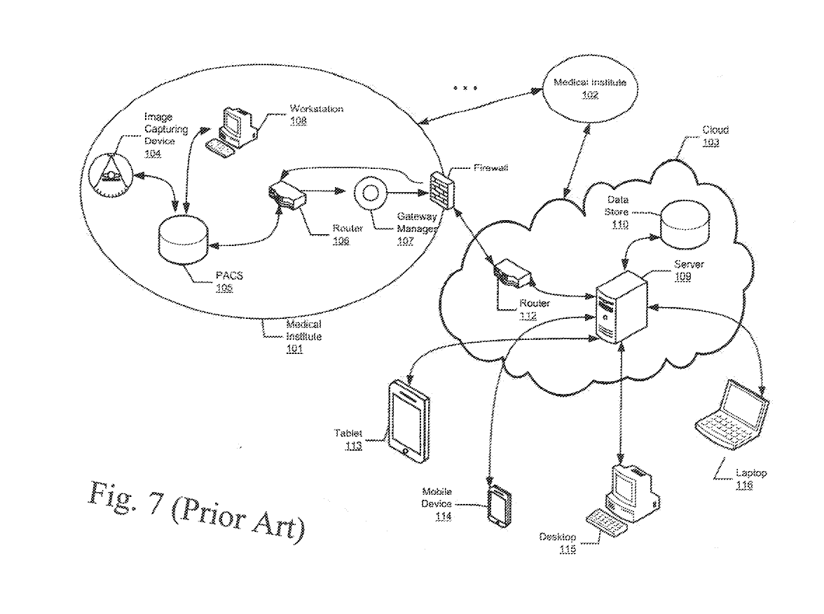

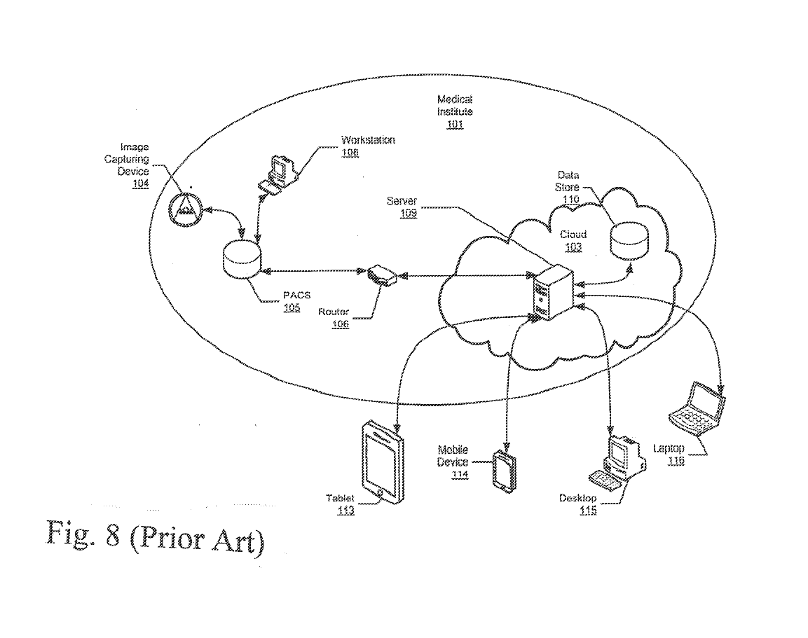

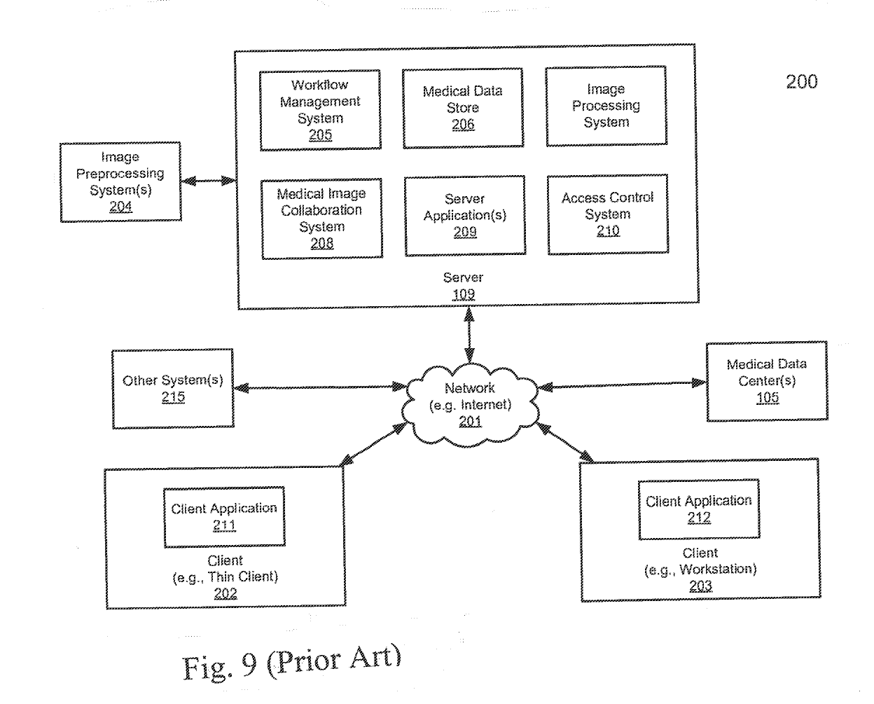

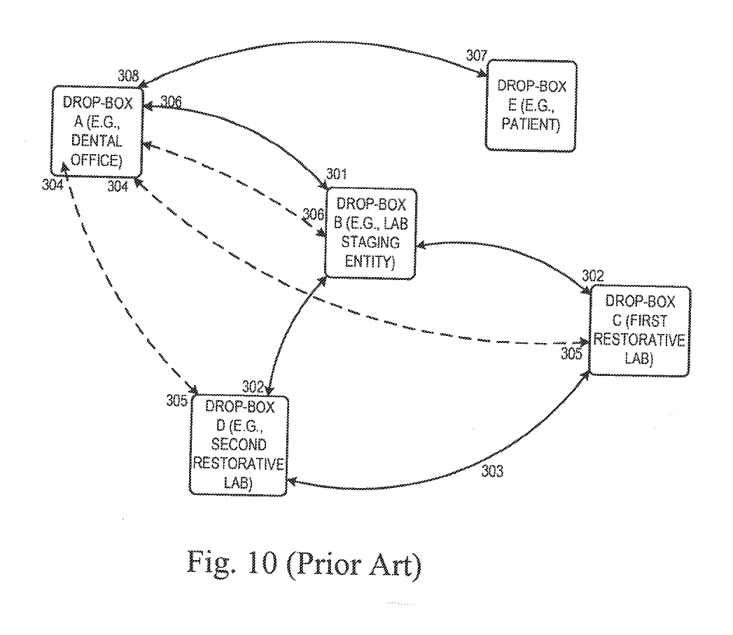

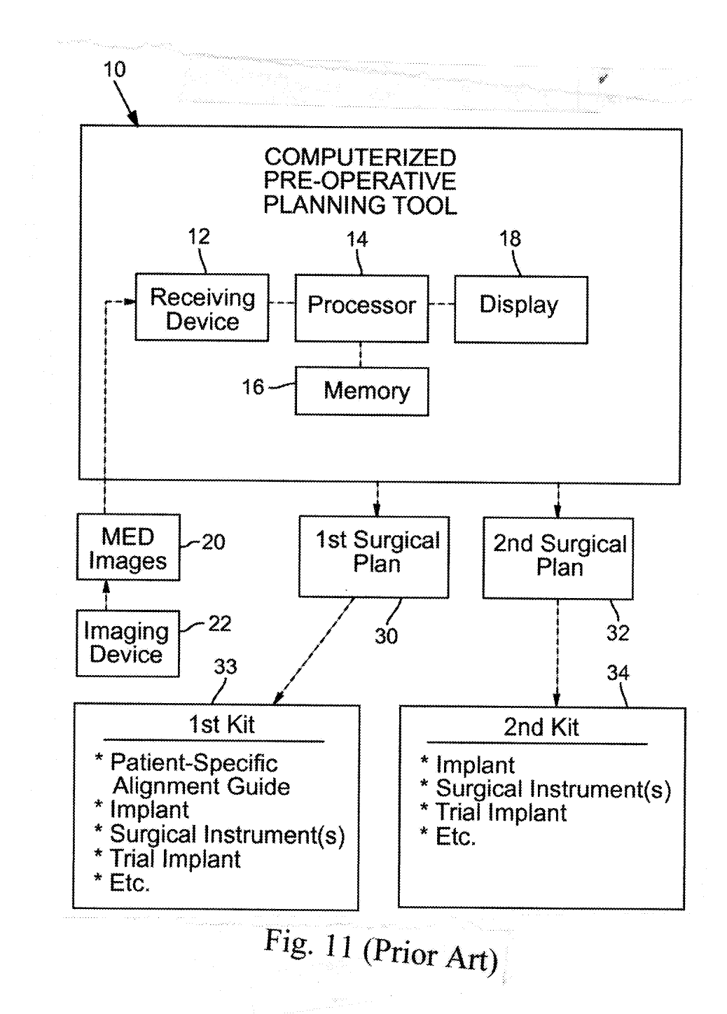

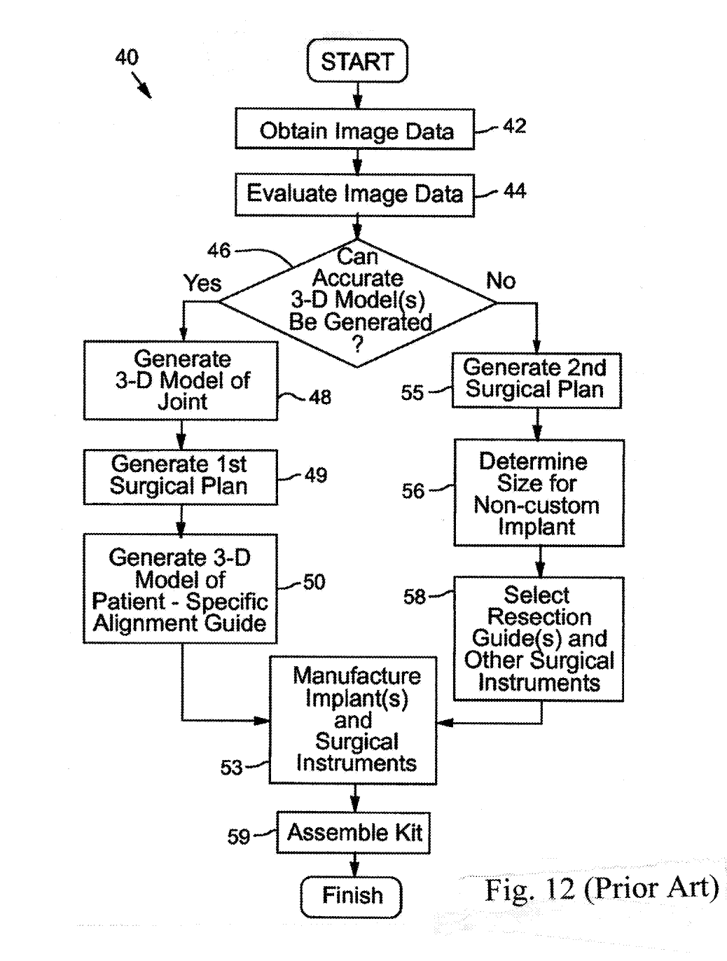

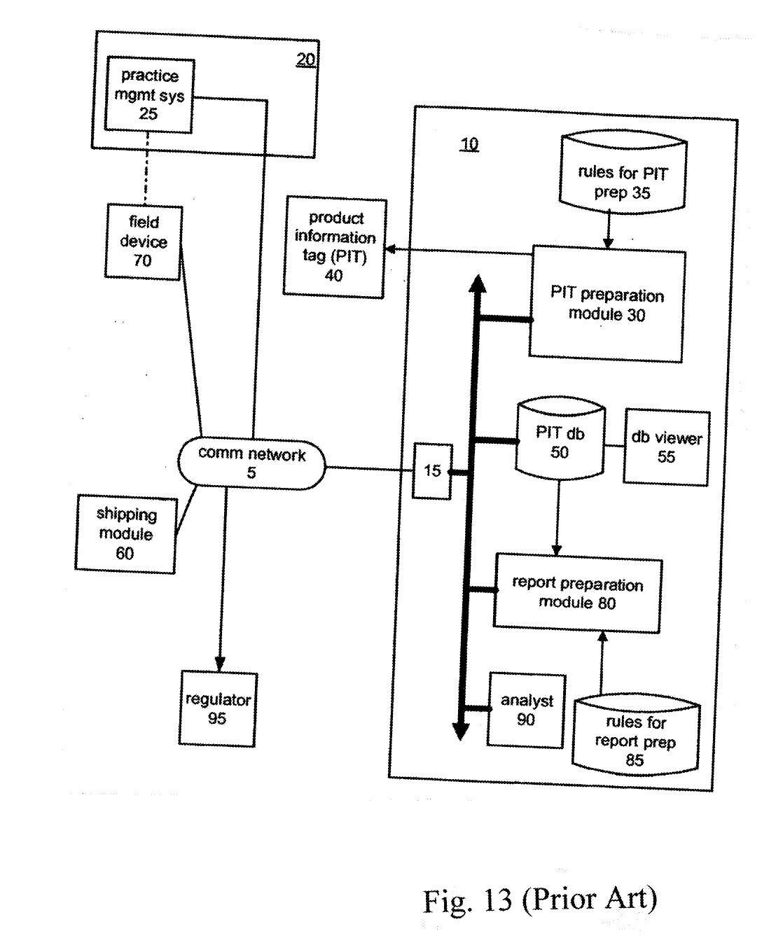

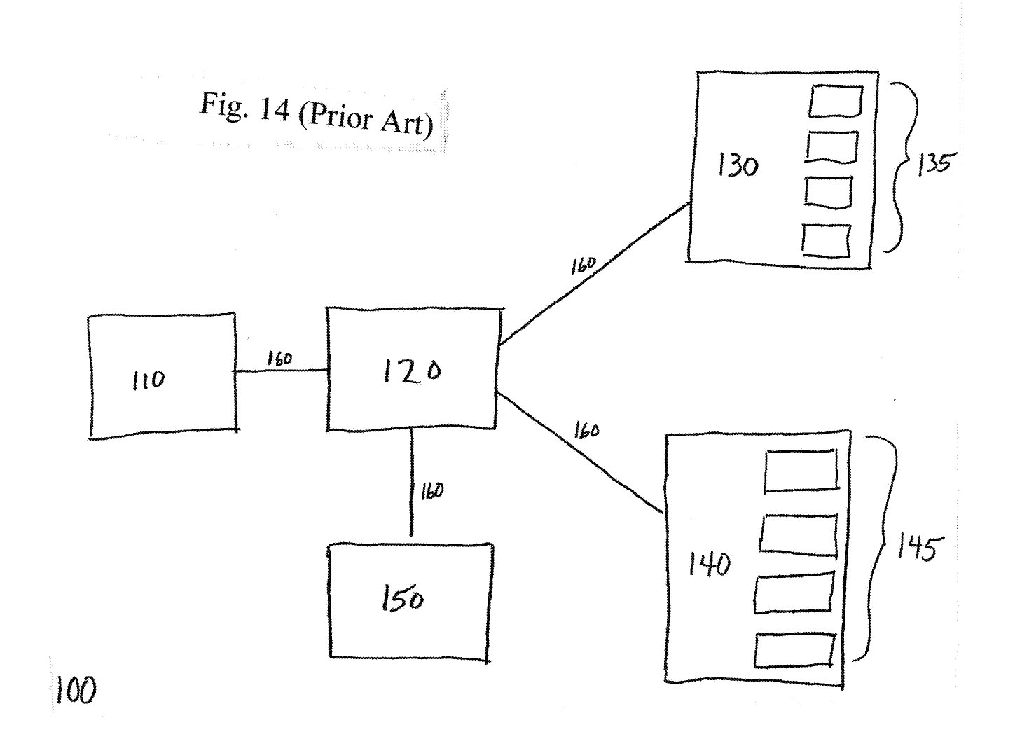

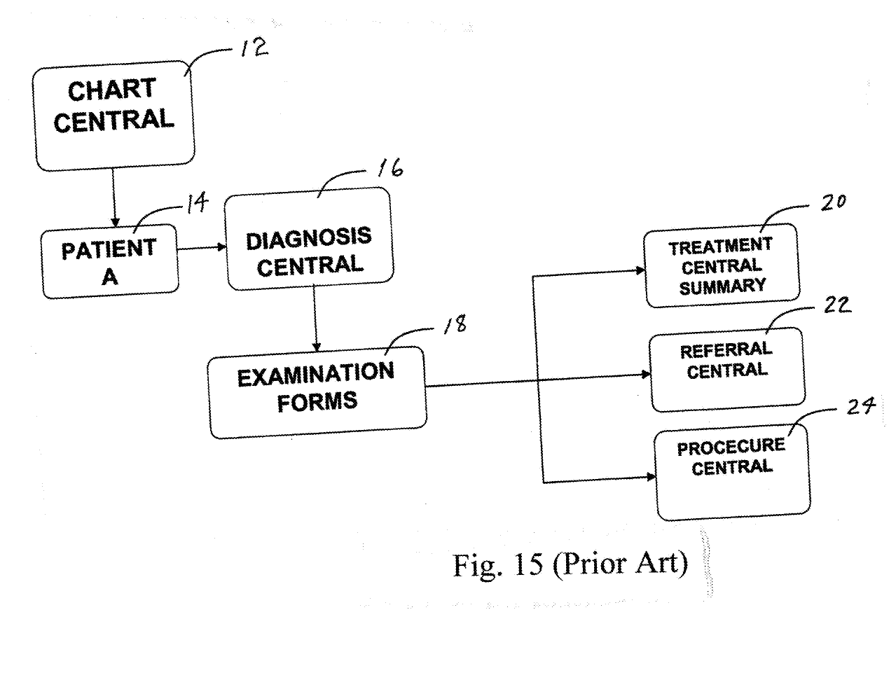

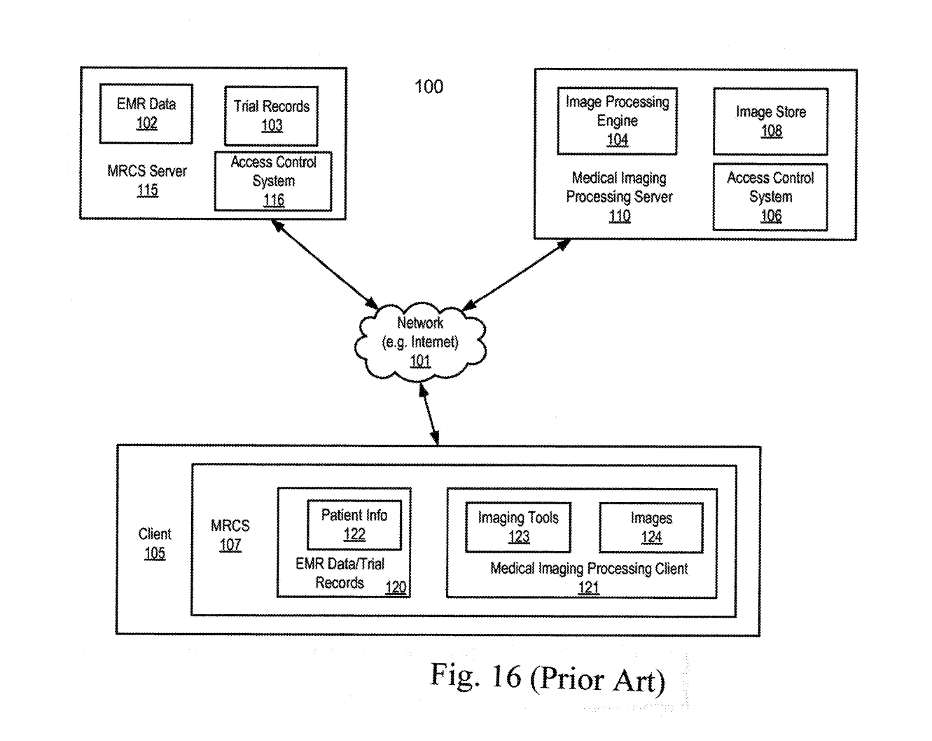

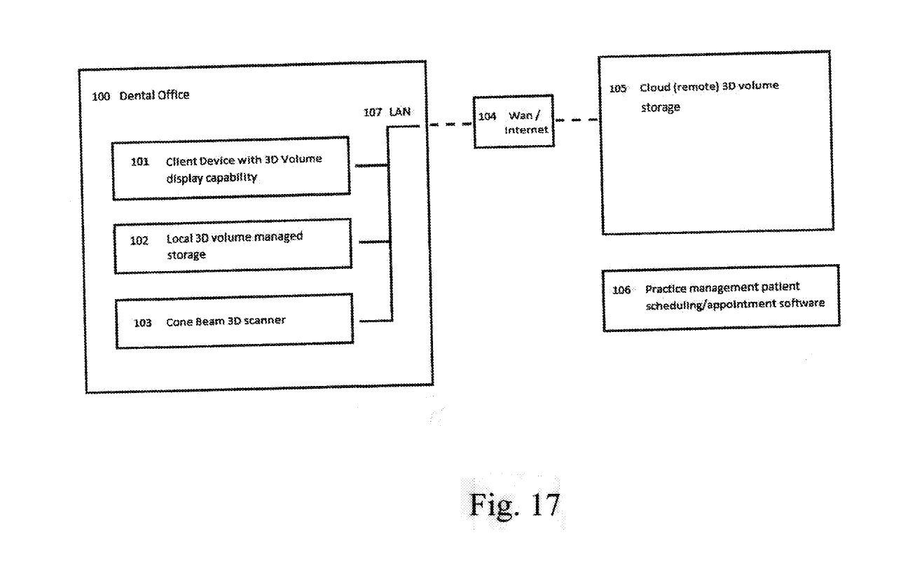

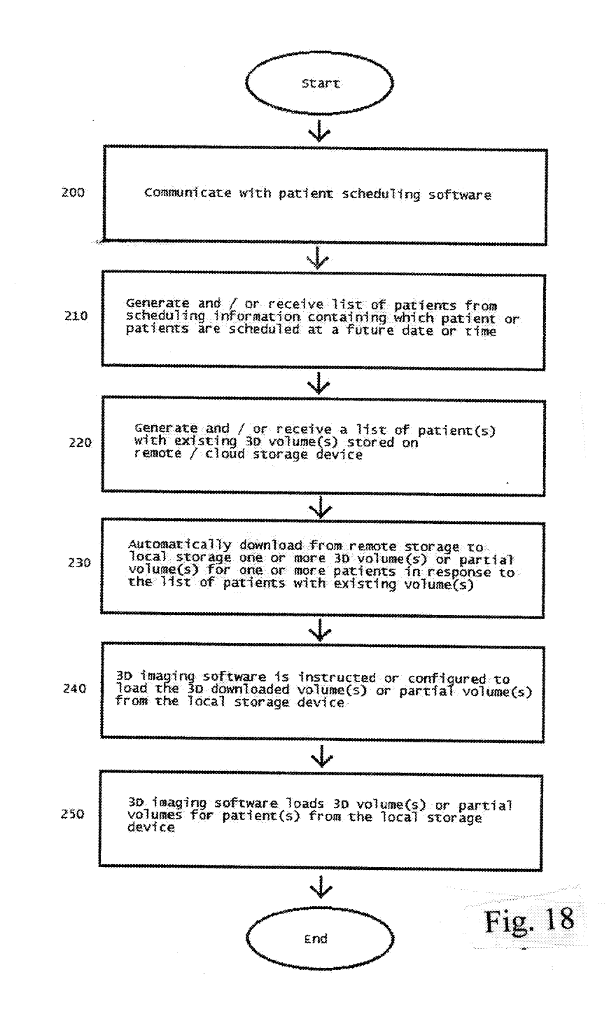

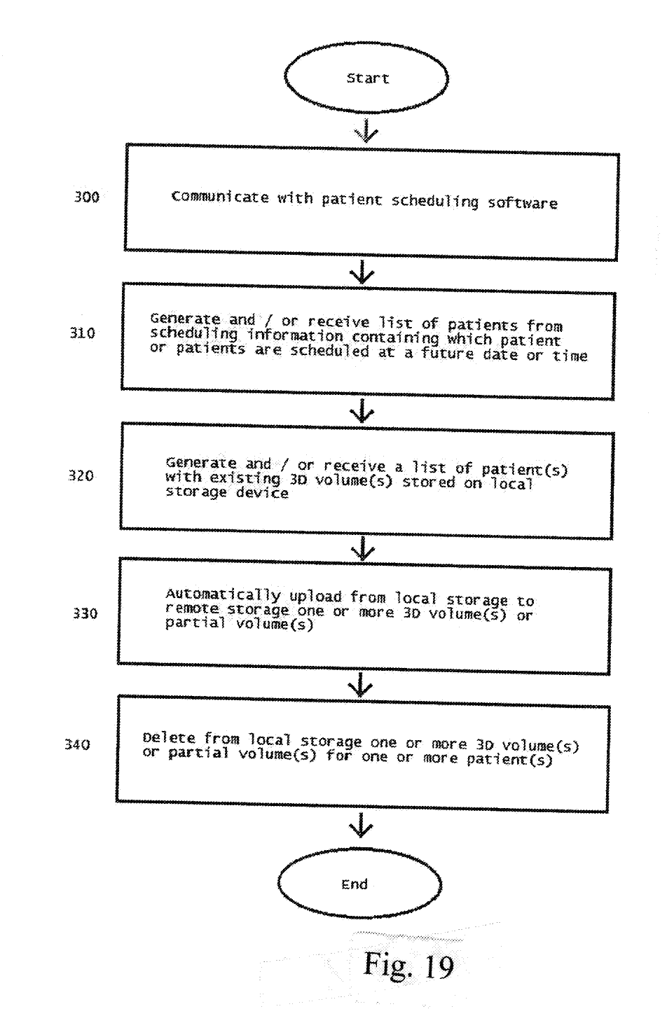

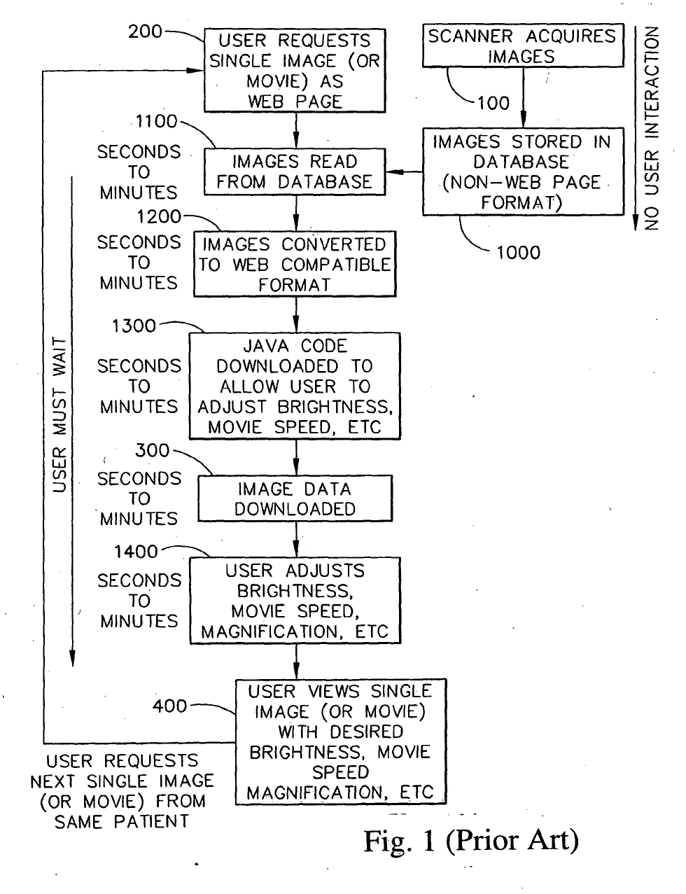

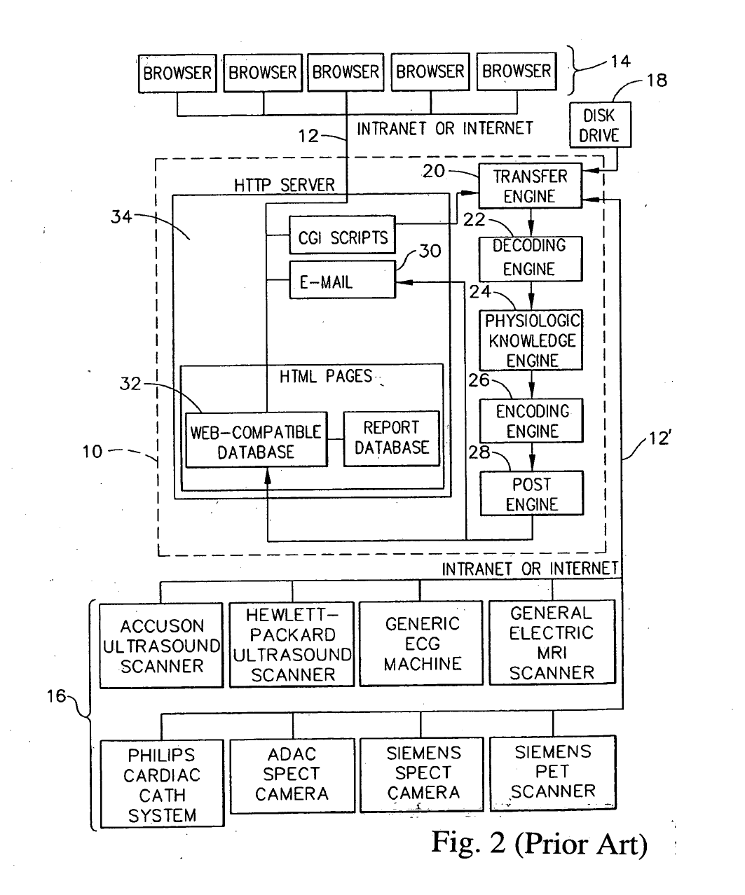

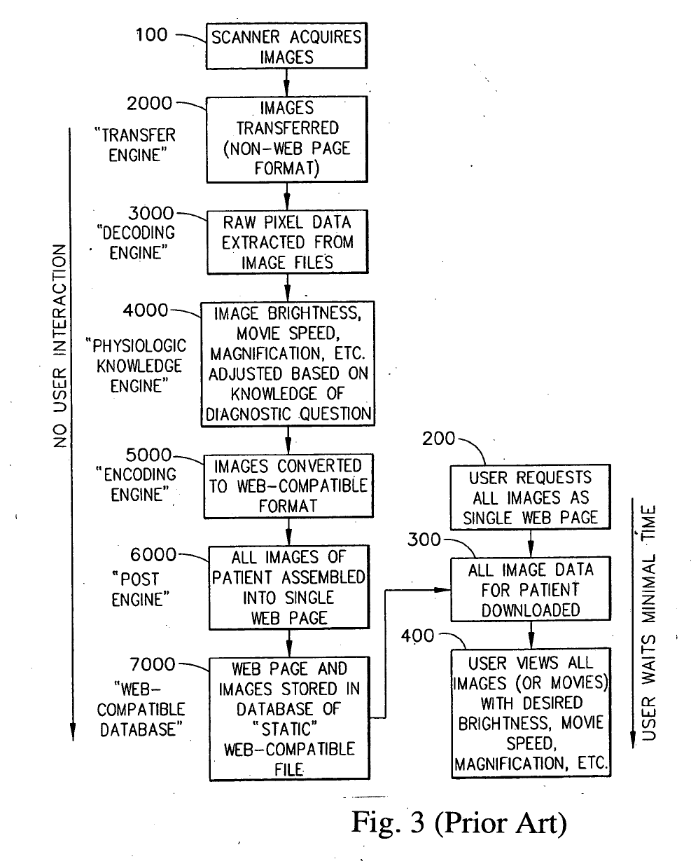

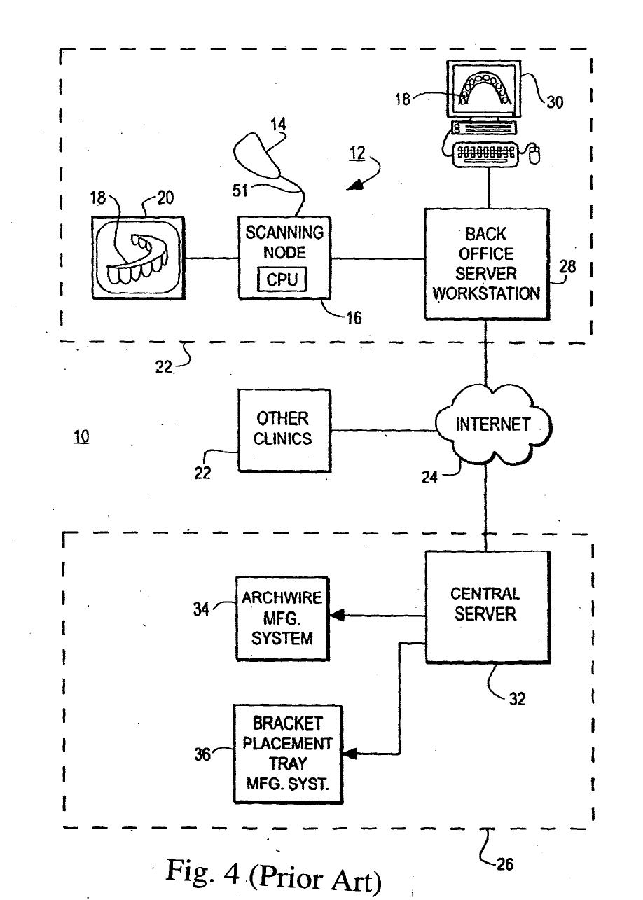

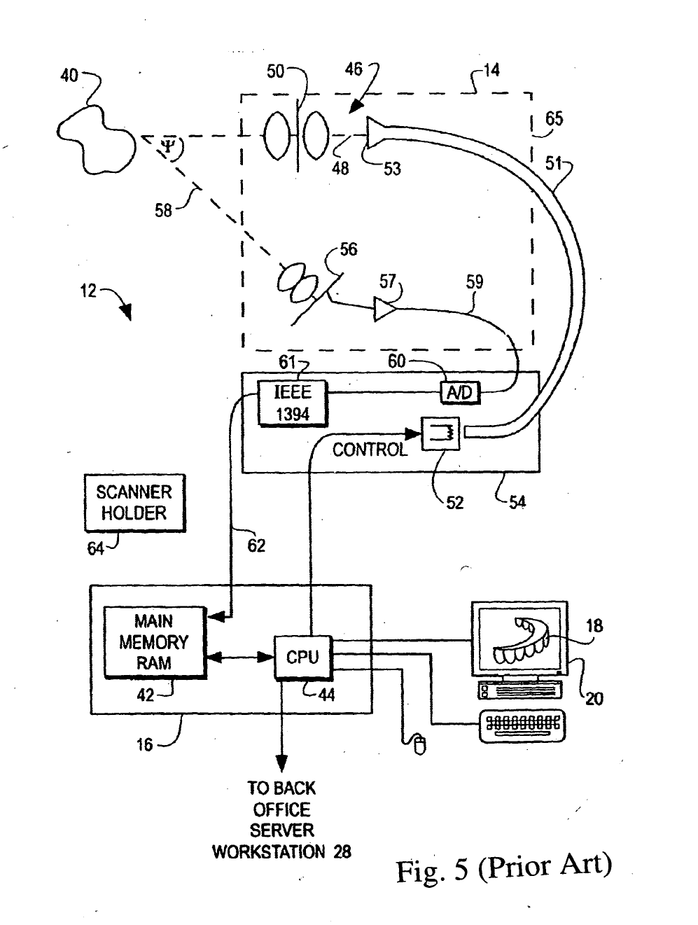

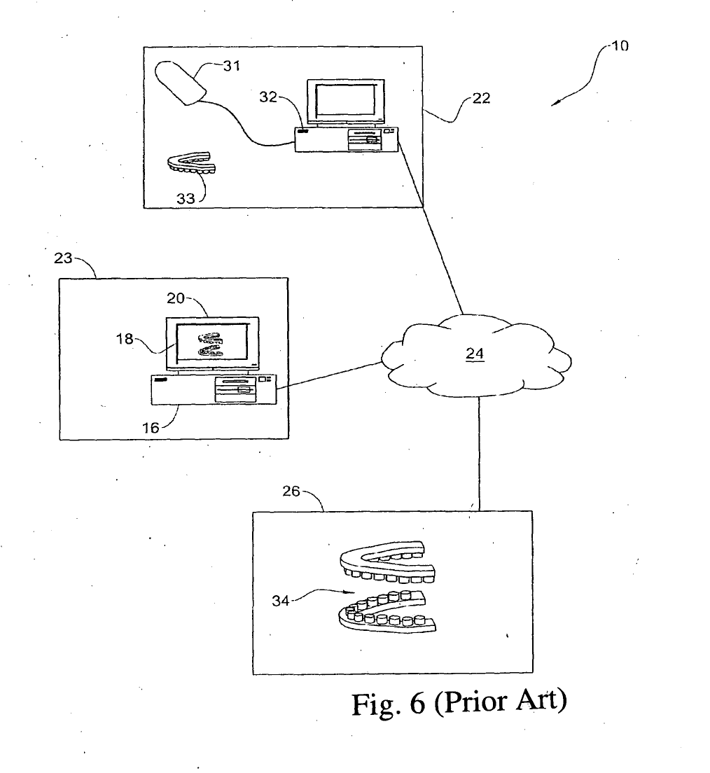

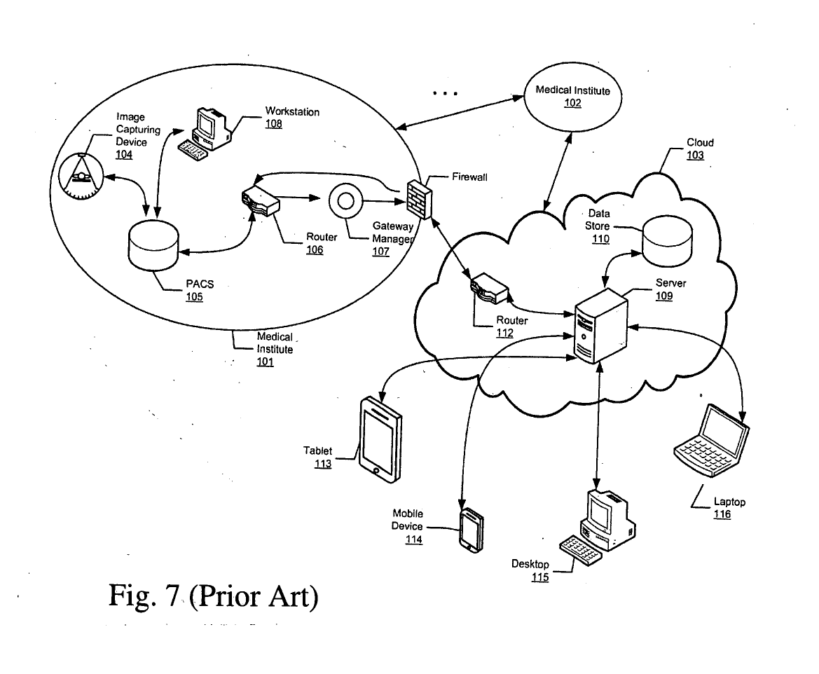

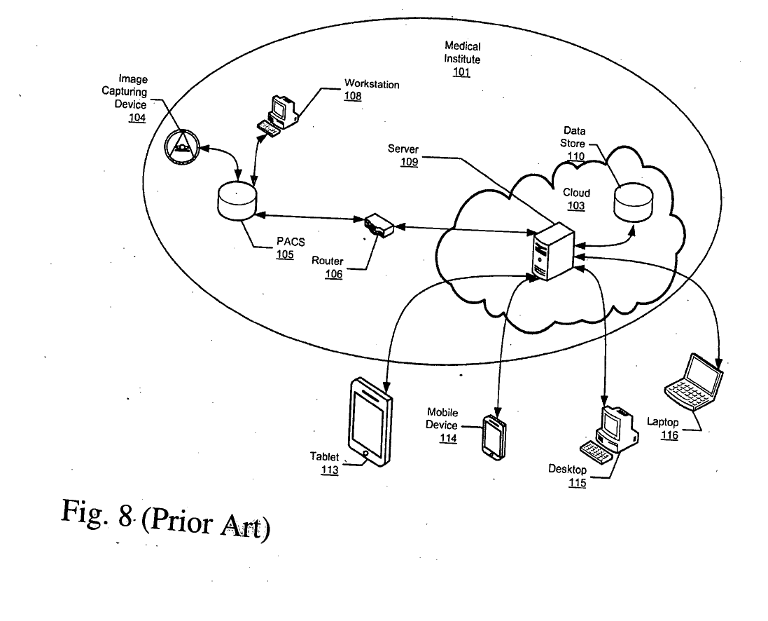

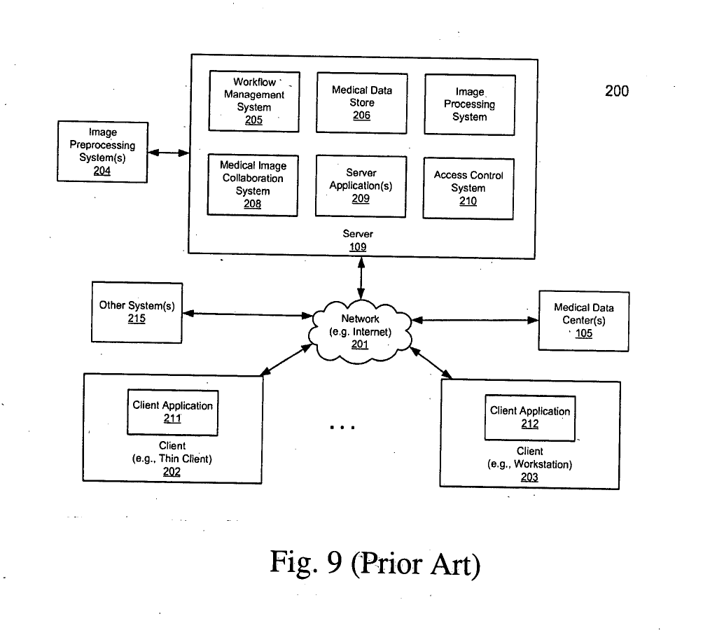

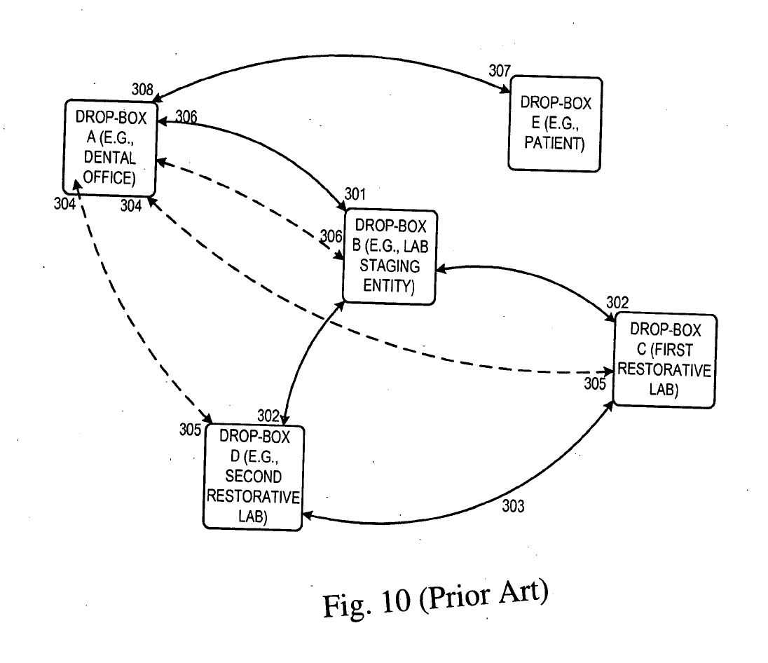

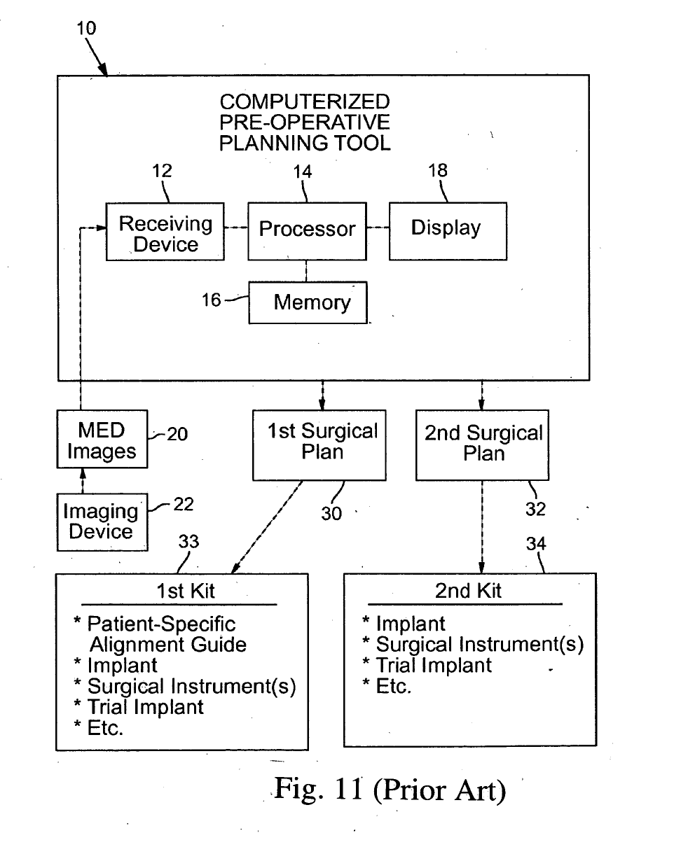

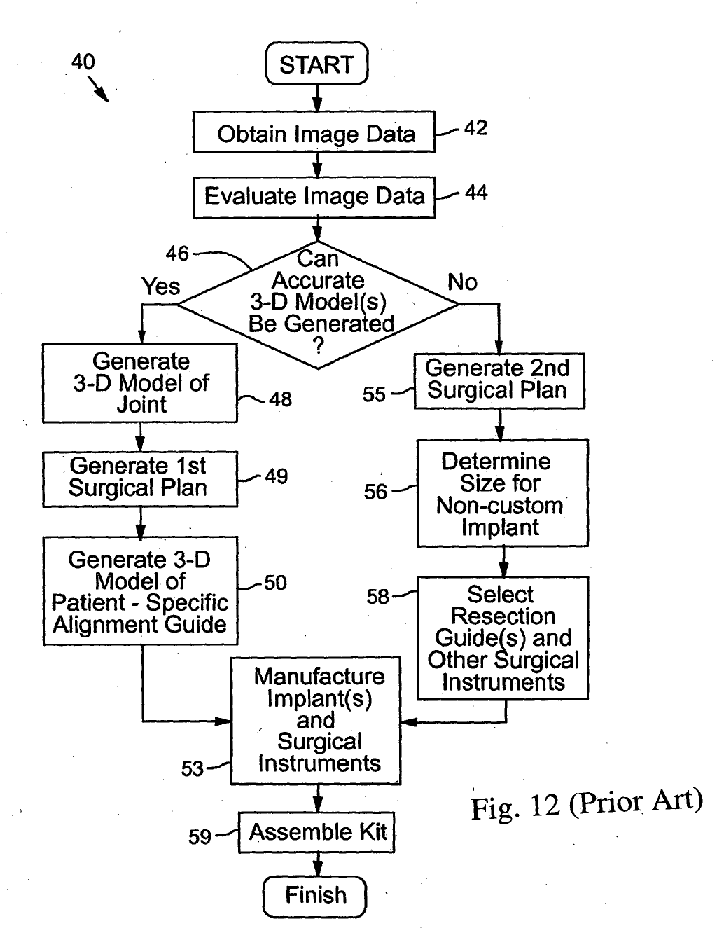

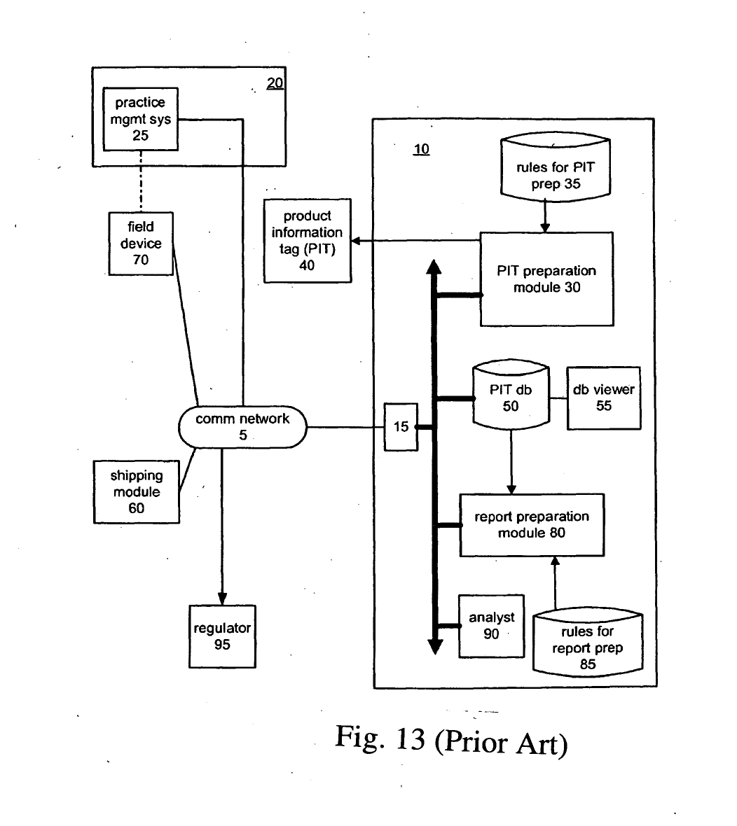

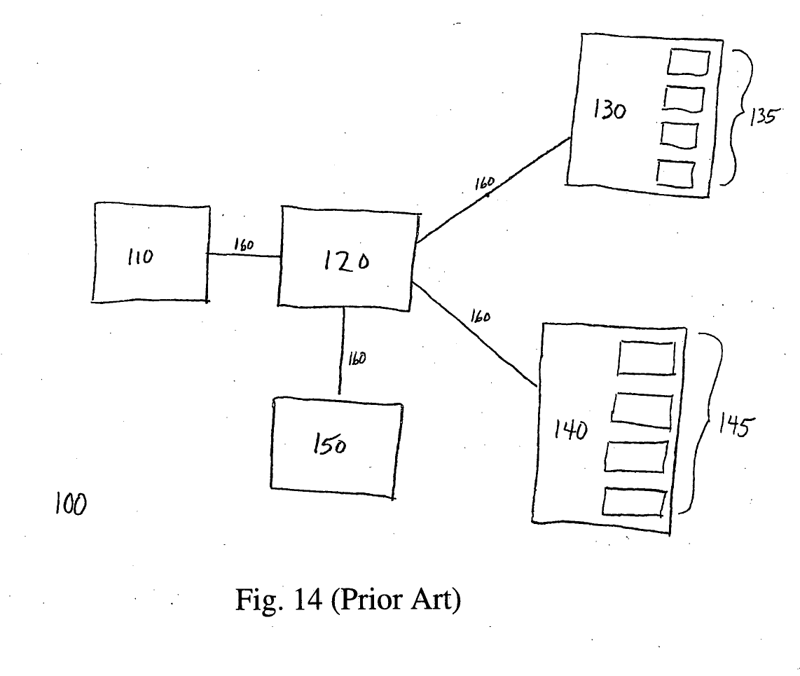

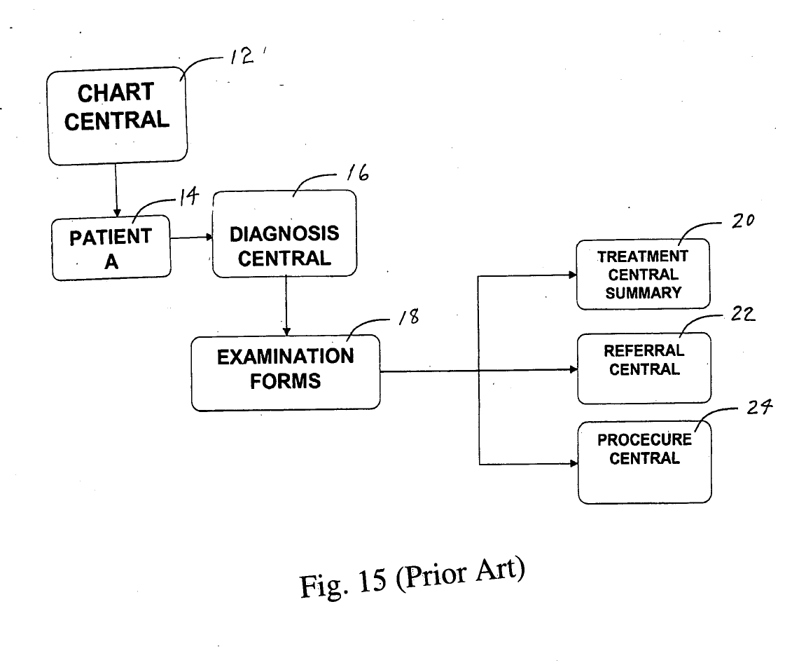

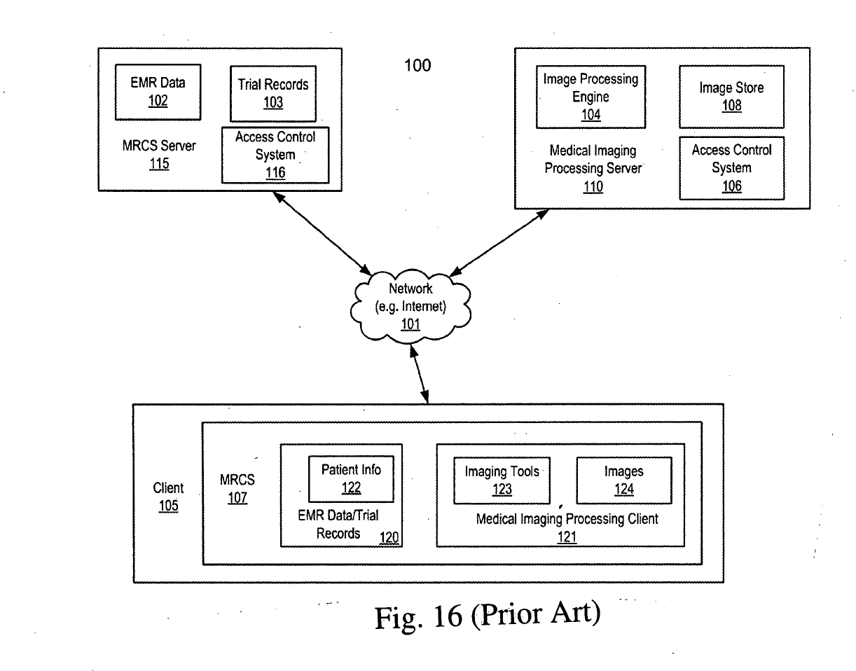

### DESCRIPTION OF THE PREFERRED EMBODIMENT

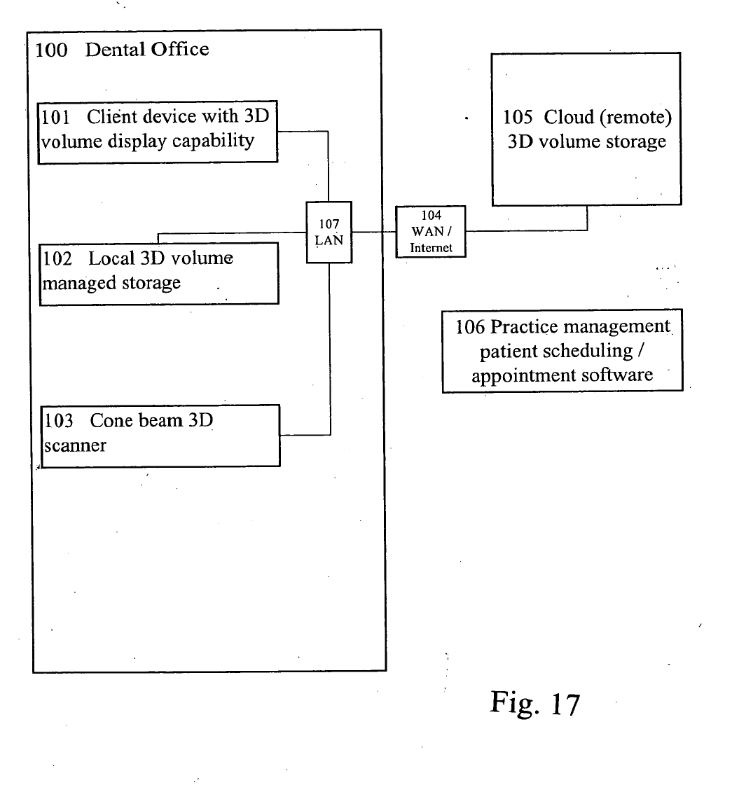

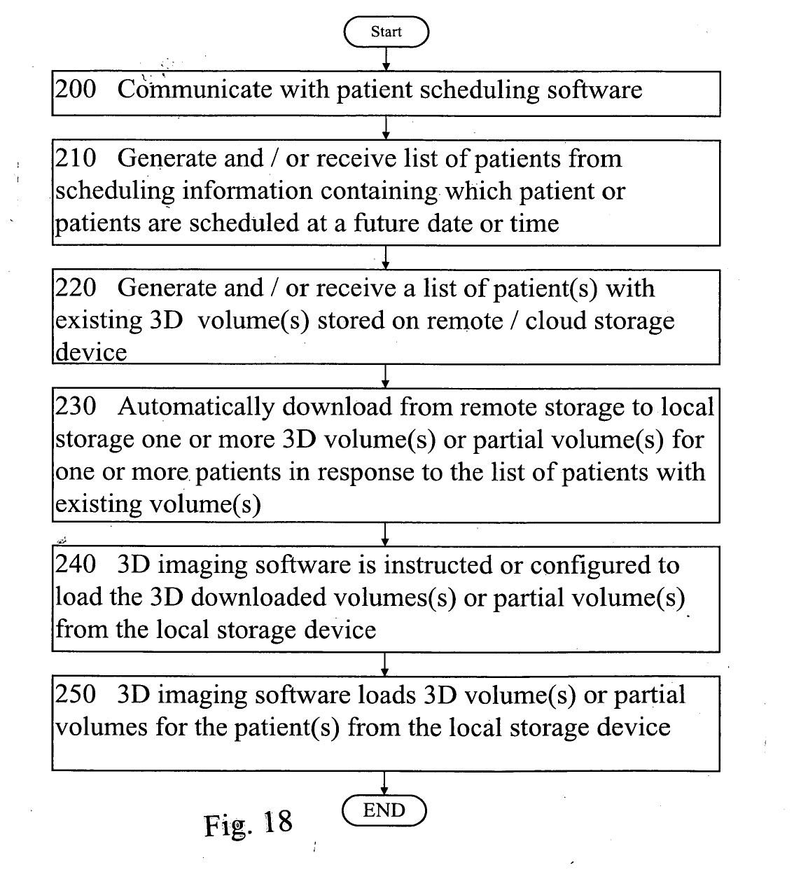

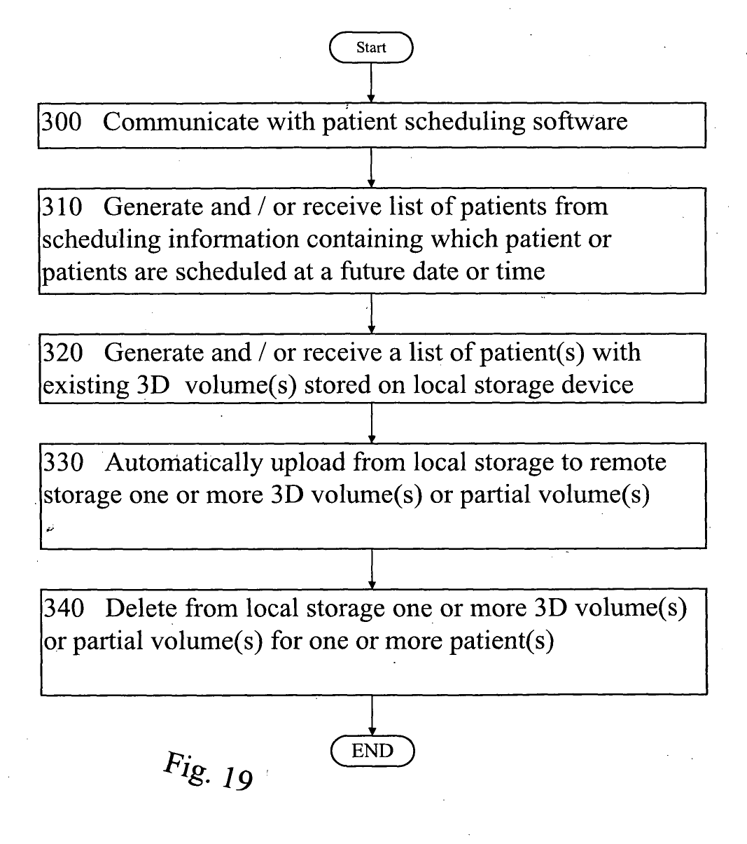

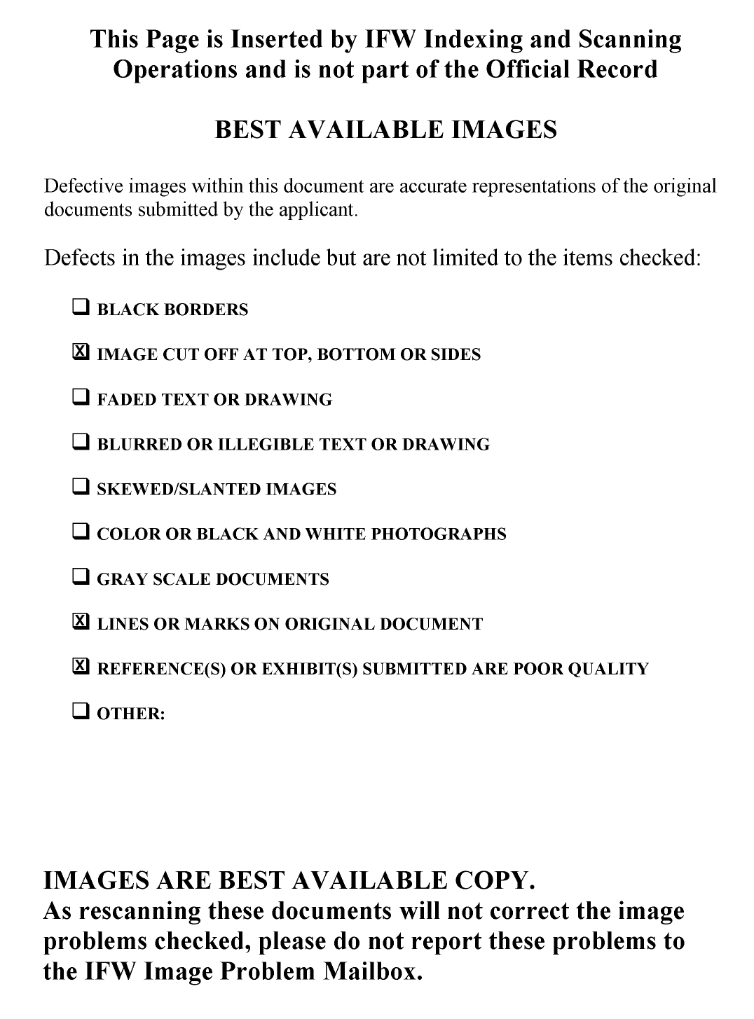

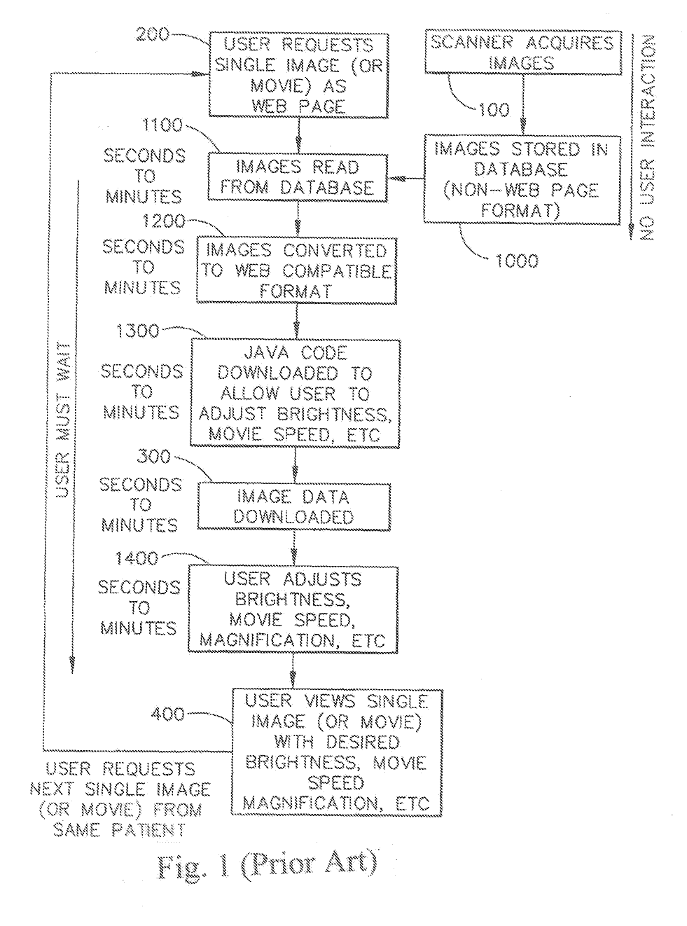

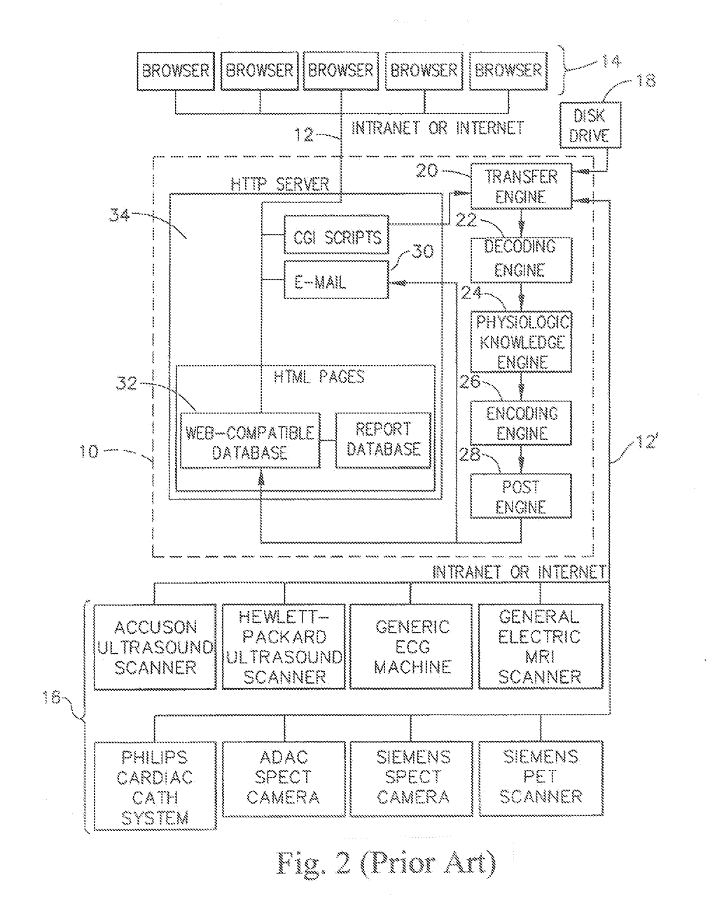

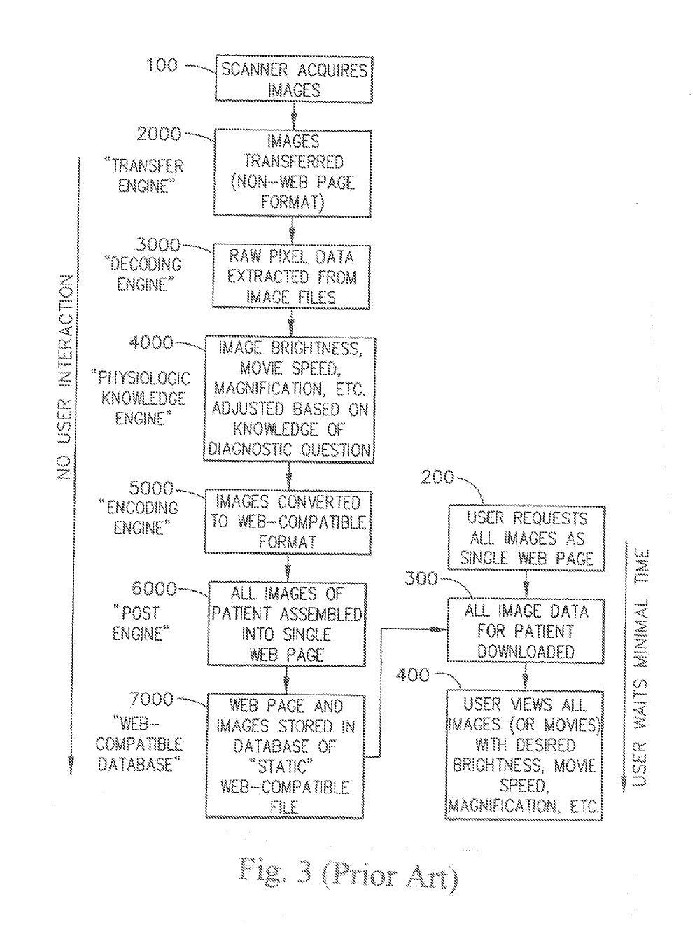

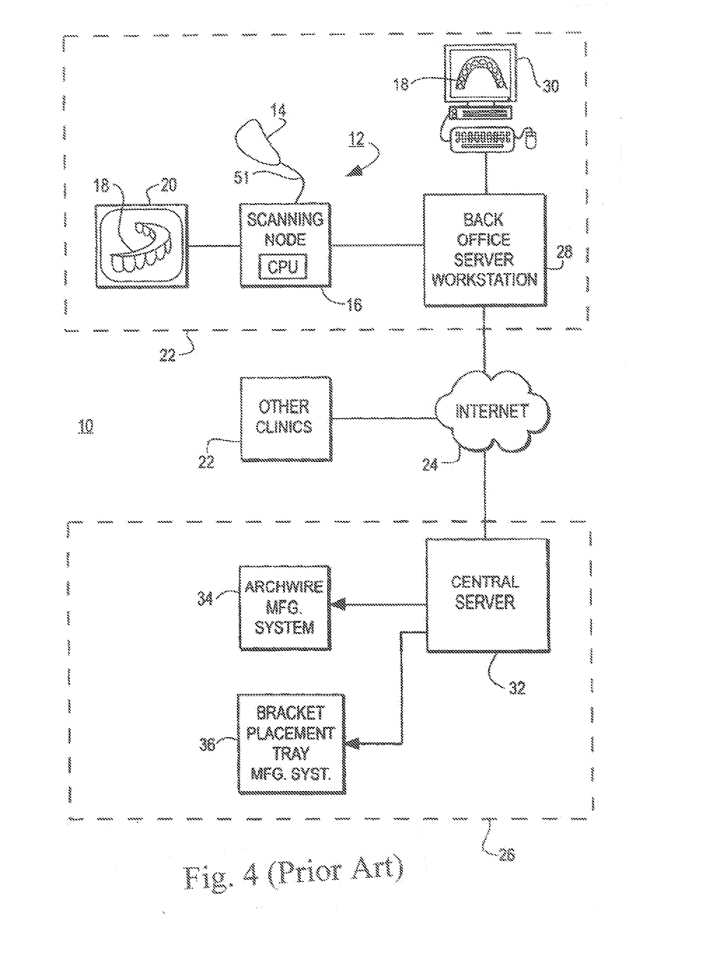

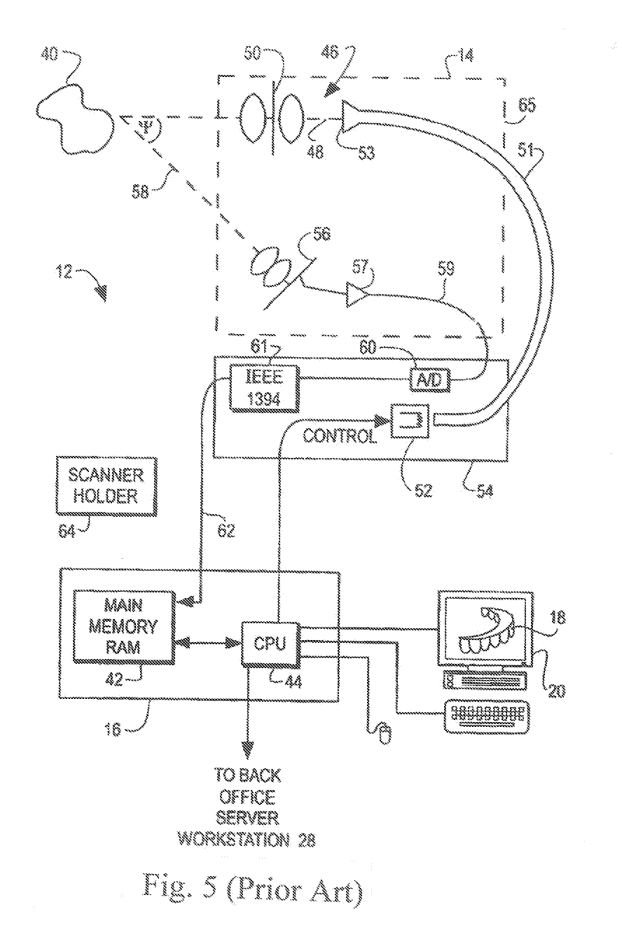

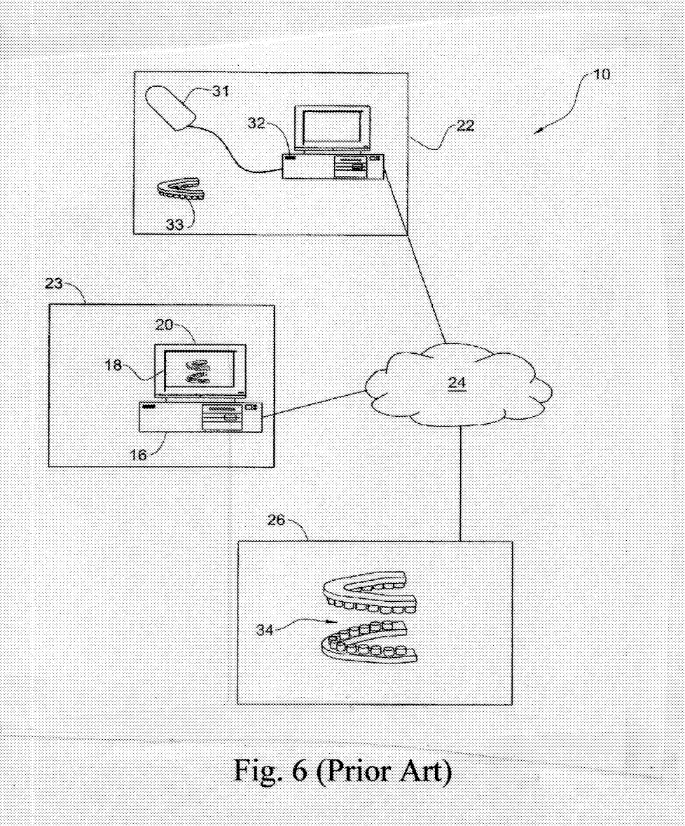

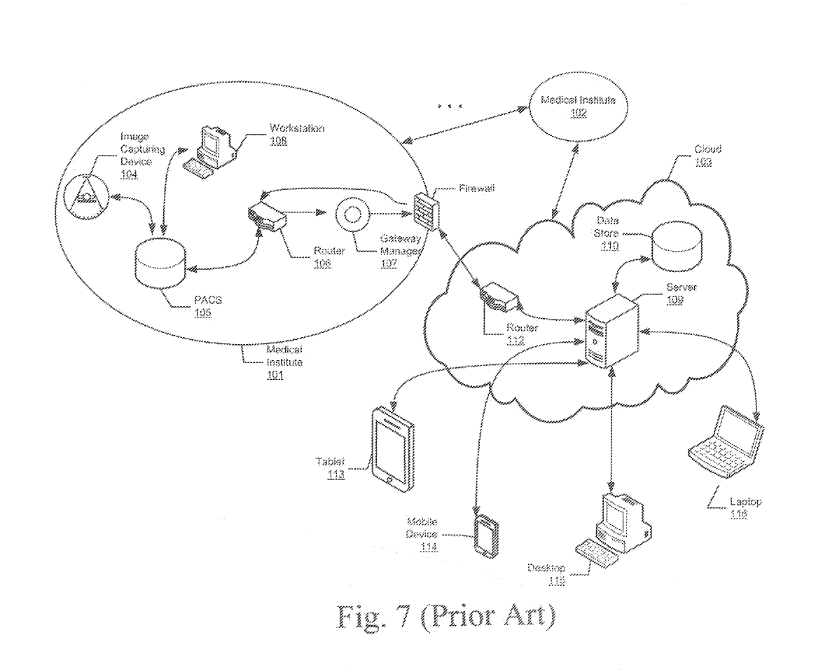

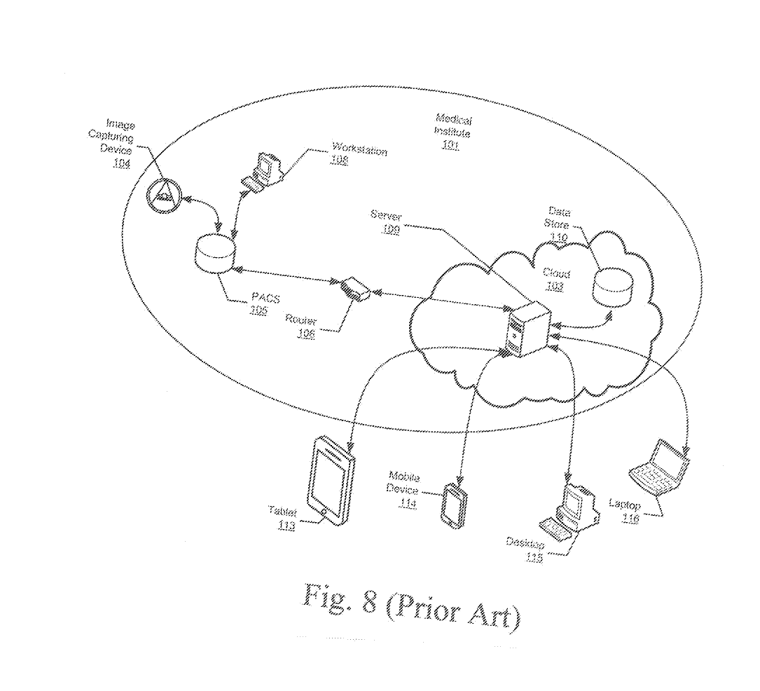

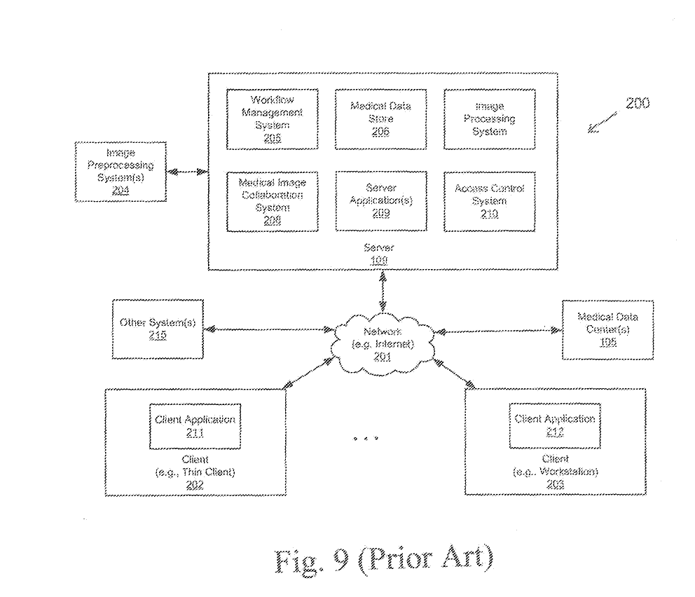

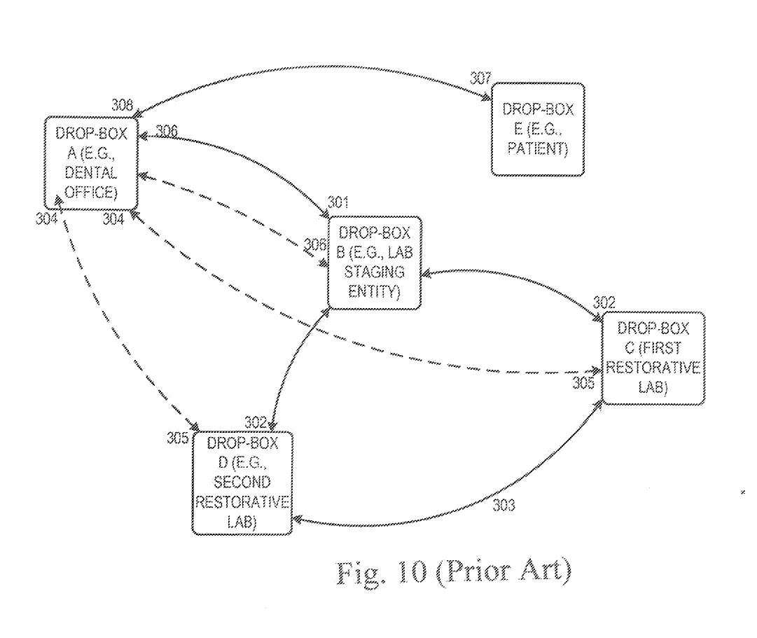

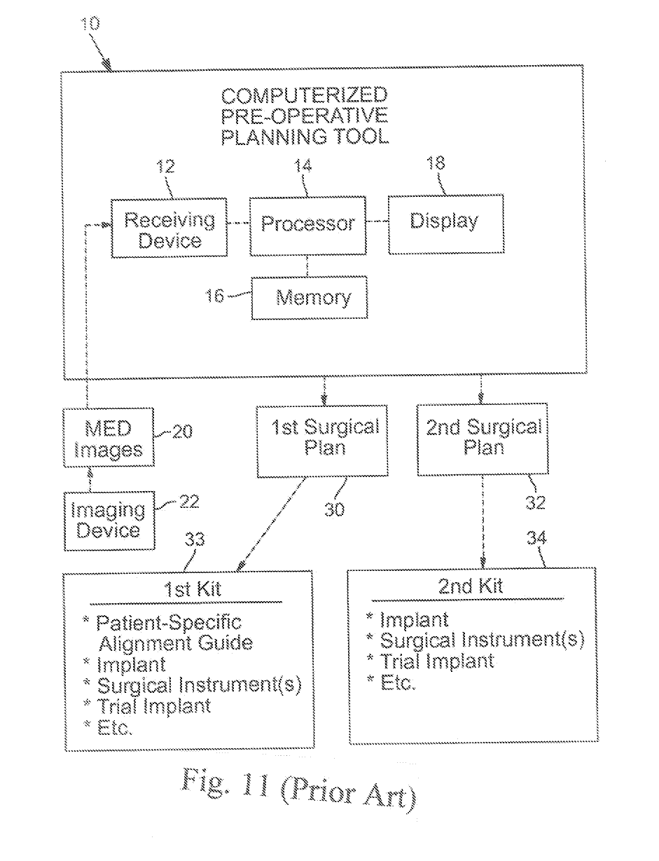

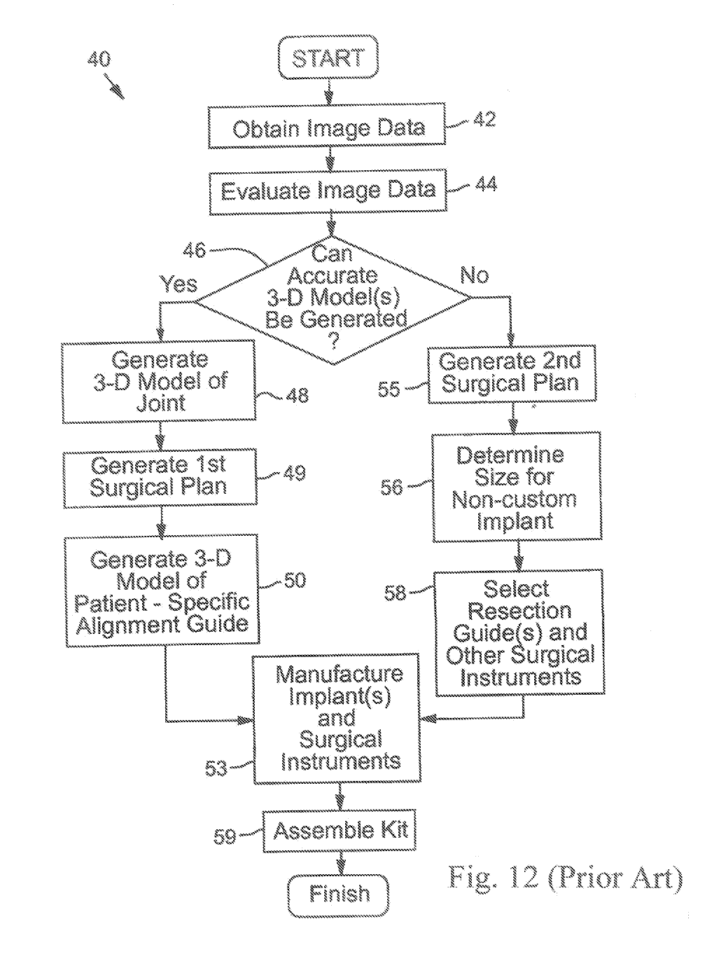

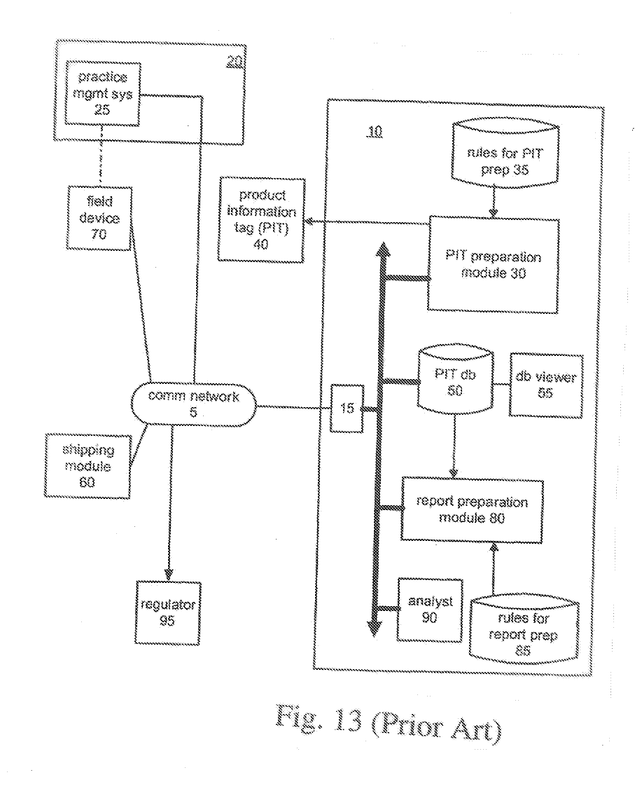

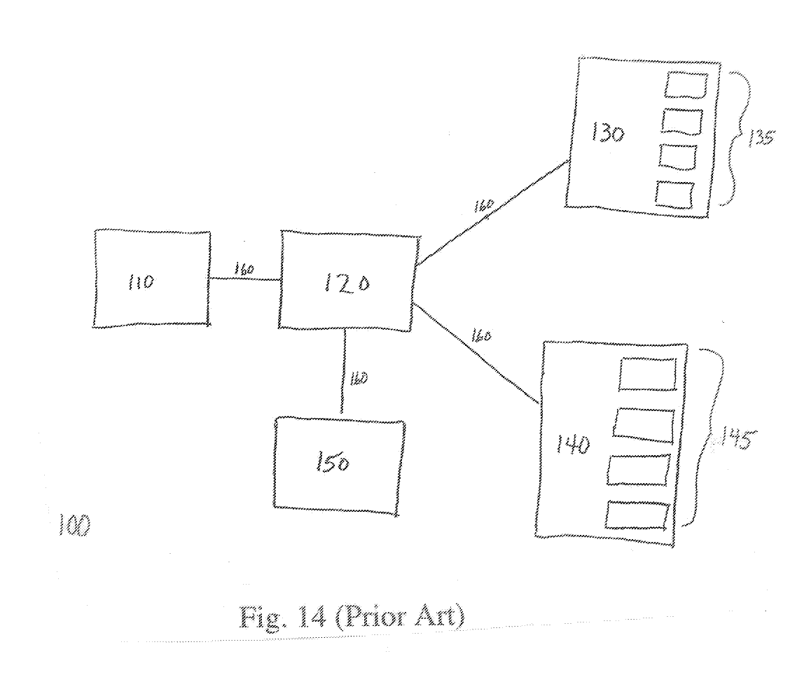

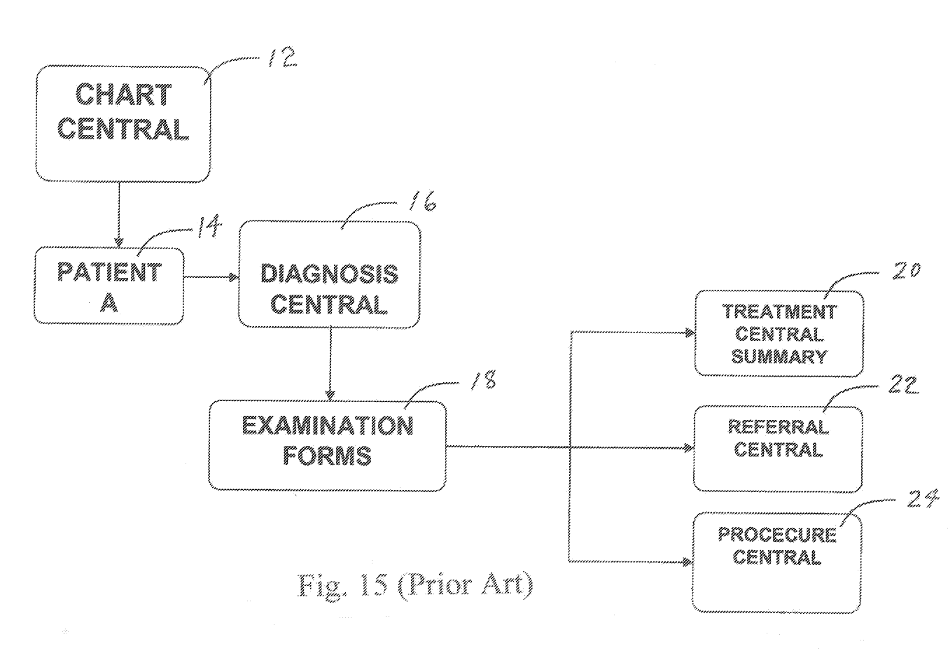

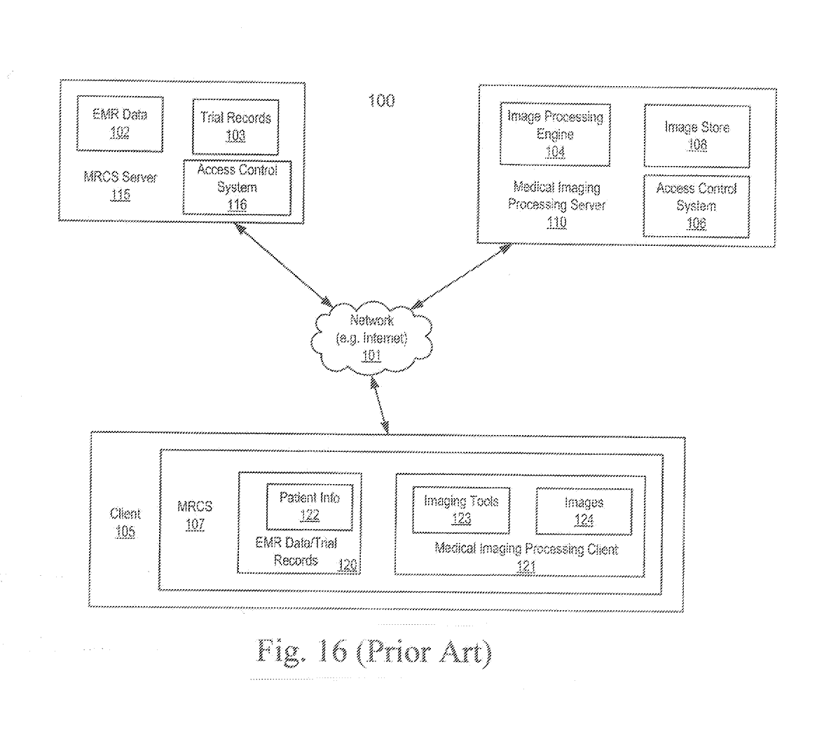

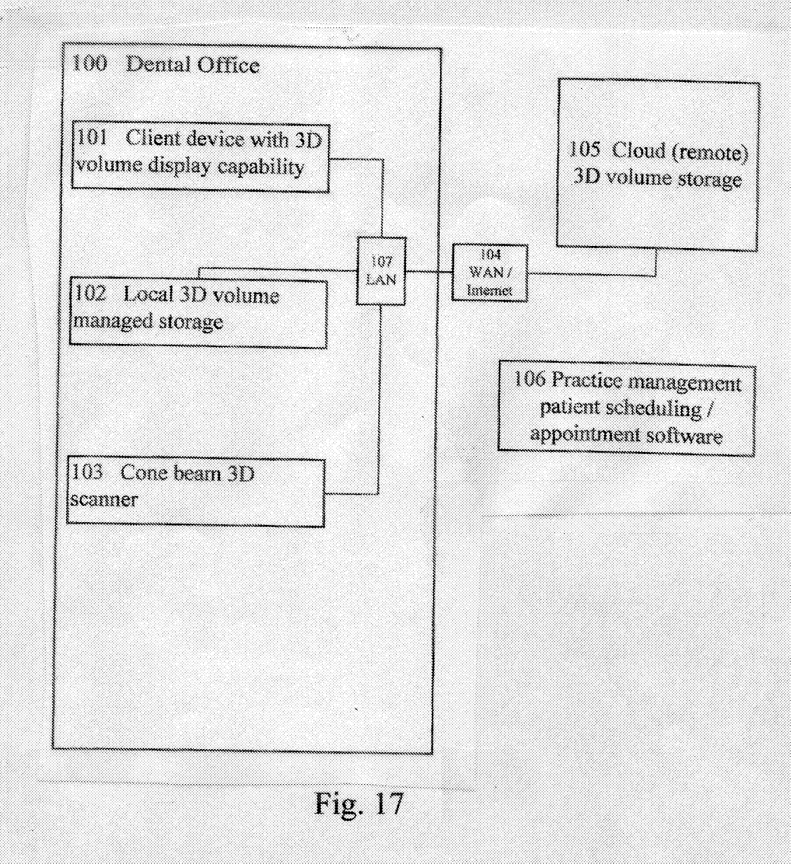

Referring to FIG. 17 a 3D cone beam dental imaging system includes a dental office 100, a remotely located cloud storage 105, WAN/Internet 104 and patient scheduling software 106. The dental office 100 contains a client device with 3D volume display capability 101, local 3D volume storage 102, a cone beam dental scanner 103, and Local Area Network 107. The client device 101, local storage 102 and cone beam scanner 103 are typically connected via the LAN 107 in the dental office. The dental office LAN 107 is connected to WAN 105 allowing access to remote cloud storage. The 3D cone beam dental imaging system is optimized for use in dental practices employing remote storage of 3D volumes.

Software located on a local or remote device such as the managed local storage device 102 or on client device 101 or on cloud storage device 105 receives related patient scheduling information from the patient scheduling software 106 via the LAN 107 or WAN 104 and finds patients with appointments at a future date and/or time from the current date and/or time.

The list of patients that are found which have been scheduled and are nearing their appointment date are automatically checked by the software for existence of any 3D volumes on remote 3D volume storage 105 via WAN connection 104. If any volumes exist for these patients then one or more 3D volumes or partial volumes are downloaded via WAN/Internet 104 to local storage 102 prior to the day and/or time of the patients scheduled appointment. When the patient arrives at the appointment and is in the operatory in dental office 100 on the day of the appointment, the client device with 3D volume display capability 101 is configured to display pre-existing 3D volumes which are accessed from 3D data located on the local managed storage device 102 via local network 107 and therefore client device (101) has high speed access to the patient's existing 3D volumes making them available immediately for diagnosis and treatment planning. If any editing is performed on the 3D volume and requested by user to be saved, the updated volume or information is saved to the local storage 102. Upon completion of patient appointment and at a definable future time and/or day based upon the patients future appointments obtained from scheduling software 106, the 3D volume in all or part is uploaded back to cloud remote storage 105 via LAN 107 and WAN/Internet 104 for permanent storage and multi-user/multi-site availability.

When a new 3D volume is acquired in the local dentist office 100 by cone beam scanner 103 this volume is stored in the local storage 102 and at a later date after completion of patient appointment and based upon patient future appointment obtained from scheduling software 106 the new 3D volume is uploaded to the cloud storage 105 and deleted from local storage 102.

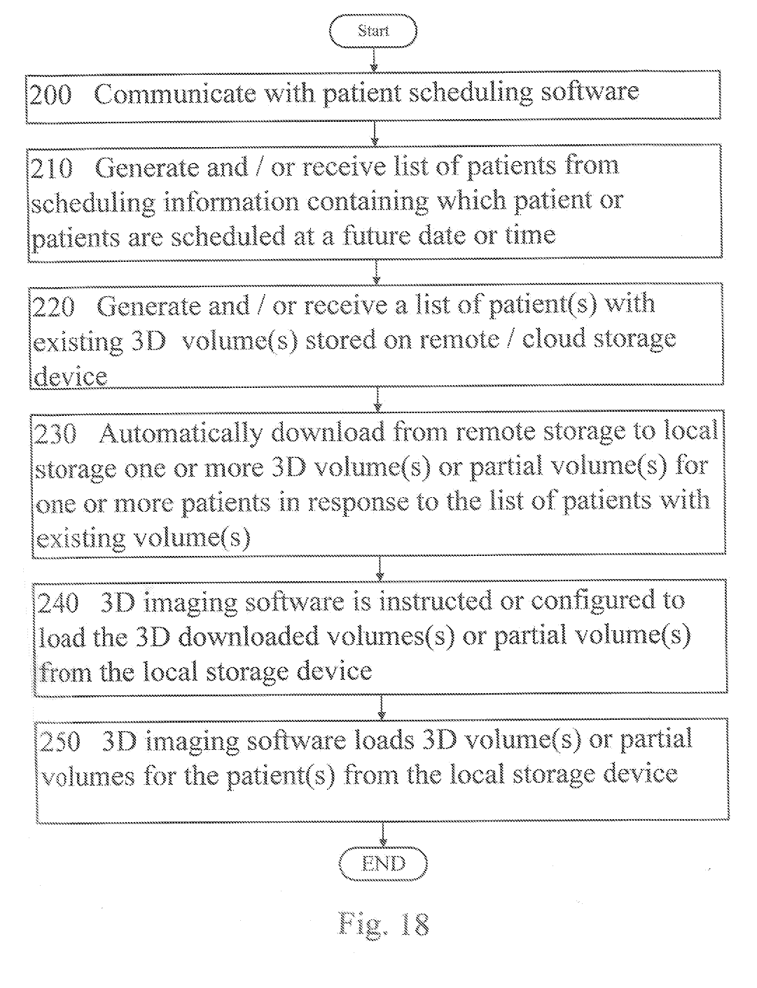

Referring to FIG. 18 in conjunction with FIG. 17 a first flowchart shows a method for automatically downloading patient or patients existing 3D volumes and or partial volumes from remote storage to local storage based upon patients future scheduled appointments.

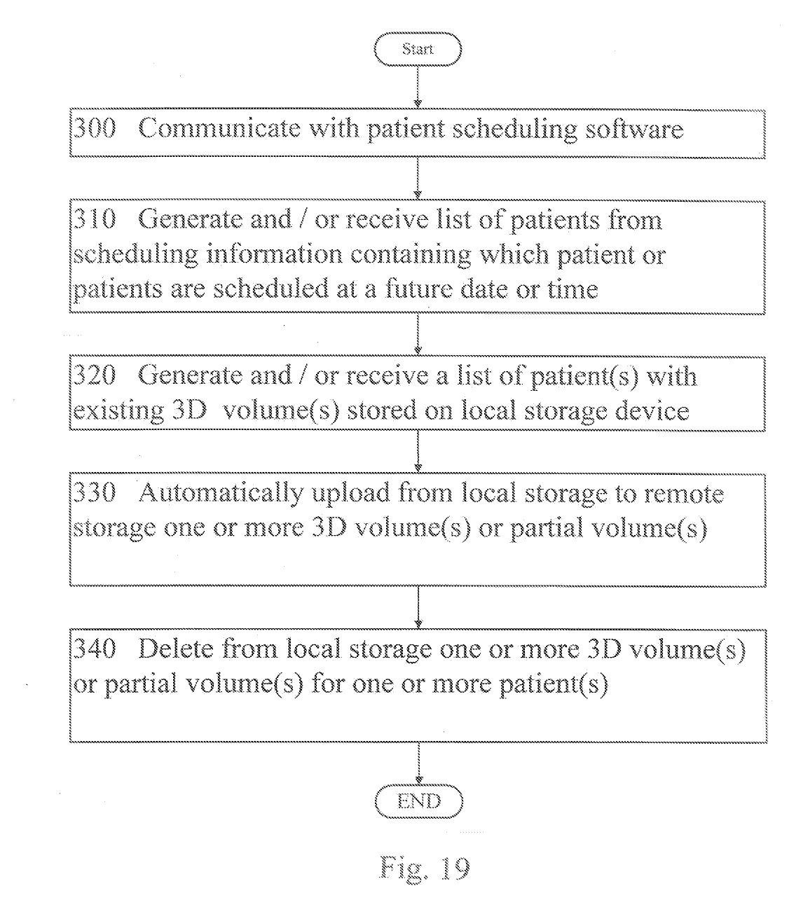

Referring to FIG. 19 in conjunction with FIG. 17 a second flowchart shows a method for automatically uploading patient or patients existing 3D volumes and or partial volumes from remote storage to local storage based upon patients future scheduled appointments.

The system and method for storing and retrieving the 3D volumes automatically to and from cloud remote storage to local managed storage eliminate the above remote storage bandwidth issues that prevent dental offices with 3D cone beam scanners from being able to acquire new volumes and/or diagnose using pre-existing 3D volumes in near real time as required by the dental workflow.

This dental imaging system relies on additional practice management or other patient scheduling data and obtains information on patients whom are scheduled for appointments (or 3D examinations) at a future date or time from today.

Upon getting this information the dental imaging software downloads those specific patients' 3D volumes to a network appliance/managed local storage for temporary use at a predetermined time prior to the patient's appointment, for example the night before the appointment.

The viewing of 3D volumes/images in this imaging system invention can be accomplished on the client computer in the doctor's office and can check the imaging systems managed local storage appliance for the patient's 3D volume(s) prior to checking the remote storage. If the 3D imaging software finds the 3D volumes for this patient exists on the local storage, it uses them for display and diagnosis on the local client device with 3D volume display capability.

After the appointment has concluded the downloaded 3D volumes on the local managed storage can be deleted if no changes were made to the 3D volume, or the 3D volume can be uploaded to the remote storage if changes were made to the 3D volume, and then it can be removed from the local managed storage.

If a new 3D volume is acquired during the appointment for the patient, the client software saves the volume on the local managed storage and then at a later date (the next hour, or that night, next week, next month and based upon patients recall schedule) software manages uploading the 3D volume back to the remote storage and removes the volume from the local managed storage. By employing the novel invention above dentist offices can employ 3D imaging into their practices and utilize remote cloud storage, where the main primary storage is not located on site at the dental office and without sacrificing any workflow slow-downs while also maintaining the advantages of having the volume stored in the cloud.

From the foregoing it can be seen that a 3D cone beam dental imaging system has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

1. (canceled)

2. (canceled)

3. A 3D dental imaging system used for producing and transferring 3D volumes of a patient to and from a remote cloud storage device, said dental imaging system comprising:
a. 3D volume imaging software for displaying cone beam images; said software has means to retrieve volumes from storage located in the dental office;
b. 3D volumes acquired via a cone beam scanner;
c. Storage located in the dentist office for storage of 3D volumes that were acquired via a cone beam scanner;
d. Storage located remotely of the dentist office for storage of 3D volumes that were acquired via a cone beam scanner;
e. Means to transfer 3D volumes automatically between said local storage and said remote storage;
f. Means to receive Patient Appointment information for patients future appointments from a patient scheduling software; and
g. And means to delete 3D volumes automatically from remote storage or local storage based upon patients future appointment information.

4. A method of 3D dental cone beam imaging, comprising (a) acquiring a cone beam 3D volume of dental data; (b) saving, all or a portion of the 3D data in local storage; (c) means to receive information details regarding patients future dental appointments from a patient scheduling software; and (d) automatically uploading or downloading the full or partial 3D volume between the local storage and remote storage based upon patient future appointment information.

5. A 3D cone beam dental imaging system used for producing and transferring 3D volumes of a patient to and from a remote cloud storage device, said dental imaging system comprising:
a. 3D volume imaging software for displaying cone beam images; said software has means to retrieve volumes from storage located in the dental office;
b. 3D volumes acquired via a cone beam scanner;
c. Storage located in the dentist office for storage of 3D volumes that were acquired via a cone beam scanner;
d. Storage located remotely of the dentist office for storage of 3D volumes that were acquired via a cone beam scanner located in the dentist office;
e. Means to transfer 3D volumes between said local storage and said remote storage;
f. Means to receive patient appointment information for patients future appointments from a patient scheduling software; and
g. And means to transfer 3D volumes automatically to and from remote storage to local storage based upon patients future appointment information.
